(19) United States
(12) Patent Application Publication
(10) Pub. No.: US 2026/0057807 A1
(43) Pub. Date: Feb. 26, 2026

(54) MODULAR ANATOMICAL SYSTEM

(71) Applicant: The Board of Supervisors of Louisiana State University and Agricultural and Mechanical College, Baton Rouge, LA (US)

(72) Inventors: Giovanni SOLITRO, Shreveport, LA (US); Patrick MASSEY, Shreveport, LA (US); R. Shane BARTON, Shreveport, LA (US)

(21) Appl. No.: 18/870,614

(22) PCT Filed: May 31, 2023
(86) PCT No.: PCT/US2023/067686

§ 371 Date: Nov. 29, 2024

Related U.S. Application Data
(60) Provisional application No. 63/347,092, filed on May 31, 2022.
(60) Provisional application No. 63/347,903, filed on Jun. 1, 2022.
(60) Provisional application No. 63/449,879, filed on Mar. 3, 2023.

(51) Int. Cl. G09B 23/34; G09B 23/28

(52) U.S. Cl. CPC G09B 23/34; G09B 23/285

(57) ABSTRACT

The present invention is directed to a modular anatomical system for demonstrating, practicing, or evaluating a medical procedure or technique.

This application is an International Application which claims priority from U.S. provisional patent application No. 63/347,092 filed on May 31, 2022, U.S. provisional patent application No. 63/347,903 filed on Jun. 1, 2022, and U.S. provisional patent application No. 63/449,879 filed on Mar. 3, 2023, the entire contents of each which are incorporated herein by reference.

### GOVERNMENT INTERESTS

N/A

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention is directed to a modular anatomical system for demonstrating, practicing, or evaluating a medical procedure or technique.

### BACKGROUND OF THE INVENTION

Various training simulators exist with varying degrees of anatomic accuracy, including cadaveric simulators, virtual reality simulators and a wide range of “bench-top” simulators. Cadavers are the ideal training simulator for most of the surgical tasks however the high price and low availability of cadaver specimens limits their access to trainees. Virtual reality simulators often lack the ability to simulate the interaction between tissues and tools for complex procedures and the enrichment with haptic rendering requires extensive programming and high computational cost; “Bench-top” simulators include a variety of tissue surrogates and are mainly provided by SawBones (Vashon Island, Washington). Examples with high anatomical accuracy include the products branded “Alex 2” and “Alex 3” for the surgery of the arthroscopic surgery of the shoulder. While simulators with low anatomical accuracy, conceived for the training of tasks, are mainly constituted by the “Dome rotator cuff anchor training block” and “MagneFAST.” These simulators are expensive, characterized by limited flexibility, and they lack the anatomical complexity of virtual reality simulators.

### SUMMARY OF THE INVENTION

In embodiments, a modular anatomical system for demonstrating, practicing, or evaluating a medical procedure or technique is described herein. In embodiment, the system comprises: an anatomical structure comprising a base portion and one or more anatomical elements; the base portion comprising one or more attachment mechanisms, wherein the one or more attachment mechanisms are configured to removably attach to the respective one or more anatomical elements; at least one tracking element; at least one camera for receiving visual information of the anatomical structure and the at least one tracking element; and one or more applications running on at least one processor of a computing device, the one or more applications configured to use information of the at least one tracking element to overlay three dimensional virtual features over the marker in a virtual display of at least a portion of the anatomical structure.

In embodiments, the one or more anatomical elements are a representation of a bone, joint, tissue, structure, nerve, vessel, or surgical hardware.

In embodiments, the one or more anatomical elements are constructed from diagnostic imaging.

In embodiments, the one or more attachment mechanisms are at different locations on the base.

In embodiments, the anatomical structure further comprises a covering portion, wherein the covering portion comprises at least one access portal.

In embodiments, the at least one access portal comprises anterior, anterior superior, anterior inferior, superior, lateral, posterior inferior, posterior, or any combination thereof.

In embodiments, the one or more anatomical elements are configured to removably host the tissue surrogate.

In embodiments, the one or more anatomical elements comprise one or more hosting elements configured to host the tissue surrogate.

In embodiments, the one or more hosting elements comprise a receptacle, pocket, peg, hook, slide, hole or socket to host the tissue surrogate.

In embodiments, the one or hosting elements are embedded into the anatomical element.

In embodiments, the tissue surrogate comprises a cadaver tissue, a synthetic tissue, or an animal tissue.

In embodiments, the system or portions thereof are manufactured via molding, machining, 3D-printing, or any combination of the same.

In embodiments, the synthetic tissue comprises bone, connective tissue, vasculature tissue, muscle tissue, adipose tissue, dermal tissue, nerve tissue, a medical device, or a combination thereof.

In embodiments, the one or more anatomical elements can be articulated or actuated.

In embodiments, the one or more anatomical elements can be actuated by an elastic element.

In embodiments, the elastic element comprises a rubber band.

In embodiments, the system is configured to simulate a medical procedure.

In embodiments, the system is configured to assess an operator's proficiency with the medical procedure.

In embodiments, the medical procedure comprises a surgical procedure.

In embodiments, the surgical procedure comprises an otolaryngology procedure, a neurosurgery, a gastroenterology procedure, a urology procedure, a cardiovascular surgery, an oral surgery, a pediatric surgery, a plastic surgery, an orthopedic surgery, a cardiothoracic surgery, dentistry, podiatry, or any a combination thereof.

In embodiments, the medical procedure comprises an arthroscopic procedure, a laparoscopic procedure, an endoscopic procedure, fluoroscopic image guided procedure, an ultrasound guided procedure, or an image guided procedure.

In embodiments, the surgical procedure comprises acromioclavicular reconstruction, rotator cuff repair, shoulder anterior labral repair, posterior labral repair, superior labral repair, humeral avulsion of the glenohumeral ligament repair, shoulder arthroscopic procedures, knee arthroscopic procedures (anterior cruciate ligament reconstruction, posterior cruciate ligament reconstruction, medial collateral ligament reconstruction, lateral collateral ligament reconstruction, osteochondral autograft transfer, osteochondritis dissecans fixation, meniscus repair), hip arthroscopic procedures (CAM resection, femur osteochondroplasty, labrum repair), ankle arthroscopic procedures (osteochondral fracture fixation, osteochondral autograft transfer, loose body removal, ankle distraction, ankle fusion), elbow arthroscopy (osteophyte debridement, loose body removal, osteochondral fragment excision, microfracture, osteochondral autograft transfer, plica excision), wrist arthroscopy, or a combination thereof.

In embodiments, the one or more anatomical elements are arranged to model an anatomical feature, deformity, or pathology.

In embodiments, the anatomical feature, deformity, or pathology comprises a human anatomical feature, deformity, or pathology.

In embodiments, the anatomical feature, deformity, or pathology is selected from the group consisting of a maxillofacial procedure, neurosurgical procedure, proximal humerus fracture, a humerus shaft fracture, a distal humerus intra-articular T-type fracture, a subtrochanteric femur fracture, a tibia plateau fracture, a tibia shaft fracture, a distal fibula fracture, a medial malleolus, a radial head, a olecranon fracture, a radius and ulna shaft, a distal radius, a posterior malleolus fracture, a calcaneus fracture, a Lisfranc fracture dislocation, an acetabulum fracture, an acetabulum and femur neck, a sacroiliac joint, a spine pedicle, a subtrochanteric fracture, a spherical socket, and a femur shaft fracture.

In embodiments, the at least one tracking element comprises an alphanumeric code, an optical marker, or a chip.

In embodiments, the at least one tracking element is located within the anatomical structure.

In embodiments, the at least one tracking element is externally attached to the anatomical structure.

In embodiments, the at least one camera comprises the computing device.

In embodiments, a second modular anatomical system identical to the modular anatomical system is located remotely from the modular anatomical system.

In embodiments, the second modular anatomical system is communicatively coupled to the modular anatomical system.

In embodiments, a trainer using the modular anatomical system performs a medical procedure or technique which is remotely displayed on a virtual or augmented reality display available to a trainee, wherein the trainee may follow along using the second modular anatomical system.

In embodiments, a trainee using the second modular anatomical system performs a medical procedure or technique which is remotely displayed on a virtual display available to a trainer, wherein the trainer uses the modular anatomical system to perform instructional actions visible to the trainee.

In embodiments, the one or more applications implement artificial intelligence for at least one of providing virtual instructions to a user of the modular anatomical system and for receiving voice command instructions for implementing training tasks in the virtual environment.

Aspects of the invention are drawn towards a modular anatomical system for demonstrating, practicing, or evaluating a medical procedure or technique. In embodiments, the system comprises: an anatomical structure comprising a base portion and one or more anatomical elements; the base portion comprising one or more attachment mechanisms, wherein the one or more attachment mechanisms are configured to removably attach to the respective one or more anatomical elements; at least one tracking element; at least one camera for receiving visual information of the anatomical structure and the at least one tracking element; and one or more applications running on at least one processor of a computing device, the one or more applications configured to use information of the at least one tracking element to overlay three dimensional virtual features over the marker in a virtual display of at least a portion of the anatomical structure.

In embodiments, the one or more anatomical elements can be a representation of a bone, joint, tissue, structure, nerve, vessel, or surgical hardware.

In embodiments, the one or more anatomical elements can be constructed from diagnostic imaging.

In embodiments, the one or more attachment mechanisms can be at different locations on the base.

In embodiments, the anatomical structure can further comprise a covering portion, wherein the covering portion comprises at least one access portal.

In embodiments, the at least one access portal can comprise anterior, anterior superior, anterior inferior, superior, lateral, posterior inferior, posterior, or any combination thereof.

In embodiments, the one or more anatomical elements can be configured to removably host the tissue surrogate.

In embodiments, the one or more anatomical elements can comprise one or more hosting elements configured to host the tissue surrogate.

In embodiments, the one or more hosting elements can comprise a receptacle, pocket, peg, hook, slide, hole or socket to host the tissue surrogate.

In embodiments, the one or hosting elements can be embedded into the anatomical element.

In embodiments, the tissue surrogate can comprise a cadaver tissue, a synthetic tissue, or an animal tissue.

In embodiments, the system or portions thereof can be manufactured via molding, machining, 3D-printing, or any combination of the same.

In embodiments, the synthetic tissue can comprise bone, connective tissue, vasculature tissue, muscle tissue, adipose tissue, dermal tissue, nerve tissue, a medical device, or a combination thereof.

In embodiments, the one or more anatomical elements can be articulated or actuated.

In embodiments, the one or more anatomical elements can be actuated by an elastic element. For example, the elastic element can comprise a rubber band.

In embodiments, the system can be configured to simulate a medical procedure. For example, the system can be configured to assess an operator's proficiency with the medical procedure. For example, the medical procedure comprises a surgical procedure, non-limiting examples of which comprise an otolaryngology procedure, a neurosurgery, a gastroenterology procedure, a urology procedure, a cardiovascular surgery, an oral surgery, a pediatric surgery, a plastic surgery, an orthopedic surgery, a cardiothoracic surgery, dentistry, podiatry, or any a combination thereof. Non-limiting examples of the medical procedure comprise an arthroscopic procedure, a laparoscopic procedure, an endoscopic procedure, fluoroscopic image guided procedure, an ultrasound guided procedure, or an image guided procedure. Non-limiting examples of a surgical procedure comprise acromioclavicular reconstruction, rotator cuff repair, shoulder anterior labral repair, posterior labral repair, superior labral repair, humeral avulsion of the glenohumeral ligament repair, shoulder arthroscopic procedures, knee arthroscopic procedures (anterior cruciate ligament reconstruction, posterior cruciate ligament reconstruction, medial collateral ligament reconstruction, lateral collateral ligament reconstruction, osteochondral autograft transfer, osteochondritis dissecans fixation, meniscus repair), hip arthroscopic procedures (CAM resection, femur osteochondroplasty, labrum repair), ankle arthroscopic procedures (osteochondral fracture fixation, osteochondral autograft transfer, loose body removal, ankle distraction, ankle fusion), elbow arthroscopy (osteophyte debridement, loose body removal, osteochondral fragment excision, microfracture, osteochondral autograft transfer, plica excision), wrist arthroscopy, or a combination thereof.

In embodiments, the one or more anatomical elements can be arranged to model an anatomical feature, deformity, or pathology. For example, the anatomical feature, deformity, or pathology can comprise a human anatomical feature, deformity, or pathology. For example, the anatomical feature, deformity, or pathology can be selected from the group consisting of a maxillofacial procedure, neurosurgical procedure, proximal humerus fracture, a humerus shaft fracture, a distal humerus intra-articular T-type fracture, a subtrochanteric femur fracture, a tibia plateau fracture, a tibia shaft fracture, a distal fibula fracture, a medial malleolus, a radial head, a olecranon fracture, a radius and ulna shaft, a distal radius, a posterior malleolus fracture, a calcaneus fracture, a Lisfranc fracture dislocation, an acetabulum fracture, an acetabulum and femur neck, a sacroiliac joint, a spine pedicle, a subtrochanteric fracture, a spherical socket, and a femur shaft fracture.

In embodiments, the at least one tracking element can comprise an alphanumeric code, an optical marker, or a chip.

In embodiments, the at least one tracking element can be located within the anatomical structure.

In embodiments, the at least one tracking element can be located within the anatomical structure.

In embodiments, the at least one camera can comprise the computing device.

In embodiments, a second modular anatomical system identical to the modular anatomical system can be located remotely from the modular anatomical system.

In embodiments, the second modular anatomical system is communicatively coupled to the modular anatomical system.

In embodiments, a trainer using the modular anatomical system can perform a medical procedure or technique which is remotely displayed on a virtual or augmented reality display available to a trainee, wherein the trainee may follow along using the second modular anatomical system.

In embodiments, a trainee using the second modular anatomical system can perform a medical procedure or technique which is remotely displayed on a virtual display available to a trainer, wherein the trainer uses the modular anatomical system to perform instructional actions visible to the trainee.

In embodiments, the one or more applications can implement artificial intelligence for at least one of providing virtual instructions to a user of the modular anatomical system and for receiving voice command instructions for implementing training tasks in the virtual environment.

Aspects of the invention are also drawn towards a modular anatomical system for demonstrating, practicing, or evaluating a medical procedure or technique, the system comprising: an anatomical structure comprising a base portion and one or more anatomical elements; the base portion comprising one or more attachment mechanisms, wherein the one or more attachment mechanisms are configured to removably attach to the respective one or more anatomical elements; a virtual reality controller, wherein the virtual reality controller is attached to a surgical probe; a virtual reality camera device; one or more applications running on one or more processors of at least one of the virtual reality controller and the virtual reality camera device, the one or more applications configured to: establish a position of the virtual reality controller relative to the virtual reality camera; receive three-dimensional data of the anatomical structure including the one or more anatomical elements within the anatomical structure; map an x-y-z position of the controller to an x-y-z position of the anatomical structure using the three-dimensional data; track a position of the surgical probe relative to the anatomical elements using information of the mapping; and generate a virtual display of the surgical probe within an environment of the anatomical structure.

In embodiments, the mapping can comprise placing the virtual reality controller in a fixed location relative to the anatomical structure.

In embodiments, the mapping can comprise the virtual reality camera mapping the environment.

In embodiments, the mapping can comprise the virtual reality camera using the information of the environmental mapping and the three-dimensional data to map the x-y-z position of the controller to the x-y-z position of the anatomical structure.

In embodiments, the one or more anatomical elements can be a representation of a bone, joint, tissue, structure, nerve, vessel, or surgical hardware.

In embodiments, the one or more anatomical elements can be constructed from diagnostic imaging.

In embodiments, the one or more attachment mechanisms can be at different locations on the base.

In embodiments, the anatomical structure can further comprise a covering portion, wherein the covering portion comprises at least one access portal. For example, the at least one access portal can comprise anterior, anterior superior, anterior inferior, superior, lateral, posterior inferior, posterior, or any combination thereof.

In embodiments, the one or more anatomical elements can be configured to removably host the tissue surrogate.

In embodiments, the one or more anatomical elements can comprise one or more hosting elements configured to host the tissue surrogate.

In embodiments, the one or more hosting elements can comprise a receptacle, pocket, peg, hook, slide, hole or socket to host the tissue surrogate.

In embodiments, the one or hosting elements can be embedded into the anatomical element.

In embodiments, the system or portions thereof can be manufactured via molding, machining, 3D-printing, or any combination of the same.

In embodiments, the tissue surrogate can comprise a cadaver tissue, a synthetic tissue, or an animal tissue. For example, the synthetic tissue can comprise bone, connective tissue, vasculature tissue, muscle tissue, adipose tissue, dermal tissue, nerve tissue, a medical device, or a combination thereof.

In embodiments, the one or more anatomical elements can be articulated or actuated.

In embodiments, the one or more anatomical elements can be actuated by an elastic element. For example, the elastic element can comprise a rubber band.

In embodiments, the system can be configured to simulate a medical procedure. For example, the system can be configured to assess an operator's proficiency with the medical procedure. For example, the medical procedure can comprise a surgical procedure, non-limiting examples of which can comprise an otolaryngology procedure, a neurosurgery, a gastroenterology procedure, a urology procedure, a cardiovascular surgery, an oral surgery, a pediatric surgery, a plastic surgery, an orthopedic surgery, a cardiothoracic surgery, dentistry, podiatry, or any a combination thereof. For example, the medical procedure can comprise an arthroscopic procedure, a laparoscopic procedure, an endoscopic procedure, fluoroscopic image guided procedure, an ultrasound guided procedure, or an image guided procedure. For example, the surgical procedure can comprise acromioclavicular reconstruction, rotator cuff repair, shoulder anterior labral repair, posterior labral repair, superior labral repair, humeral avulsion of the glenohumeral ligament repair, shoulder arthroscopic procedures, knee arthroscopic procedures (anterior cruciate ligament reconstruction, posterior cruciate ligament reconstruction, medial collateral ligament reconstruction, lateral collateral ligament reconstruction, osteochondral autograft transfer, osteochondritis dissecans fixation, meniscus repair), hip arthroscopic procedures (CAM resection, femur osteochondroplasty, labrum repair), ankle arthroscopic procedures (osteochondral fracture fixation, osteochondral autograft transfer, loose body removal, ankle distraction, ankle fusion), elbow arthroscopy (osteophyte debridement, loose body removal, osteochondral fragment excision, microfracture, osteochondral autograft transfer, plica excision), wrist arthroscopy, or a combination thereof.

In embodiments, the one or more anatomical elements can be arranged to model an anatomical feature, deformity, or pathology. For example, the anatomical feature, deformity, or pathology can comprise a human anatomical feature, deformity, or pathology. For example, the anatomical feature, deformity, or pathology can be selected from the group consisting of a maxillofacial procedure, neurosurgical procedure, proximal humerus fracture, a humerus shaft fracture, a distal humerus intra-articular T-type fracture, a subtrochanteric femur fracture, a tibia plateau fracture, a tibia shaft fracture, a distal fibula fracture, a medial malleolus, a radial head, a olecranon fracture, a radius and ulna shaft, a distal radius, a posterior malleolus fracture, a calcaneus fracture, a Lisfranc fracture dislocation, an acetabulum fracture, an acetabulum and femur neck, a sacroiliac joint, a spine pedicle, a subtrochanteric fracture, a spherical socket, and a femur shaft fracture.

In embodiments, a second modular anatomical system identical to the modular anatomical system can be located remotely from the modular anatomical system.

In embodiments, the second modular anatomical system can be communicatively coupled to the modular anatomical system.

In embodiments, a trainer using the modular anatomical system can perform a medical procedure or technique which is remotely displayed on a virtual or augmented reality display available to a trainee, wherein the trainee follows along using the second modular anatomical system.

In embodiments, a trainee using the second modular anatomical system can perform a medical procedure or technique which is remotely displayed on a virtual display available to a trainer, wherein the trainer uses the modular anatomical system to perform instructional actions visible to the trainee.

In embodiments, the one or more applications can implement artificial intelligence for at least one of providing virtual instructions to a user of the modular anatomical system and for receiving voice command instructions for implementing training tasks in the virtual environment.

Aspects of the invention are further drawn towards a method of simulating a medical procedure. For example, the method can comprise simulating a medical procedure using the anatomical system as described herein.

Still further, aspects of the invention are drawn towards a medical procedure simulation system. For example, the system comprises the modular anatomical system as described herein; a software configured to calculate an operator proficiency score; and a display screen configured to display the operator proficiency score.

Other objects and advantages of this invention will become readily apparent from the ensuing description.

### BRIEF DESCRIPTION OF THE FIGURES

FIG. 1 shows illustrations of the base (panel a), the anatomical elements (panel b), and the dome (panel c).

FIG. 2 shows illustrations of example of pocket (panel a) ang pegs (panel b) that can be included in the anatomical elements host a tissue surrogate as the cube shown in (panel c).

FIG. 3 shows an illustration of the base, one anatomical element (Scapular bone), the base, and the holding plate that being placed at the bottom limits the movement of the anatomical element.

FIG. 4 shows an image of an example of a prototype of the modular system with the hood closed (panel a) and open (panel b).

FIG. 5 shows an illustration of an example of computer set up with pre-determined locations for visual markers that can then be placed on the real-world model to triangulate position.

FIG. 6 shows illustrations of Left) Example of a marker with placed in a real-world model. The model has slots or peg holes to direct the user to insert the marker at a predetermined location and angulation which is correlated with the virtual model to triangulate position for the augmented reality structures and (right) bleeding blood vessel simulated. This demonstrates the augmented/mixed reality structures that can be placed inside of the model for use in training exercises.

FIG. 7 shows (left) Example of wooden dowel or stick with attached markers and (Right) augmented metallic cylinder which simulates a shaver device and can interact with augmented reality but provide haptic feedback based on the real-world model.

FIG. 8 shows an image of an Example of the system augmented with a virtual bursa (left) and the printed marker usd (right).

FIG. 9 shows illustrations of example of augmented reality (AR) markers hosted in the hood (panel a), on additional posts anchored to the anatomical elements (panel b), and constituted by the bone surrogate (panel c).

FIG. 10 shows illustrations of the invention being used for the training of the rotator cuff repair.

FIG. 11 shows pictures of the system described herein in various perspectives.

FIG. 12 shows illustrations of a hip scope-acetabulum block and femur neck block model.

FIG. 13 shows illustrations of sacroiliac screw simulator-sacral block and iliac block model.

FIG. 14 shows illustrations of a posterior spine pedicle screw simulator with 2 blocks.

FIG. 15 shows an illustration of subtrochanteric fracture model with rubber bands.

FIG. 16 shows illustrations of camera handle with open architecture for placement of camera.

FIG. 17 shows an illustration of a synthetic Arthroscopic Camera model that allows a camera to be inserted into a hole in the back and stick out to front to be used as an Arthroscopic camera analog.

FIG. 18 shows illustrations of the camera holster.

FIG. 19 shows an illustration of the camera holster.

FIG. 20 shows illustrations of camera holster with closed architecture.

FIG. 21 shows an illustration of the camera holster.

FIG. 22 shows an illustration of camera holster and camera.

FIG. 23 shows illustrations of the camera holster and camera.

FIG. 24 shows illustrations of the camera holster and camera.

FIG. 25 shows an illustration of the camera holster.

FIG. 26 shows illustrations of a synthetic Arthroscopic Camera model that allows a camera to be inserted into a hole in the back and stick out to front to be used as an Arthroscopic camera analog. Additionally, the handle has a mold to hold a joystick and/or gamepad which can interface with a computer.

FIG. 27 shows illustrations of the handle with a mold to hold a joystick and/or gamepad which can interface with a computer.

FIG. 28 shows an illustration of the handle and a gamepad.

FIG. 29 shows an illustration of the handle which has a mold to hold an Augmented reality/virtual reality/mixed reality controller with built in tracking software to track camera movements in relation to the real-world simulation training module.

FIG. 30 shows illustrations of the handle which has a mold to hold an Augmented reality/virtual reality/mixed reality controller.

FIG. 31 shows illustrations of the handle which has a mold to hold an Augmented reality/virtual reality/mixed reality controller.

FIG. 32 shows an illustration of synthetic Arthroscopic Camera model that allows a camera to be inserted into a hole in the back and stick out to front to be used as a Arthroscopic camera analog. Additionally, the handle has a mold to hold a smart phone or other optical tracking device with built in tracking software to track camera movements in relation to the real-world simulation training module. The screen can then be facing the user to show a picture of the real-world environment in the arthroscopic training module or a mixed reality perspective.

FIG. 33 shows an illustration of a handle which has a mold to hold a smart phone or other optical tracking device.

FIG. 34 shows illustrations of a handle which has a mold to hold a smart phone or other optical tracking device.

FIG. 35 shows an illustration of synthetic Arthroscopic tool model. The handle has a mold to hold an Augmented reality/virtual reality/mixed reality controller with built in tracking software to track the tool movements in relation to the real-world simulation training module. In the augmented/mixed reality/virtual reality environment the tool can then be visualized as a variety of instruments such as a suture passer, cautery device or shaver.

FIG. 36 shows an illustration of the handle which has a mold to hold an Augmented reality/virtual reality/mixed reality controller with built in tracking software to track the tool movements in relation to the real-world simulation training module.

FIG. 37 shows a schematic of the synthetic handle with topical tracking handle.

FIG. 38 shows an illustration of a fracture deformity simulator. Simulated Bone in purple, socket in Blue, simulated bone block in orange.

FIG. 39 shows an illustration of a fracture deformity simulator. Simulated Bone in purple, socket in Blue, simulated bone block in orange which have been inserted into the sockets.

FIG. 40 shows illustrations of a spherical socket with base for clamping to table-top and 6 hooks around a ring every 45 degrees.

FIG. 41 shows an illustration of 2 ring top sockets on each end for stabilization of two bone ends.

FIG. 42 shows illustrations femur shaft fracture model with sphere ends and hooks placed to recreate deforming forces on proximal and distal femur.

FIG. 43 shows an illustration of 2 ring top sockets with femur model.

FIG. 44 shows illustrations of semi-circular ring top for clamping to table.

FIG. 45 shows an illustration of 2 ringtop sockets and ringtops with simulated femur fracture with deforming hook attachments.

FIG. 46 shows an illustration of ringtop sockets and ringtops with simulated femur fracture with deforming hook attachments.

FIG. 47 shows an illustration of a femur fracture model.

FIG. 48 shows illustrations of an attached tension devices to femur bone and rings. Tension ring to distal femur medially to create adduction deforming force (red ring). Tension device anterior and lateral to proximal femur to create flexion and abduction deforming force (blue ring).

FIG. 49 shows illustrations of an arthroscopic camera model with socket for a small camera at the end (primary camera). Additionally, a socket in the handle for an additional camera (secondary camera). This secondary camera can be used to view external markers outside the arthroscopic model to calibrate the position of the simulated camera. This can be used to then create mixed reality in combination with the real video from the primary camera.

FIG. 50 shows an illustration of an arthroscopic camera model.

FIG. 51 shows an illustration of a primary camera on inside of model Secondary camera visualizing target (red) on outside of the arthroscopy model.

FIG. 52 shows an illustration of an embodiment of a knee simulator.

FIG. 53 shows an illustration of an embodiment of a knee simulator.

FIG. 54 shows an illustration of an embodiment of a knee simulator.

FIG. 55 shows an illustration of an embodiment of a knee simulator.

FIG. 56 shows an illustration of an embodiment of a knee simulator.

FIG. 57 shows an illustration of an embodiment of a knee simulator.

FIG. 58 shows an illustration of an embodiment of a knee simulator.

FIG. 59 shows an illustration of an embodiment of a knee simulator.

FIG. 60 shows an illustration of an embodiment of a knee simulator.

FIG. 61 shows an illustration of an embodiment of a knee simulator.

FIG. 62 shows an illustration of an embodiment of a knee simulator.

FIG. 63 shows an illustration of an embodiment of a knee simulator.

FIG. 64 shows an illustration of an embodiment of a knee simulator.

FIG. 65 shows an illustration of an embodiment of a knee simulator.

FIG. 66 shows an illustration of an embodiment of a knee simulator.

FIG. 67 shows an illustration of an embodiment of a knee simulator.

FIG. 68 shows an illustration of an embodiment of a knee simulator.

FIG. 69 shows an illustration of an embodiment of a knee simulator.

FIG. 70 shows an illustration of an embodiment of a knee simulator.

FIG. 71 shows an illustration of an embodiment of a knee simulator.

FIG. 72 shows an illustration of examples of portal locations of the disclosure. Ankle—2 anterior portals, 2 posterior portals, 2 medial incision portals, 2 lateral incision portals.

FIG. 73 shows an illustration of examples of portal locations of the disclosure. Hip—5 portals.

FIG. 74 shows an illustration of examples of portal locations of the disclosure. Knee—3 anterior portals.

FIG. 75 shows an illustration of examples of portal locations of the disclosure. Lumbar—midline portal.

FIG. 76 shows an illustration of examples of portal locations of the disclosure. Cervical—posterior midline incisional portal.

FIG. 77 shows an illustration of examples of portal locations of the disclosure. Hand and/or wrist—3 portals.

FIG. 78 shows an illustration of examples of portal locations of the disclosure. Elbow—4 portals.

FIG. 79 shows a graphic of embodiments of the disclosure.

FIG. 80 shows total seconds to complete arthroscopic shoulder simulator tasks.

FIG. 81 shows scatterplot of seconds to complete arthroscopic simulation tasks on new simulator versus number of shoulder arthroscopies performed during career.

FIG. 82 shows anatomy test score before and after shoulder arthroscopic simulator usage for the Alex3 and new simulator described herein.

FIG. 83-FIG. 97 shows steps to create a surgical training platform as described herein. (FIG. 83 and FIG. 84). A schematic of a trapezium with two sides made of two are that at the start of creating a training platform are characterized by infinitesimal curvature. In the default configuration, the trapezium is dimensioned to resemble a square with side dimensions of 100 mm. The topology of the base rectangle is enriched by extending arms made of a circle connected to the trapezium trough a rectangle that in the default configuration is orthogonal to vertical axis of the trapezium. The base plate is then automatically build fro extrusion of this profile in direction of the vertical axis. (FIG. 85). The external profile of the hosting plate which can then be generated through the extrusions of the offset profiles performed on the external edges of the base plate. The offset of the base profile can be performed at a first distance that could be of 0.4 mm for FDM printing technology while the second offset that creates the external wall of the hosting plate can be of various dimensions with 4 mm being the dimension already implemented in the existing prototypes. (FIG. 86). The user can add primitives in correspondence of the base through a selection menu available in the user interface (UI). The primitives can be placed in the 3D environment (3DE) through drag and drop. Random unique colors can assigned to each element by the system as soon as it is inserted into the 3D environment. Each element can become listed in a dedicated sidebar window in which the user can select single or group of elements, delete them or indicate if the element in the training system is going to be virtual, real or both. For the geometries that have edges below the plane of the base, a cut can be performed using this plane. Further manipulation of the geometries following the drop are performed trough a “Gizmo” tool (see following figure) that allows operations such as positioning, scaling, and stretching. The Gizmo appears on the entity as soon as it is selected by the user. (FIG. 87). The same tool can be used to move in the plane the lateral arms for the clamping and appears when the user pointer is positioned in correspondence of the arm center. (FIG. 88). A “drawing tool” can be included for which the system creates a sweep of a circular section along a path decided by the user through the locations of the pointer. In embodiments, the curve can be determined from the path ideally with a single NURBS curve created for each continuous input received by the user (examples: left mouse button pressed for computer-based modeling while index-thumb tip-pinch or handheld controller button pressed for VR-AR based systems. (FIG. 89). As shown, the elements indicated as real will be indicated with solid colors while virtual elements will be displayed in transparency and elements that are indicated as both will be solid and surrounded by a transparent surface created offsetting the element surface by a preset distance. (FIG. 90) A menu of features is also available for the user to add elements such as: pegs for anchoring soft tissues surrogates, pockets to host bone surrogates, joints such as sliders and hinges, and hooks to anchor springs or rubber bands. These elements, differently from the geometries when positioned in place following a confirmation from the user are merged to the interfering geometry trough a Boolean operation. The pegs when moved in correspondence of the geometric element are by default disposed so their main axis is perpendicular to the surface of the geometric element at the point of intersection between the main axis and the surface. See following illustration. (FIG. 91). The pockets for bone surrogates when dragged in the 3DE are displayed to the user with an arrow indicating the direction of extraction of the bone surrogate and the axis along which the user can interact in performing the training. (FIG. 92). The merging of the pocket to the geometric elements can be performed in the following automated steps: a) FIG. 93—the box delimiting the pocket is subtracted from the geometrical entity; b) FIG. 94—Two additional Boolean subtractions are internally performed with the parallelepipeds created at the windows of the pockets two ensure access of the bone surrogates for use and extraction; c) FIG. 95—the final configuration is obtained merging the pocket with the geometrical entity. For the pocket feature tool, the gizmo allows Euclidean transformations with difference in behavior for the scaling given the standardized sizes of the bone surrogates, in performing the scaling a snapping is performed on the dimensional values for which the bone surrogates will be released to the public. In embodiments, dimensions can be: 20×20×20 mm, 30×30×30 mm, 20×20×3 mm, 30×30×3 mm, 20×20×3 mm, 30×30×3 mm, 20×20×40 mm, 20×20×60 mm, 30×30×60 mm. Hinges, Sliders, and Hooks can be similarly introduced in the 3DE. (FIG. 96). Following the positioning of the elements in the 3DE, the user can choose to verify the status of the entities in relation to their merging to the base. The merged elements are then included in this list as individual items and indicated with an alphanumeric symbol (*). In this process, in the object view, each isolated element has a Real green box if connected to the base while the elements not in contact with the base have a virtual green box. This is a default configuration for which the elements marked as real will be physically realized (3d printed) while the elements marked as virtual will be saved as 3d models and associated to augmented reality markers. The user at this point could accept this realization of the trainer or select the Real box for the elements that they want to be physically realized. (FIG. 97).

FIG. 98 shows total seconds to complete arthroscopic shoulder simulator tasks on a 3D-printed Arthroscopic Shoulder Simulator (3DPASS) and Commerically Available Shoulder Simulator (CASS).

FIG. 99 shows construct validity using the ASSET Rating of Expert Surgeons versus Medical Students for the CASS and 3DPASS.

FIG. 100 shows total seconds to complete arthroscopic shoulder simulator tasks for medical students versus expert surgeon on a commercially available simulator and 3D-printed simulator.

FIG. 101 shows anatomy test score before and after shoulder arthroscopic simulator usage for medical students versus expert attendings on a commercially available simulator and 3D-printed simulator.

FIG. 102 shows an image of examples of prototypes of the modular system with hoods having different color tones.

FIG. 103 shows an embodiment of a 3D printed arthroscopic shoulder simulator.

FIG. 104 shows anatomy test score before and after shoulder arthroscopic simulator usage for the commercially available simulator (Alex 3) and an embodiment of the simulator described herein.

FIG. 105 shows total seconds to complete arthroscopic shoulder simulator tasks on a 3DPASS and CASS.

FIG. 106 shows methods of an experimental evaluation of construct validity of medical students versus novice and expert orthopaedic arthroscopy surgeons.

FIG. 107 shows different arthroscopic tasks tested in the experimental evaluation of construct validity of medical students versus novice and expert orthopaedic arthroscopy surgeons.

FIG. 108 shows ASSET on a 3D-printed arthroscopic shoulder simulator (3DPASS) and commercially available shoulder simulator (CASS).

FIG. 109-FIG. 113 shows exemplary steps to create an embodiment of the system for surgical task training and the features of a Computer Aided Design System conceived for this purpose. These steps cen be performed trough a software environment that provides visualization and editing of tridimensional representation of the anatomy. FIG. 109 shows creation of the training platform base. FIG. 110 shows enrichment of the training platform base with primitives. FIG. 111 shows enrichment of the training platform with anatomical elements. FIG. 112 shows enrichment of the training platform base with arbitrary geometries. A “Drawing tool” can be included for which the system creates a sweep of a circular section along a path decided by the user through the locations of the pointer. FIG. 113 shows enrichment of the training platform with features. In addition to the insertion and editing of entities, a menu of features is also available for the user to add elements such as: pegs for anchoring soft tissues surrogates, pockets to host bone surrogates, joints such as sliders and hinges, and hooks to anchor springs or rubber bands. Referring to FIG. 90 type of elements included in the simulator can be distinguished from one another. For example, the elements indicated as real will be indicated with solid colors while virtual elements can be be displayed in transparency and elements that are indicated as both can be solid and surrounded by a transparent surface created offsetting the element surface by a preset distance.

### DETAILED DESCRIPTION OF THE INVENTION

### Abbreviations and Definitions

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

For purposes of the present disclosure, it is noted that spatially relative terms, such as “up,” “down,” “right,” “left,” “beneath,” “below,” “lower,” “above,” “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device can be otherwise oriented (rotated 90 degrees or at other orientations) and the spatially relative descriptors used herein interpreted accordingly.

As used herein, the term “standard of care” can refer to a diagnostic and/or treatment process for which a clinician follows for a certain type of patient, illness, or clinical circumstance. For example, a standard of care can refer to the ordinary level of skill and care that a clinician is expected to observe in providing clinical care to a patient. In embodiments, the standard of care can vary depending on the patient, the illness, or clinical circumstance. As used herein, “standard care practices” can refer to practices which are standard of care.

As used herein, the term “clinician” can refer to a person qualified in the clinical practice of medicine, psychiatry, or psychology. As used herein, the terms “clinician” and “practitioner” can be used interchangeably. For example, “clinician” can refer to a physician, a surgeon, a veterinarian, a physician assistant, a nurse, or a person practicing under the supervision thereof.

As used herein, the term “board-certified” can refer to a professional whose qualifications have been approved by an official group or governing body. For example, the person is a physician who has graduated from medical school, completed residency, trained under supervision in a specialty, and passed a qualifying exam given by a medical specialty board.

The terms “subject” and “patient” as used herein include all members of the animal kingdom including, but not limited to, mammals, animals (e.g., cats, dogs, horses, swine, etc.) and humans.

### Modular Anatomical System

Aspects of the invention are drawn towards a modular anatomical system configured to simulate a medical procedure as described herein.

Embodiments as described herein can be configured to represent a specific tissue, organ, and/or cavity in the mammalian anatomy, such as the human anatomy.

Embodiments can comprise a base portion, one or more three-dimensional anatomical elements, at least one tracking element, and a processing unit.

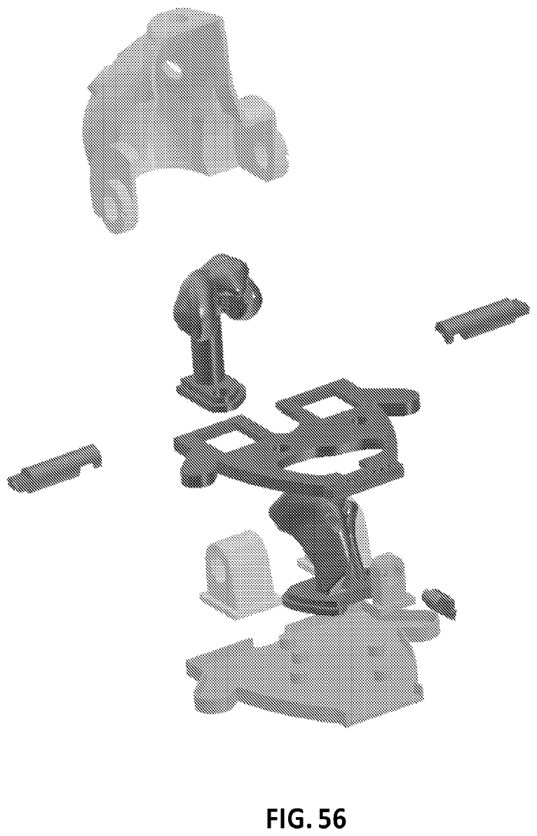

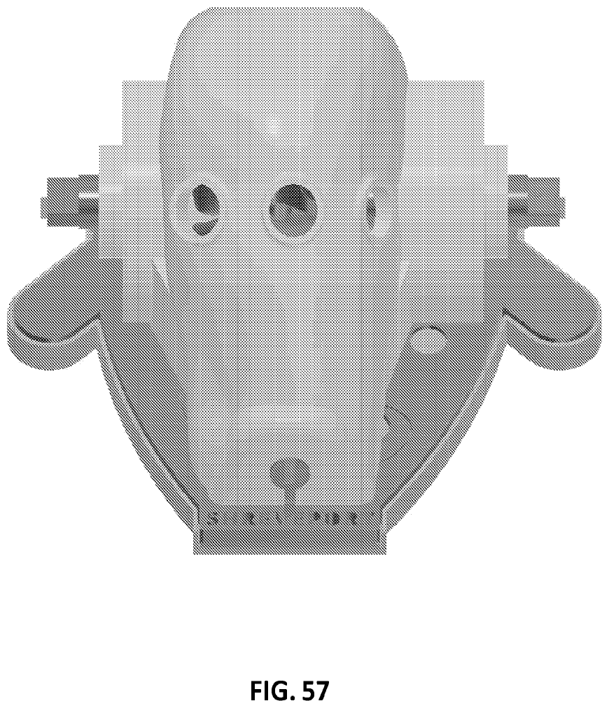

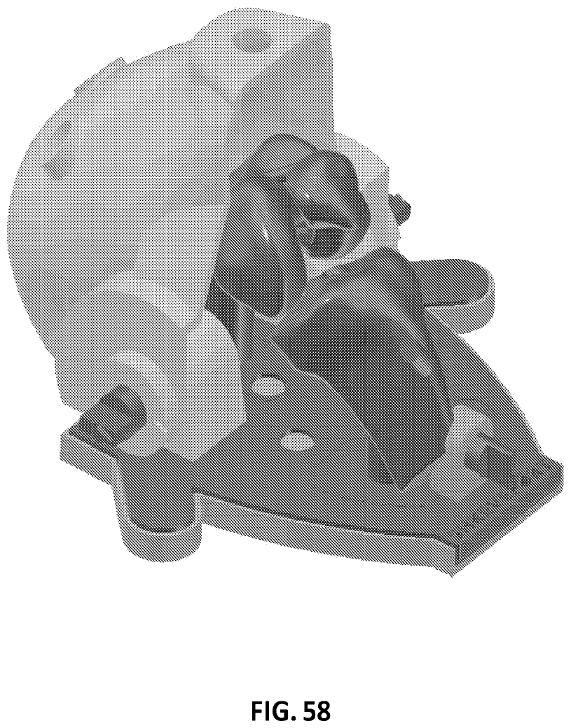

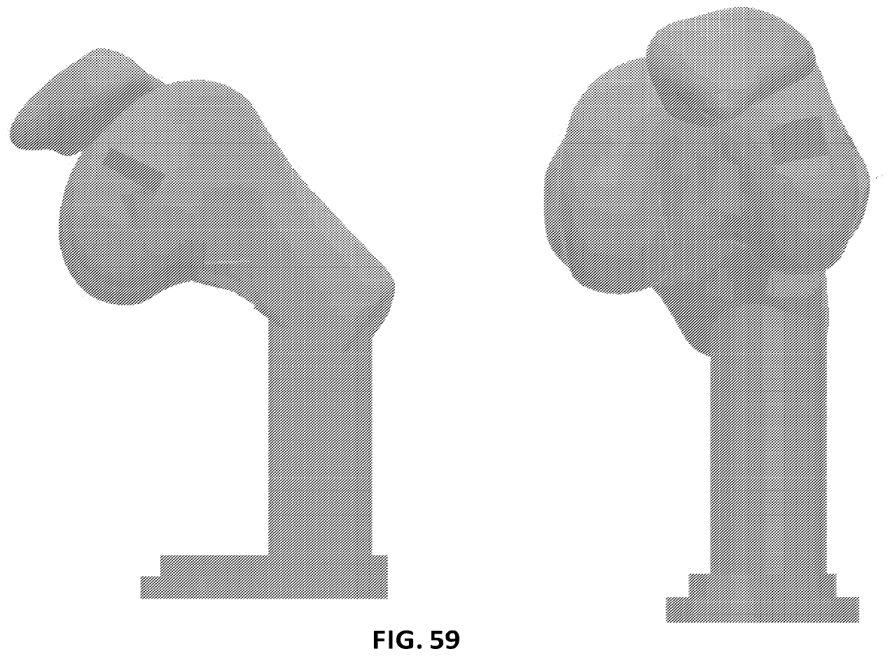

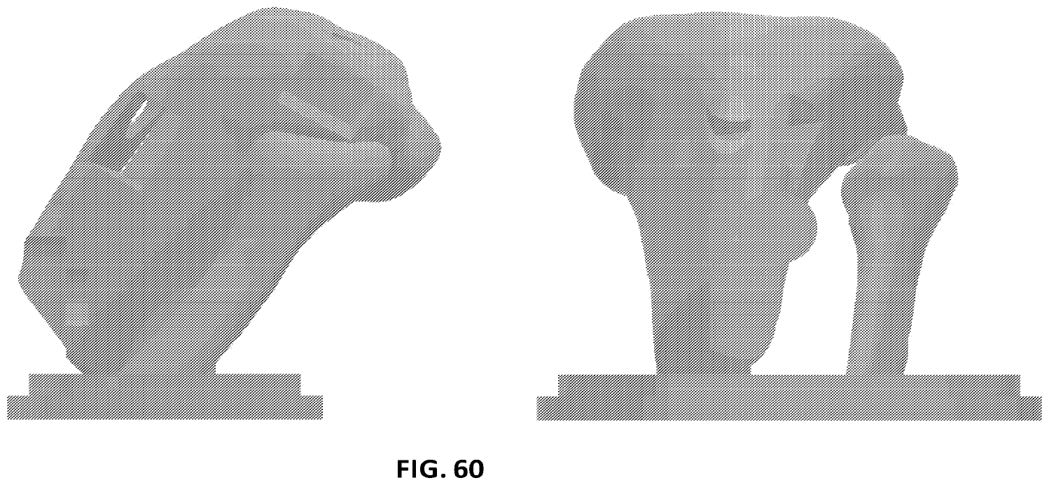

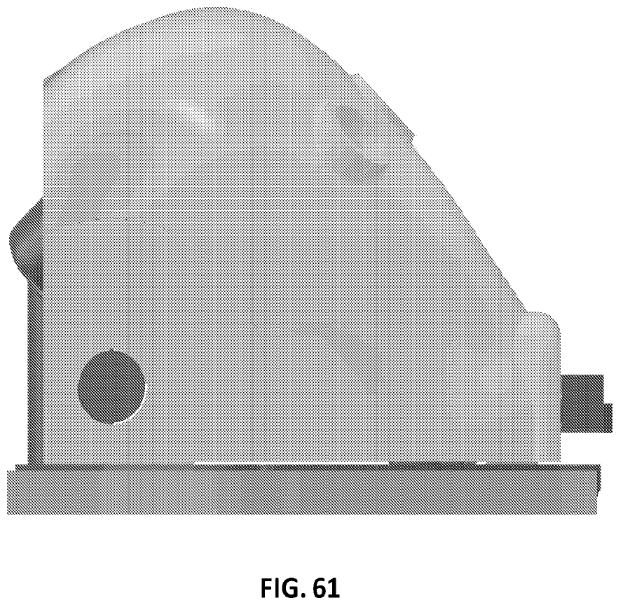

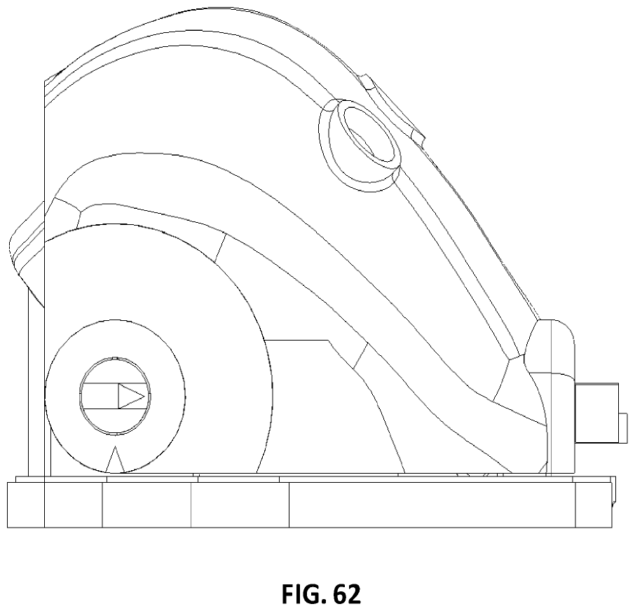

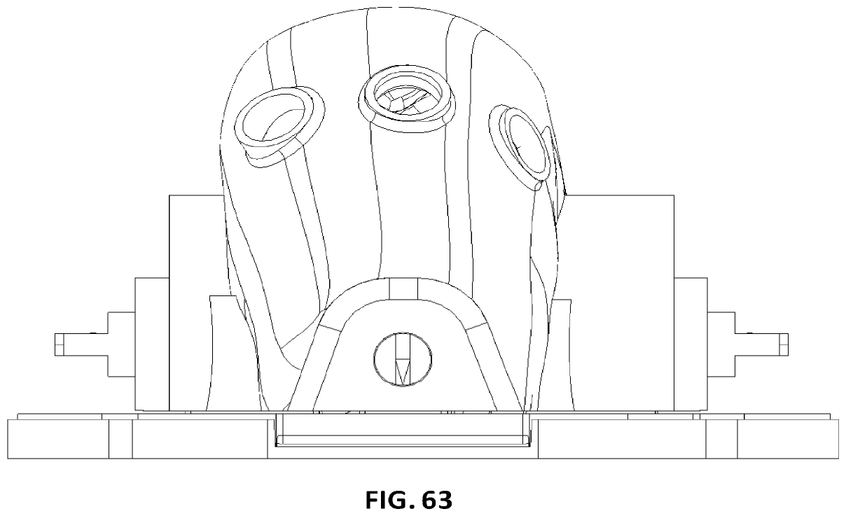

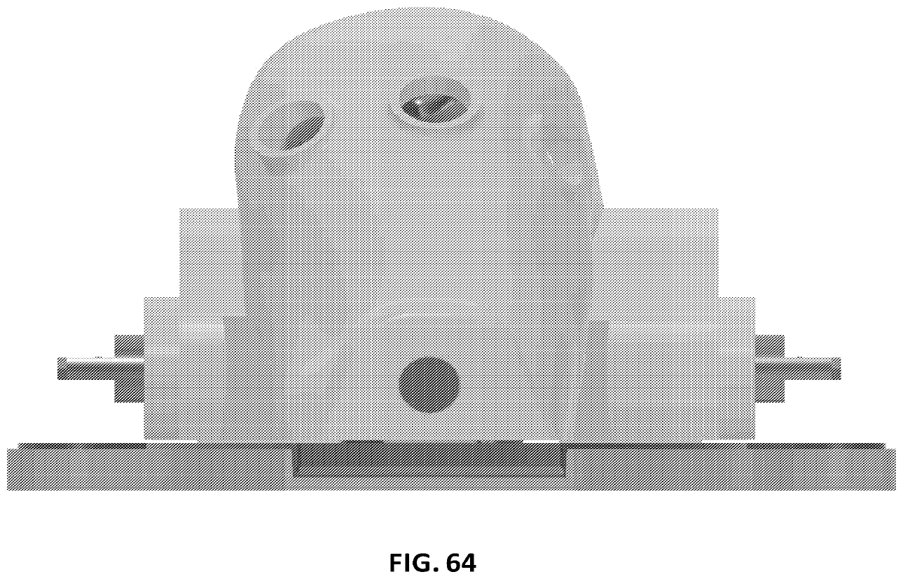

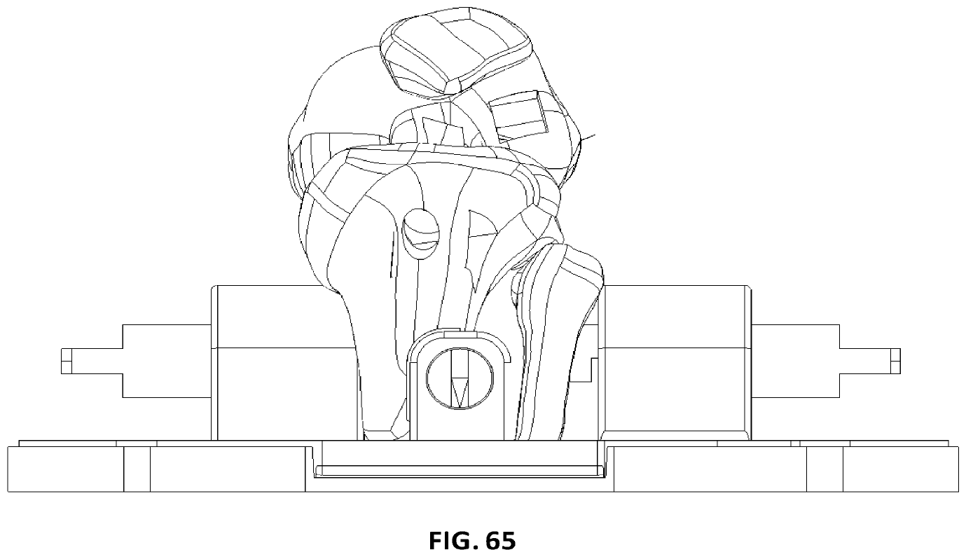

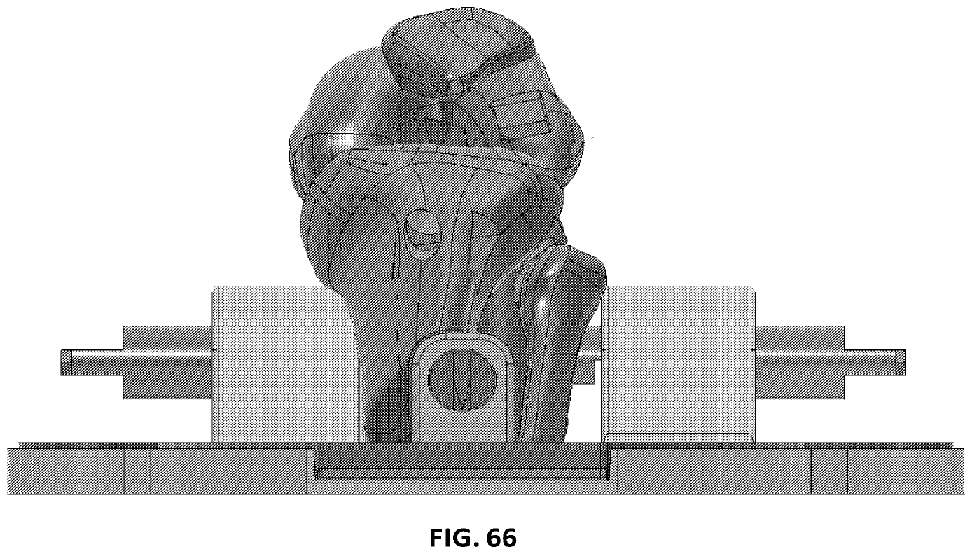

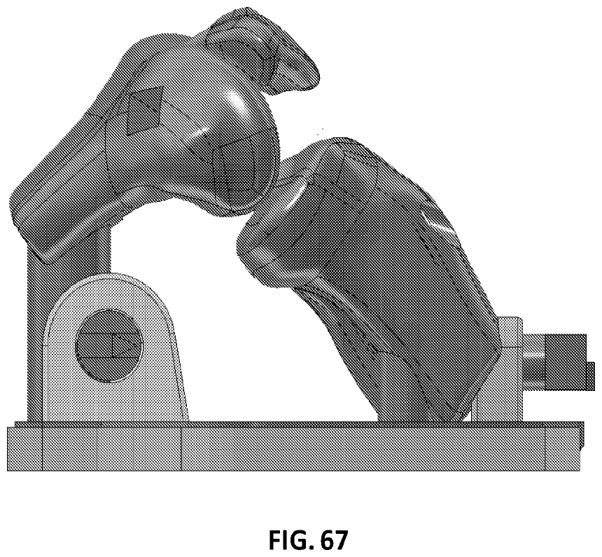

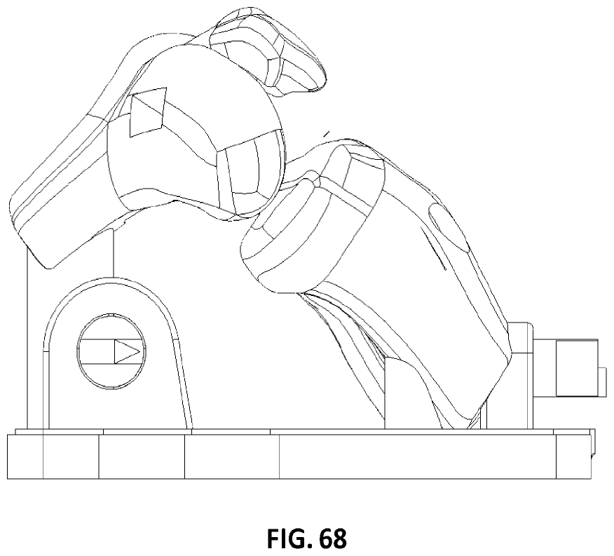

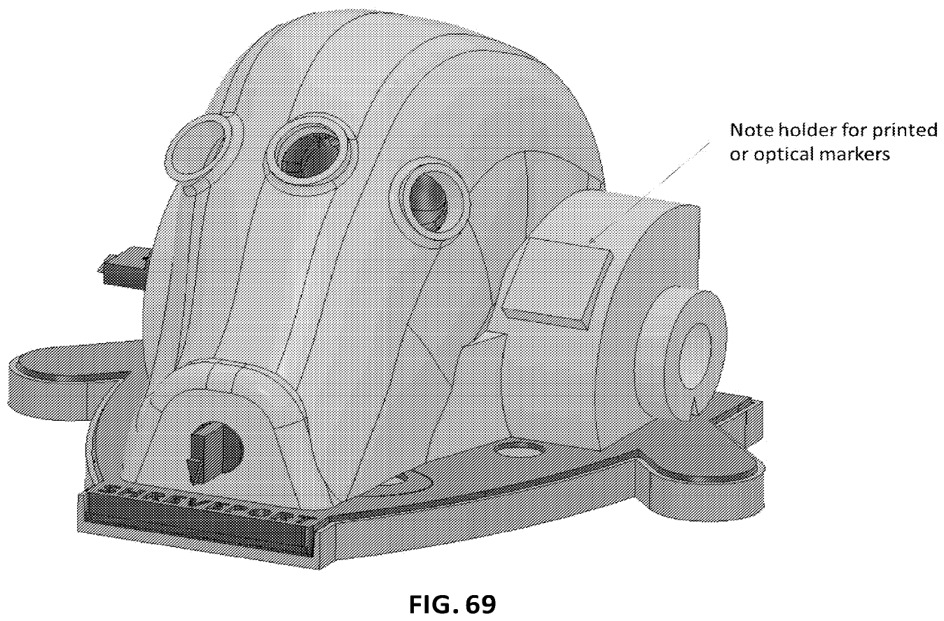

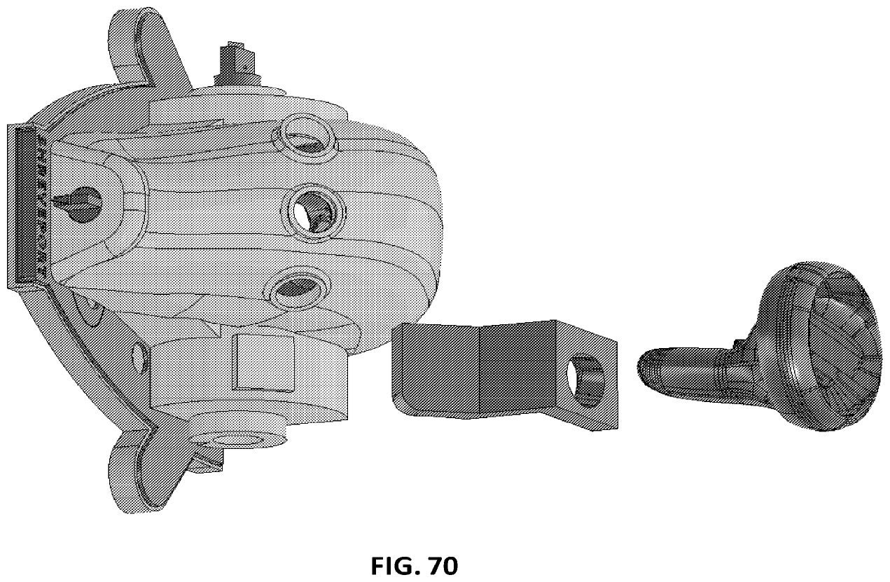

The “base portion” can refer to any support structure that can support the components of the anatomical model as described herein, including but not limited to the one or more anatomical elements and/or the covering portion. In embodiments, the base portion can be planar, and the components of the anatomical model can sit directly atop of the planar base portion. Referring to FIG. 56 and FIG. 58, for example, the base can be upright, and the components of the anatomical model can sit perpendicular to the upright base.

In embodiments, the base portion comprises one or more attachment mechanisms configured to removably attach to a respective anatomical element. The term “attachment mechanism” can refer to a mechanism for binding, joining, or securing a first material to a second material. For example, the attachment mechanism can be for securing an anatomical element to the base portion, a first anatomical element to a second or more anatomical elements, a covering portion to the base portion, and the like. Non-limiting examples of attachment mechanisms can be hooks, snaps, clips, retainers, loop-pile fastners, magnets, latch es, adhesives, or any other mechanism that can permanently or removably attach a first element to a second element.

In embodiments, the one or more attachment mechanisms (and their corresponding anatomical elements) can be arranged at different locations on the base portion, thereby modeling an anatomical feature, deformity, or pathology, such as a mammalian anatomical feature, deformity, or pathology. In embodiments, the anatomical elements can be arranged on the base portion to model a human anatomical feature, deformity, or pathology.

Non-limiting examples of anatomical features comprises the humerus, tibia, femur, fibula, malleoli, radial head, hip, pelvis, sacroiliac joint, spine, ribcage, skull, and the like.

Non-limiting examples of anatomical deformities comprise malalignment, dislocations, dysplasia, fracture, spondylosis, anomalies of the curvature, peromelia, craniosynostosis, and the like.

Non-limiting examples of anatomical pathologies comprise fracture, osteoporosis, polymyalgia rheumatica, cancer, arhrititis, osteoarthritis, rheumatoid arthritis, rickets, fibrous dysplasia, graft-versus-host disease, tennis elbow, oaget disease of bone, multiple myeloma, metabolic bone disease, osteogenesis imperfecta, gout, nerve syndromes, marble bone disease, osteomyelitis, and the like.

For example, the anatomical pathology can be a fracture. Non-limiting examples of such fractures comprise proximal humerus fracture, a humerus shaft fracture, a distal humerus intra-articular T-type fracture, a subtrochanteric femur fracture, a tibia plateau fracture, a tibia shaft fracture, a distal fibula fracture, a medial malleolus fracture, a radial head fracture, a olecranon fracture, a radius and ulna shaft fracture, a distal radius fracture, a posterior malleolus fracture, a calcaneus fracture, a Lisfranc fracture dislocation, an acetabulum fracture, an acetabulum and femur neck, a sacroiliac joint, a spine pedicle, a subtroch fracture, a spherical socket, and a femur shaft fracture.

The “anatomical element” can refer to a three-dimensional representation of a portion of a mammalian anatomy, such as human anatomy. For example, the anatomical element can represent a particular bone, joint, ligament, connective tissue, vasculature tissue, muscle tissue, adipose tissue, dermal tissue, and the like. In embodments, the anatomical element can comprise elements of non-mammalian anatomy previously introduced into the body, such as implants or hardware related to prior medical procedures such as surgeries.

In embodiments, the anatomical element can be constructed from diagnostic imaging of a subject's body. “Diagnostic imaging” can refer to any visual display of structural or functional patterns of organs or tissues for a diagnostic evaluation. It can include measuring the physiologic and metabolic responses to physical or chemical stimuli. A number of modalities exist for medical diagnostic and imaging systems including ultrasound systems, optical imaging systems, computed tomography (CT) systems, x-ray systems (including both conventional and digital or digitized imaging systems), positron emission tomography (PET) systems, single photon emission computed tomography (SPECT) systems, and magnetic resonance imaging (MRI) systems.

In embodiments, the one or more anatomical elements can be articulated or actuated, thereby simulating the relative motion, migration, rotation of natural tissue. For example, the relative migration of bones due to joint instability. For example, the one or more anatomical elements can be actuated by an elastic element, such as a rubber band.

In embodiments, the anatomical element comprises a tissue surrogate. A “tissue surrogate” can refer to a material that can replace or represent the natural tissue and simulate the characteristics of the natural tissue in situ. For example, the term “bone surrogate” can refer to any material which simulates the characteristics of natural bone in situ, including synthetic hydroxyapatite and Ca- and/or Si-containing sol gel systems. Similar to natural tissue, a tissue surrogate can be drilled, have implants inserted into them, sawed, ablated, or excised.

In embodiments, the tissue surrogate can be a synthetic tissue. Synthetic tissues can be fabricated from materials such as wood, PEEK, polyethilene, high-density polyethylene, polyurethane, ABS, PLA, PVA, polystyrene, silicon rubbers, nylon, neoprene, modacrylic, olefin, acrylic, polyester, rayon, vinyon, saran, spandex, vinalon, slime, aramids, kevlar, twaron, modal, dyneema/spectra, polybenzimidazole, sulfar, lyocell, M-5 (PIPD fiber), orlon, zylon (PBO fiber), vectran (TLCP fiber), derclon, silk, silly putty, natural rubber, lacquer, cllulose, cotton, wool, epoxy, teflon, rubber, isoprene, keratine, acetylglucosamine, glucose, phenolic compounds, prodcutds of D-galacturonic acid, fibroin, and the like.

In embodiments, the anatomical element can comprise a cadaver tissue, an animal tissue, or portions thereof.

In embodiments, components of the system can be made via molding, machining, 3D-printing, or any combination of the same. For example, components of the system can be molded, manufactured, or 3D-printed according to shapes or objects saved on a server and downloaded through a website.

For example, the anatomical element itself can be fabricated from a tissue surrogate in its entirety, or the anatomical element can be fabricated from one material but be configured to removably host and/or anchor the tissue surrogate therein. For example, the anatomical element can have pockets, pegs, or other attachment mechanisms to removably host and/or anchor the tissue surrogate. In this manner, the operator attempting the surgical approaches only sacrifices the tissue surrogate rather than the entire anatomical element. After completion of a training exercise, the tissue surrogate can be removed and replaced with a new one for additional exercises.

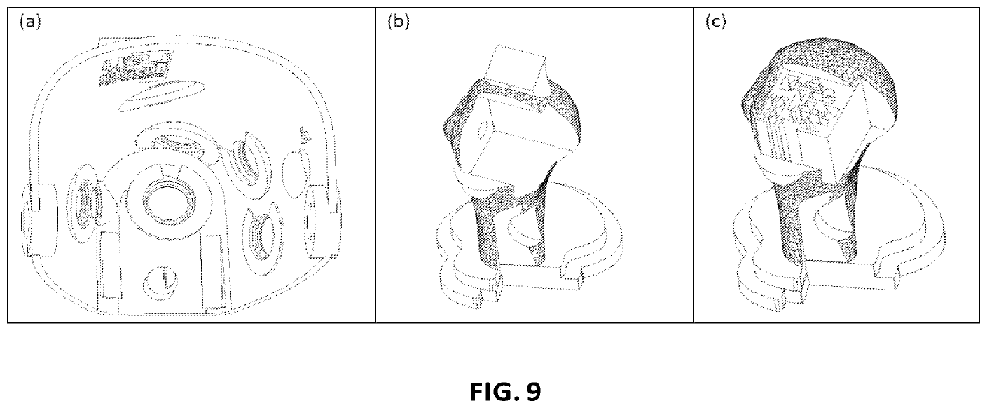

In embodiments, the anatomical elements can comprise one or more “hosting elements”. For example, a hosting element can be configured to host a tissue surrogate. Non-limiting examples of hosting elements include a receptacle, pocket, peg, hook, slide, hole, or socket. For example, the hosting element can be designed such that the tissue surrogate can slide into the hosting element, such as slide into the socket or receptacle. In embodiments, the insertion/extraction direction of the tissue surrogate is perpendicular to the direction of instrumentation, impaction, implantation described in surgical training, such that when placing force on the surrogate, the surrogate will not pull out (see, for example, FIG. 9, panels B and C). In embodiments, there can be holes in connecting to the socket or receptacle so the user can push or pull the tissue surrogate out from the hosting element (e.g., a socket or receptacle).

Hosting elements can be embedded into the system, such as embedded into the anatomical element.

The “tracking element” can refer to an element that identifies or tracks anatomy, structures, and activities within a training surgical environment. For example, tracking elements can include markers placed within a surgical task training environment to enable the display of virtual elements in the context of augmented or mixed realities. These augmented reality markers comprise an image or an object that can be recognized by an augmented reality equipped processing unit and camera recognition system. The image or object is used to trigger augmented reality features. The markers can be used to track elements and activities in the surgical training environment in relation to a user in order to provide haptic feedback to surgical task training performed in virtual reality. Further, a tracking element can include an alphanumeric code printed on an anatomical element in the surgical training environment. As yet another example, a tracking element can include an RFID tag or chip embedded in anatomical element. The RFID tag or chip is capable of broadcasting information identifying the anatomical element.

The “processing unit” can refer to a unit or system that includes any collection of processor-based devices or computing devices operating together, or components of processing systems or devices. For example, the processing system can include one or more personal computers, workstations, servers, main-frame computers, laptop computers, mobile computers, smart phones, tablets, or combinations thereof. The processing system can include components within a larger computer system.

In embodiments, the processing unit can be communicatively linked to the tracking elements. “Communicatively linked” can refer to communication paths that couple these components. Communication paths include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, the Internet, mobile networks, and cellular networks. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

The modular anatomical system can further comprise a “covering portion”, or “hood”, comprising at least one access portal. An “access portal” can refer to a physical opening that provides the operator access to the area under the covering portion containing the components of the system, including the one or more anatomical elements. In embodiments, the access portal can be covered by softer elastic material mimicking human skin to allow the incision with surgical scalpels. The access portals can be dispersed throughout the hood depending on the medical procedure and anatomy desired. For example, the at least one access portal comprises anterior, anterior superior, anterior inferior, superior, lateral, posterior inferior, posterior, or any combination thereof.

### Medical Procedure Simulation System

Aspects of the invention are drawn towards a medical procedure simulation system. In embodiments, the system comprises a modular anatomical system as described herein, software, and a display screen.

In embodiments, the software is configured to calculate an operator proficiency score and/or determine running time, and the display screen is configured to display the operator proficiency score and/or running time.

The medical procedure simulation system can further comprise a microcontroller. A “microcontroller” can refer to a small computer on a single metal-oxide-semiconductor (MOS) integrated circuit (IC) chip. A microcontroller contains one or more CPUs (processor cores) along with memory and programmable input/output peripherals.

In embodiments, the microcontroller can comprise a timer, an interface to a processing unit, an output to the display, or a combination thereof.

### Methods of Using Systems

Embodiments as described herein can be used to simulate a medical procedure, thereby allowing a user to demonstrate, practice, or evaluate a medical procedure or technique.

The term “medical procedure” can refer to any clinical or diagnostic procedure performed by a medical practitioner (e.g., including, but not limited to a physician or physicians assistant, a nurse or nurse practitioner, or a veterinarian). Non-limiting examples of a medical procedure comprises an arthroscopic procedure, a laparoscopic procedure, an endoscopic procedure, fluoroscopic image guided procedure, an ultrasound guided procedure, or an image guided procedure.

In embodiments, the medical procedure comprises a “surgical procedure”. “Surgical procedure”, “surgery” and related terms “surgical,” “surgical operation,” or “surgical intervention” can refer to any medical procedure involving an incision into a tissue. For example, the surgical procedure comprises an otolaryngology procedure, a neurosurgery, a gastroenterology procedure, a urology procedure, a cardiovascular surgery, an oral surgery, a pediatric surgery, a plastic surgery, an orthopedic surgery, a cardiothoracic surgery, dentistry, podiatry, or any a combination thereof. For example, the surgical procedure comprises acromioclavicular reconstruction, rotator cuff repair, shoulder arthroscopic procedures, knee arthroscopic procedures, anterior labral repair, or a combination thereof

Simulating a medical procedure can be used to assess an operator's proficiency with the medical procedure. For example, methods as described herein can be used to determine the total amount of time required for an operator to complete the surgical procedure. Similarly, embodiments as described herein can be used to determine accuracy in the execution, repeatibilaty, trajectories and speed of the tools (including cameras), volumes of the envolopes of the tool movements, extension of the contact surface between tools and anatomy, exercised forces, effective contact pressures, extension of the alterations made to execute the surgery (invasiveness of the procedure), number of contacts made with certain anatomical structures, directions of the contacts, agreement between executed tool paths and paths of reference, number of hand motions to complete a task, number of errors, number of dangerous movements on vital structures (nerves, blood vessels, cartilage), smoothness of movements and camera motion, and the like.

Thus, aspects of the invention can be used to provide an operator proficiency score. In embodiments, the operator proficiency score is inversely proportional to the total amount of time required to complete the surgical procedure.

### Other Embodiments

While the invention has been described in conjunction with the detailed description thereof, the foregoing description is intended to illustrate and not limit the scope of the invention, which is defined by the scope of the appended claims. Other aspects, advantages, and modifications are within the scope of the following claims.

The invention will be further described in the following examples, which do not limit the scope of the invention described in the claims.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1—Modular System for Surgical Task Training

In embodiments, the disclosure described herein is directed to training equipment for the execution of surgical tasks.

Various training simulators exist with varying degrees of anatomic accuracy, including cadaveric simulators, virtual reality simulators and a wide range of “bench-top” simulators. Cadavers are the ideal training simulator for most of the surgical tasks however the high price and low availability of cadaver specimens limits their access to trainees. Virtual reality simulators often lack the ability to simulate the interaction between tissues and tools for complex procedures and the enrichment with haptic rendering requires extensive programming and high computational cost; “Bench-top” simulators include a variety of tissue surrogates and are mainly provided by SawBones (Vashon Island, Washington). Examples with high anatomical accuracy include the products branded “Alex 2” and “Alex 3” for the surgery of the arthroscopic surgery of the shoulder. While simulators with low anatomical accuracy, conceived for the training of particular tasks, are mainly constituted by the “Dome rotator cuff anchor training block” and “MagneFAST.” These simulators are expensive, characterized by limited flexibility, and despite the fact that can provide haptic feedback during the execution of tasks, they lack the anatomical complexity of virtual reality simulators. Therefore, we have foreseen the need of a training tool that can overcome the limitation of existing devices in terms of anatomical fidelity, flexibility, and integration with computer graphics

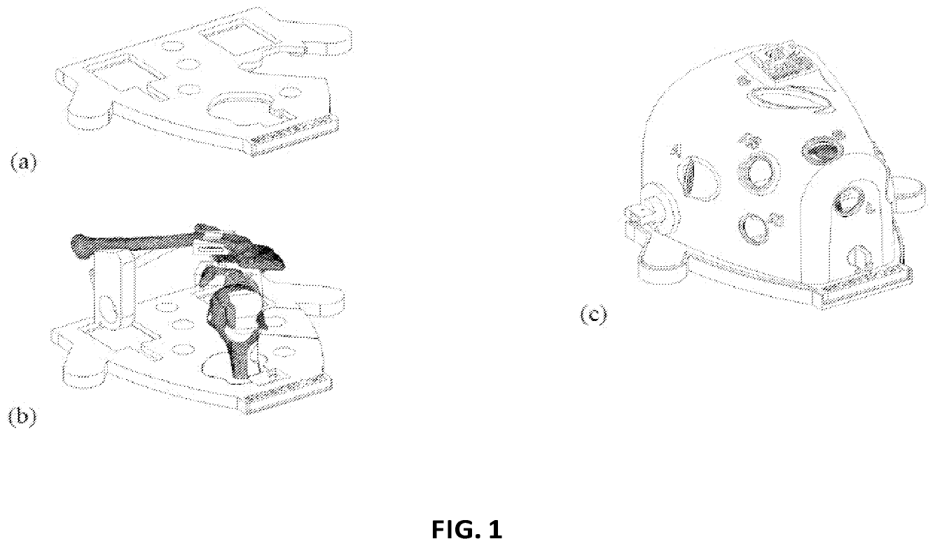

In an embodiment, the modular system for surgical task training is composed by a base that hosts in predefined positions anatomical elements, individual anatomical elements that can be exchanged with various shapes to characterize various pathologies and deformities, and, optionally, a hood that covers the anatomy for the training of arthroscopic, laparoscopic, endoscopic, or simulated fluoroscopic/ultrasound/image guided procedures. (see, for example, FIG. 1).

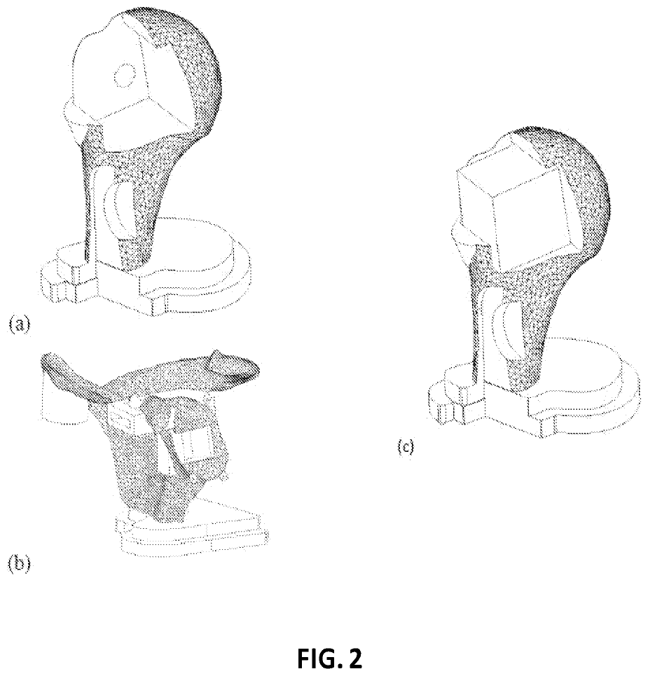

In order to reduce the cost of the supplies, the anatomical elements can have pockets (see, for example, FIG. 2 panel a) or pegs (see, for example, FIG. 2 panel b) to host and anchor tissues surrogates, so the user in attempting surgical approaches, only sacrifices the surrogate in place of the entire anatomical element (see FIG. 2 panel c). These tissue surrogates can be drilled, have implants inserted into them, sawed, ablated, or excised. After completion of the training exercise, the tissue surrogate can then be removed and replaced with a new one for additional exercises. Furthermore, to simulate the relative migration of bones due to joint instability, the single anatomical elements can be articulated or can articulate with the base and such articulation can be actuated by elastic elements such as rubber bands. The anatomical element can also include reinforcing structures to form articulated joints or to accommodate the hosting of tissue surrogates. The structures can be eventually indicated in different color or texture in order to indicate to the user a deviation from the surfaces reconstructed from diagnostic imaging.

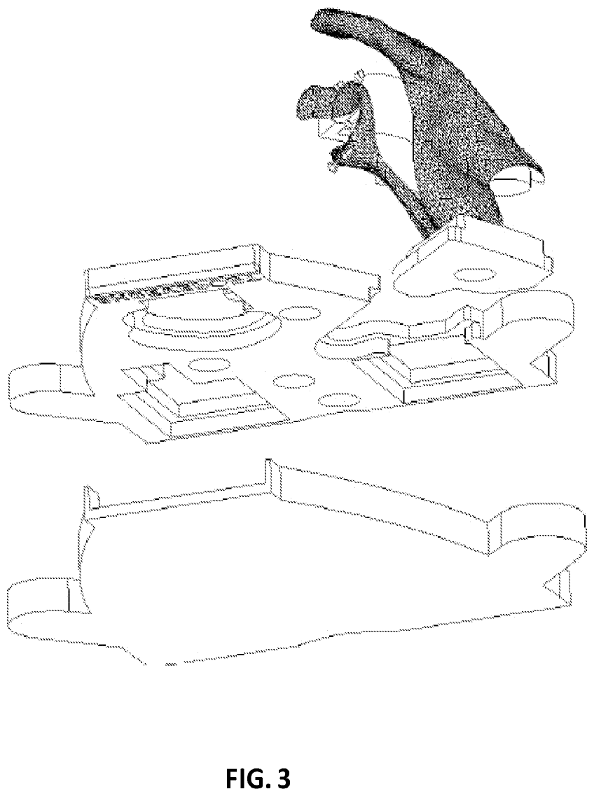

The anatomical elements are anchored to the base trough press-fitting or simply positioned and constrained in place by an additional plate that limits their disengagement from the base. In a preferred embodiment, the base has ledges to allow the anchoring to workbenches through the use of clamps. The ledges have been placed so that the work area of the training can avoid contacting the surface of the workbench. Each anatomical element is ideally derived from computer tomography images and is characterized by a distinctive profile at the base so it can be firmly positioned in a unique designated position (see, for example, FIG. 3).

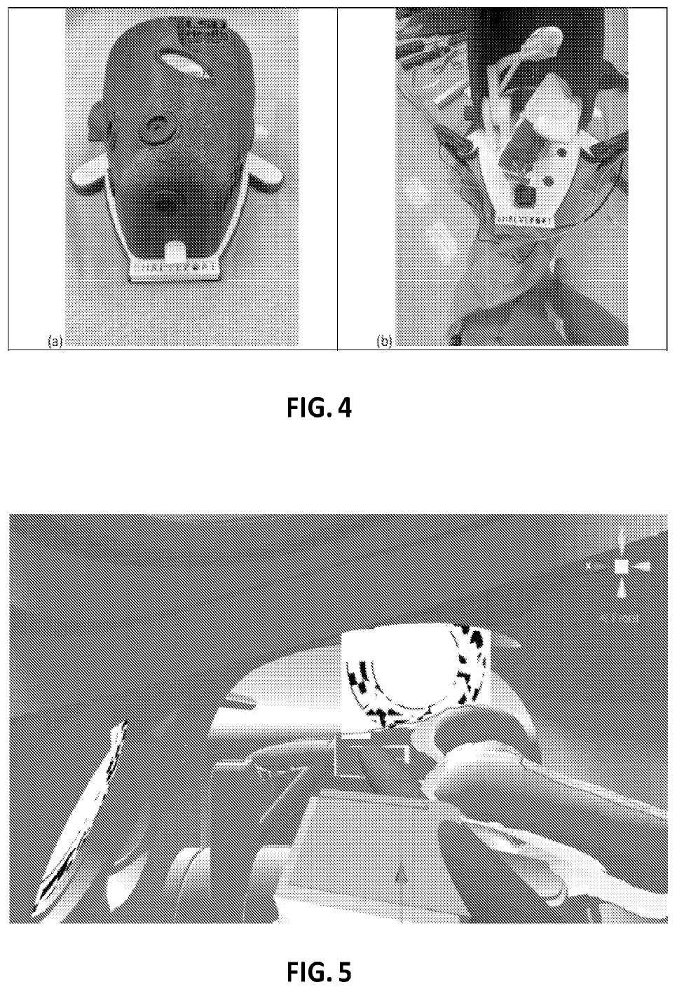

The hood can be articulated with the base to easy the exposure of the inner anatomy and can also have holes and opening in predetermined position for training of specific tasks (see, for example, FIG. 4). While the hood can be characterized by high rigidity and contains alphanumeric characters to be referenced in the training instructions, the opening can be covered by softer elastic material mimicking human skin to allow the incision with surgical scalpels.

Such modular system can be connected to a processing unit for the tracking of various elements involved in the training such as user ID, time to execute the tasks, anatomical elements used. For this last purpose, each anatomical element used is identified through an alphanumeric code that can be simply printed on the element, represented by a marker, or communicated using radio-frequency identification (RFID) technology through an embedded chip.

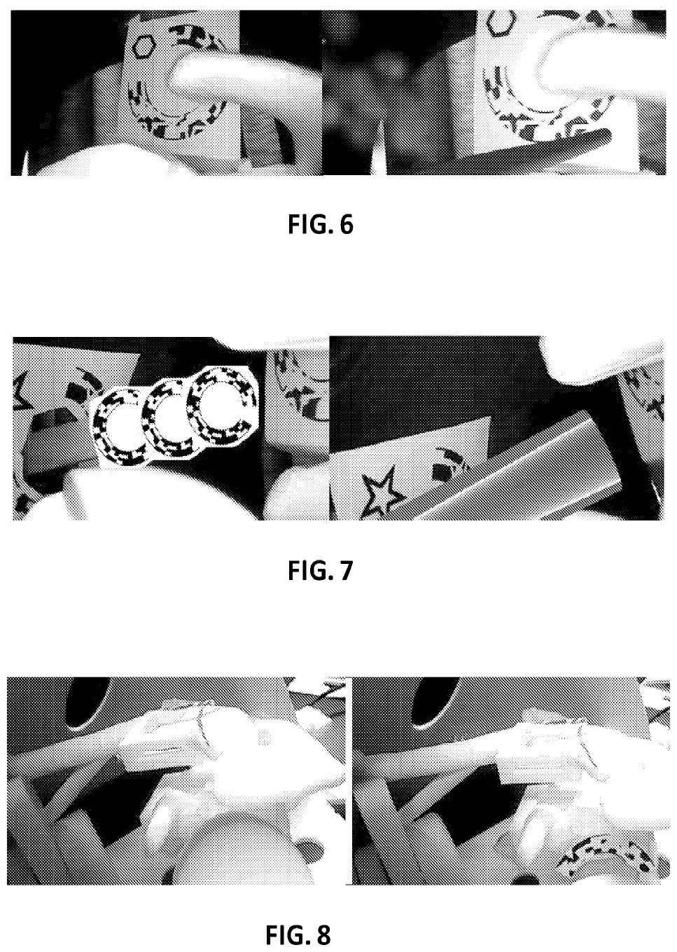

The tracking of the elements in relation to the user is integrated into the system to display virtual elements in the contests of augmented and mixed realities or simply to provide haptic feedback to surgical task training performed in virtual reality. The dome and anatomic model can have unique embossed or raised regions which identify the locations for the tracking elements/markers. The tracking elements can be positioned in areas which can be visible to a camera viewed through one of the access portals. Additionally, the entire anatomic structure and dome can be custom printed with unique patterns to provide a unique marker for augmented or mixed reality for surgical training (See, for example, FIG. 5). Additionally, the entire dome and anatomic model can be scanned, or the model used to produce them can be utilized to create a unique model for augmented or mixed reality tracking. Additional markers can also be placed on real surgical instruments or other objects such as a wooden dowel to include in the scene the visualization of virtual tools that such as a shaver or cauterizer device and behave in an augmented environment like a shaver or cauterizer. This real-world system that incorporates augmented reality tracking, provides for mixed reality exercises which simulate surgical steps such as shaving out tissue, cauterizing blood vessels, and the like. These augmented reality surgical steps receive haptic feedback from the real-world model, dome portals, and tissue surrogates. See, for example, FIG. 6 for an example of an augmented bleeding vessel, and, for example, FIG. 7 for an augmented metallic shaver. FIG. 8 is an example of augmented bursa in the shoulder model.

Augmented reality presents information in a correct real-world context. In order to do this, the system needs to know where the user is and what the user is looking at. Normally, the user explores the environment through a display that portrays the image of the camera together with augmented information. Thus, in practice, the system needs to determine the location and orientation of the camera. With a calibrated camera, the system is then able to render virtual objects in the correct place. The term tracking means calculating the relative pose (location and orientation) of a camera in real time. It is one of the fundamental components of augmented reality.

In marker-based tracking, the system needs to detect the marker, identify it, and then calculate the pose.

A good marker is easily and reliably detectable under all circumstances. Differences in luminance (brightness) are more easily detected than differences in chrominance (color) using machine vision techniques. This is due to the poor automatic white balance of the cameras: the colors register incorrectly, and an object may change its color in the image depending on what else is in the view, for example. Furthermore, the lighting changes the perceived colors of the objects and therefore color detection is challenging. Naturally, the more contrast in the luminance the more easily objects are detected. In this sense, black and white markers are optimal.

The system should also be able to calculate the pose of the camera using the detected marker. Four known points are sufficient to calculate the pose of a camera uniquely and the simplest shape to acquire them is a square. In addition, the locations of the corner points are relatively robust, as they can be estimated as intersections of edge lines. Therefore, many of the marker systems use black and white square markers but embodiments are not so limited.

The first goal of a marker detection process is to find the outlines of potential markers, and then to deduce locations of marker's corners in the image. In addition, detection system needs to confirm that it really is a marker and decipher its identity. Finally, the system calculates the pose using the information from the detected marker location.

Before the actual detection of the marker, the system needs to obtain an intensity image (a greyscale image). If the captured image format is something else, the system converts it, e.g. an RGB image is converted into an intensity image. From now on, we will assume that the marker detection system is operating with a greyscale image.

The first task of the marker detection process is to find the boundaries of the potential markers. Detection systems use two approaches: either they first threshold an image and search for markers from the binary image, or they detect edges from a greyscale image. These lower-level image-processing tasks (thresholding, edge detection, line fitting, etc.) are well known.

The pose of a calibrated camera can be uniquely determined from a minimum of four coplanar but non-collinear points. Thus, a system can calculate a marker's pose (relative to camera) in 3D coordinates using the four corner points of the marker in image coordinates.

In an ideal pinhole camera model, all rays pass the infinitely small optical center of a camera, and the object's image registers on an image plane. This is called an ideal image. In digital cameras, the image registers on the image sensor and coordinates of its elements differ from ideal coordinates. The camera image depends on the camera's physical characteristics, e.g. focal length, image sensor orientation and size. A transformation matrix converts world coordinates to ideal camera coordinates.

Of course, the main idea of augmented reality is to present virtual objects in a real environment as if they were part of it. The camera pose is used to render the virtual object in the right scale and perspective. The virtual camera of computer graphics is moved to same pose as the real camera and virtual objects are rendered on top of the real image.

There are several software systems and development frameworks available that provide augmented reality (AR) using markers. Here are a few examples:

Vuforia: Vuforia is a popular AR development platform that offers marker-based AR capabilities. It provides robust marker detection, tracking, and rendering functionalities. With Vuforia, developers can create AR experiences that recognize and track various types of visual markers, including images, QR codes, and 3D objects. Vuforia supports multiple platforms, including iOS, Android, and Unity.

Unity3D with AR Foundation: Unity3D is a popular game development engine that also provides AR functionality through its AR Foundation package. AR Foundation supports marker-based AR by incorporating marker detection, tracking, and rendering features. Developers can utilize Unity's robust game development tools and integrate AR experiences with marker-based tracking using AR Foundation.

Additional software systems include Wikitude and EasyAR but embodiments are not so limited.

The tracking can be performed with shape recognition technologies, optical, or magnetic markers and can include tracking of fine hand or arthroscopic instruments movements. For this purpose, an external camera can be included in the setup in addition to an internal camera constituting the arthroscope. In the context of augmented reality, the system can also be provided of the visualization in real time of computer-generated images rendered as x-rays images to simulate the usage of intraoperative fluoroscopy. Videos from the external cameras and 3d trajectories of hands and tools can be recorded by a processing unit for extraction of performance measure or for display in training session in augmented reality. Markers specific to each instrument and implant can then be placed which are unique and can be recorded. These markers and their 3-dimensional locations relative to the training model can then be recorded while the trainer is performing a task. The trainee can then later or live, view an augmented reality/mixed reality video of the surgical training with virtually augmented instruments and implants on the trainees' model corresponding to the exact location in space that the trainer recording them. For example, the steps and motions of instruments can be recorded during a simulated rotator cuff repair. This augmented reality or virtual reality video can then be played back by another user at another time and location, while the secondary user is viewing the augmented reality video in their separate surgical simulator.

In another embodiment, multiple users can interact in an augmented reality environment at the same time in real time. This can be useful for training, where a teacher can demonstrate a surgical procedure remotely from a different location with a separate surgical simulator with similar dimensions. For example, user A (teacher) could be in a separate location than user B (trainee). User B and user A both are using a surgical simulator and user A is teaching user B how to perform a rotator cuff repair, for example. User A can use instruments which have markers on them which register the instrument's location and angular position. The trainee will then visualize the teacher's instruments in the trainee's augmented reality environment.

In yet another embodiment, the augmented reality environment can have augmented reality instructions with animations to guide the trainee in completing tasks. For example, the tracking software can locate the marker associated with a screwdriver. An animated arrow can then show the trainee where to insert the screwdriver in the augmented reality environment corresponding to the real-life location that the screwdriver needs to be inserted.

In an embodiment, the simulator can be used for standardized testing of users. This can be done by providing a consistent, standardized simulator with identical anatomy to all test takers. The system can be then used to assess the users' skills with objective measures.

In embodiments, the tracking can be used to simulate the use of a fluoroscopic imaging system: the processing unit render simulated x-ray images trough the collection of the relative position between the surrogate fluoroscope and the anatomical elements.

The various parts composing the system have dedicated slots to host printed markers, such slots can be made as arch section concentric to the openings in the hood (see, for example, FIG. 9, panel a), as post that is anchored on the anatomical element (see, for example, FIG. 9, panel b) or the bone surrogate is used as marker (See, for example, FIG. 9, panel c).

An example of application of this system is its application for the training of the arthroscopic surgery of the shoulder: the modular device mimicking the human shoulder anatomy is composed by a hood (representing the skin overlying the shoulder) that covers modular parts representing the clavicle, scapula, and humerus.

The hood contains multiple arthroscopic portals including A (Anterior), AS (Anterior Superior), AI (Anterior Inferior), S (Superior), L (Lateral), PI (Posterior Inferior), and P (posterior) portals. It also contains a slightly larger elliptical opening over the distal clavicle and coracoid process which simulates the small open incision performed by surgeons during an acromioclavicular reconstruction procedure.

3D reconstruction from a CT scan was used to accurately produce the bony anatomy of the shoulder and give a realistic representation of the anatomical relationships during shoulder arthroscopy. The humerus has a pocket in the anatomical position of the greater tuberosity and supraspinatus footprint. A properly sized bone surrogate, for example, in the density of 10 PCF can be used to simulate anchors insertion into the greater tuberosity as is done in rotator cuff repairs.

The scapula element contains two separate compartments which receive sheets of bone surrogates preferably in 20 PCF. One compartment is within the distal tip of the coracoid process which allows holes to be drilled and sutures and suture securing devices to be deployed when simulating an acromioclavicular reconstruction repair. The other compartment on the scapula is located on the articular surface of the glenoid. The compartment continues medially, within the scapular body to allow anchors to be placed when simulating a labral repair. Four pegs or cleats are arranged around the margin of the glenoid at the 2 o'clock, 4 o'clock, 7 o'clock, and 11 o'clock positions which act as anchors to hold an artificial labrum when simulating a labral repair. We have used polyisoprene strips taken from orthopedic sterile gloves to recreate disposable labrum surrogates that were hooked on the four pegs around the margin of the glenoid.

The clavicle contains a compartment for hosting bone surrogates that is positioned directly above the compartment within the coracoid. This compartment allows drilling and suture placement when simulating an Acromioclavicular reconstruction. The clavicle articulates with the base through the connection of its medial into a portion hosting the hinge that connects the hood to the base of the simulator. A rubber band is attached to the bottom of the hinge on the clavicle and tensioned in order to cause the clavicle to displace superiorly (thus demonstrating torn coracoclavicular ligaments). This requires the trainee to tension down the clavicle when simulating an acromioclavicular reconstruction, exactly as is done in an actual patient in the operating room.

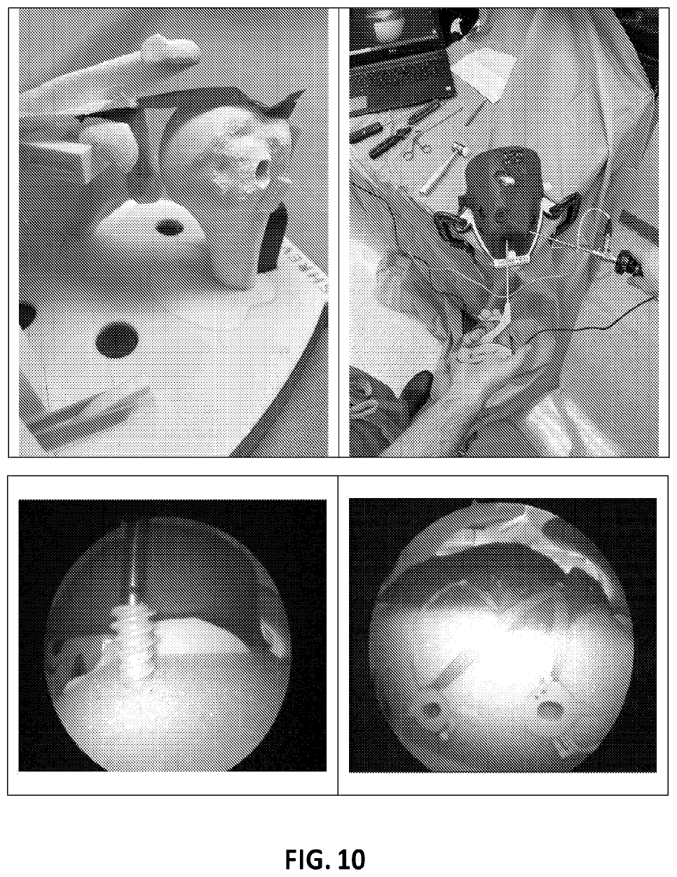

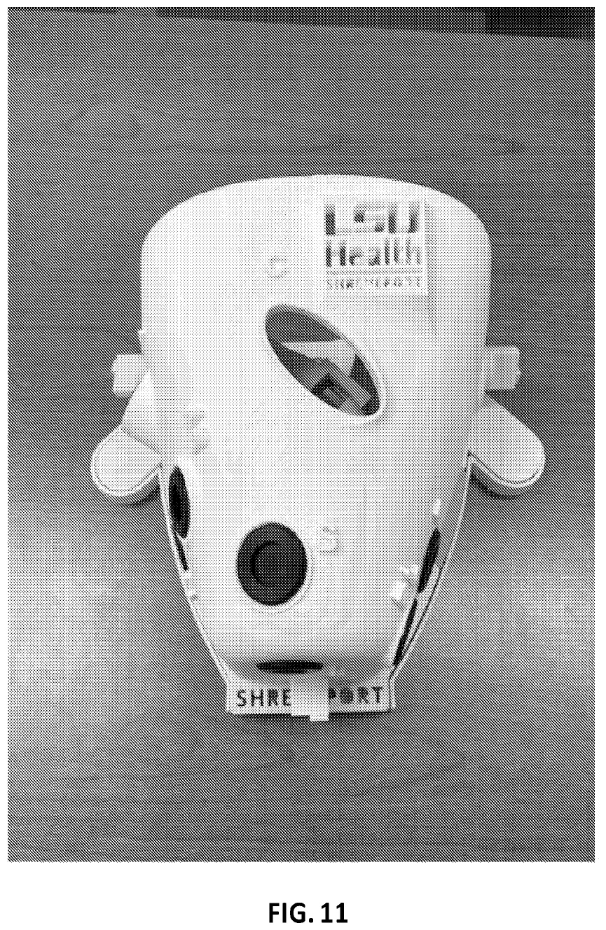

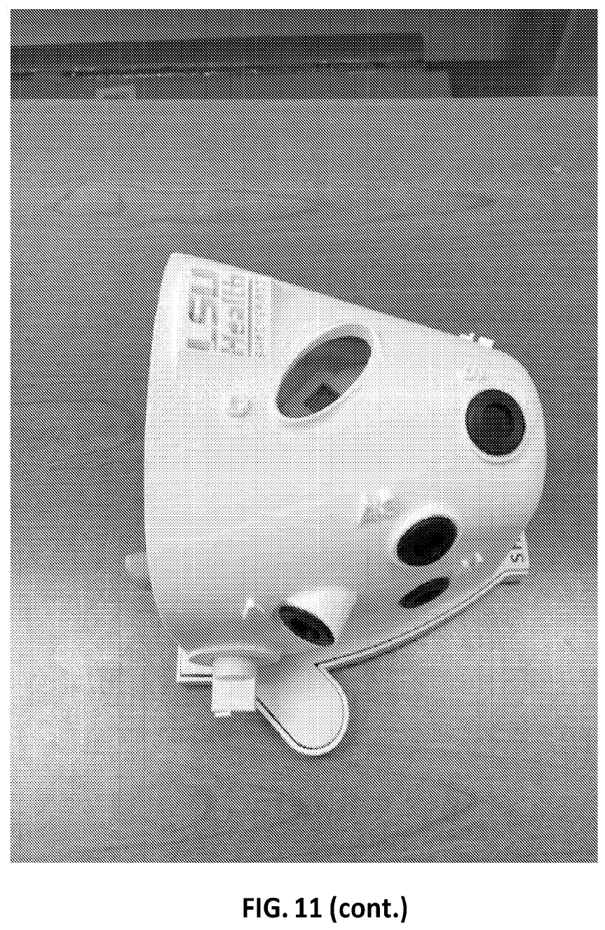

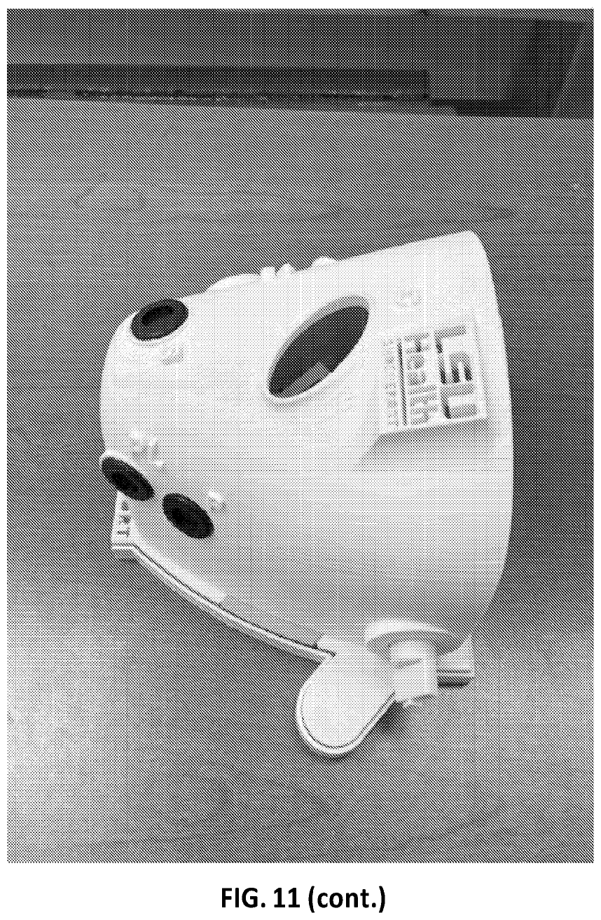

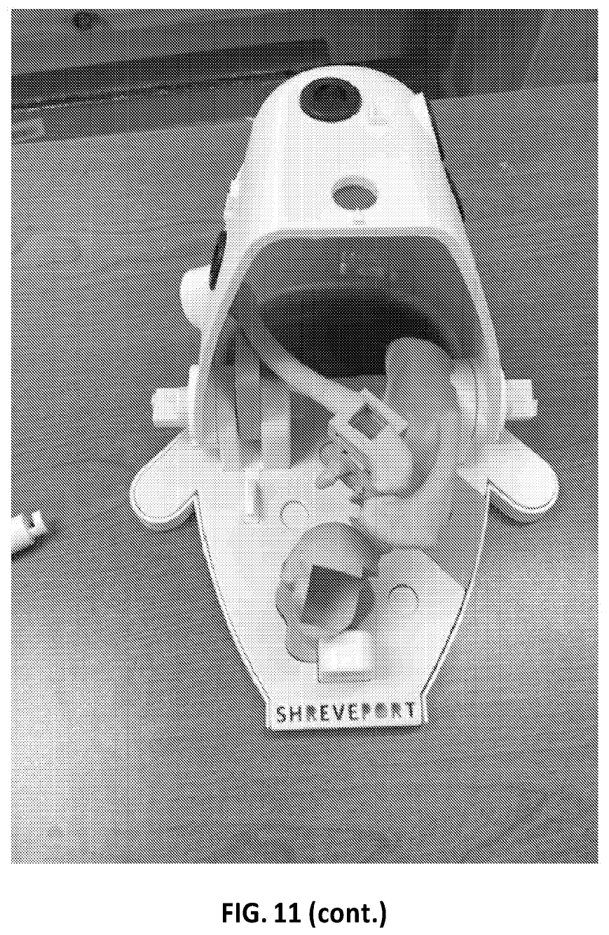

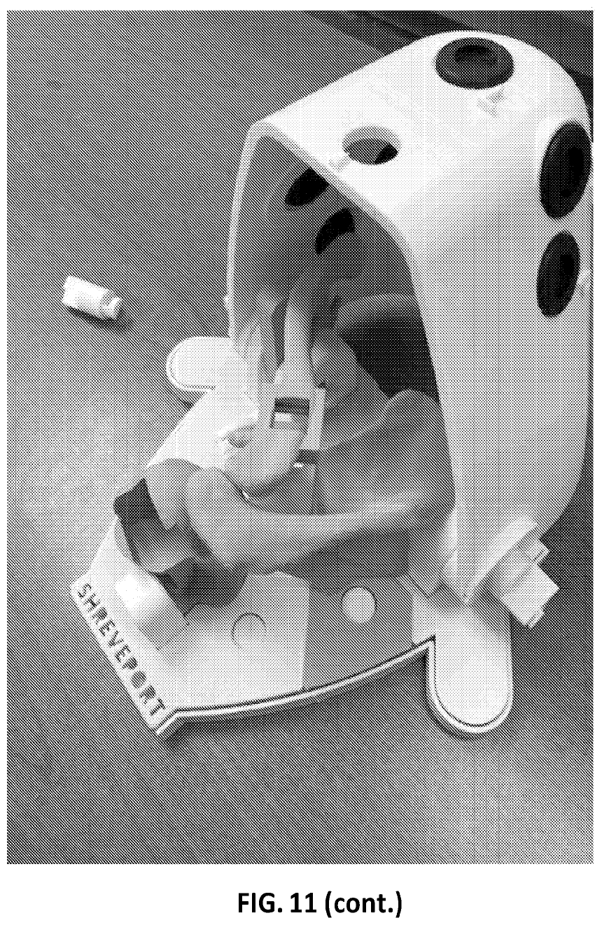

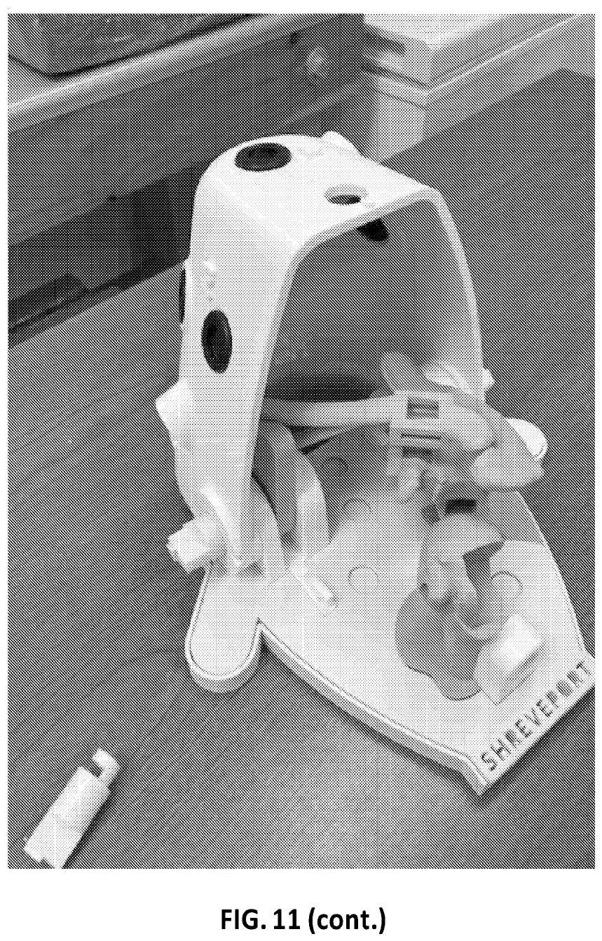

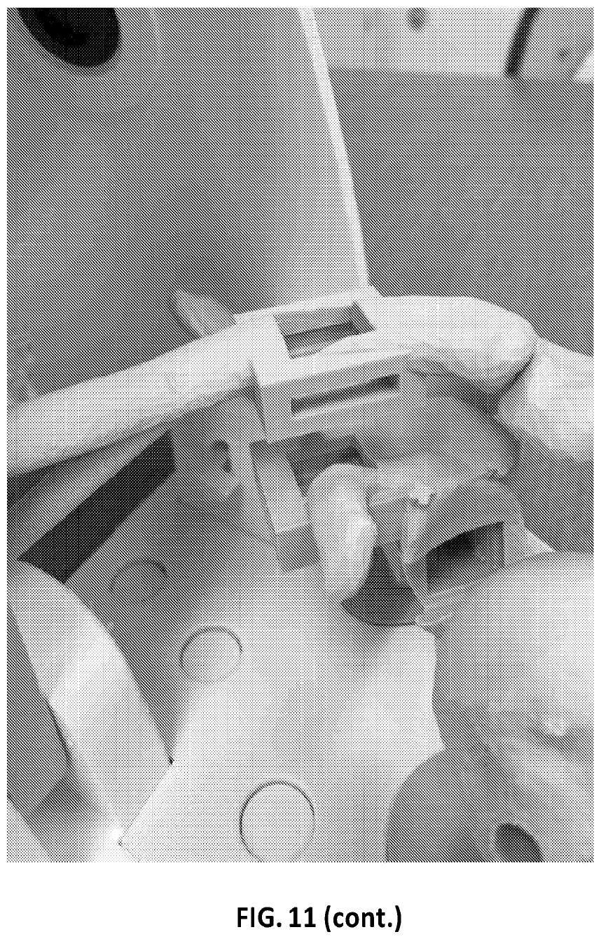

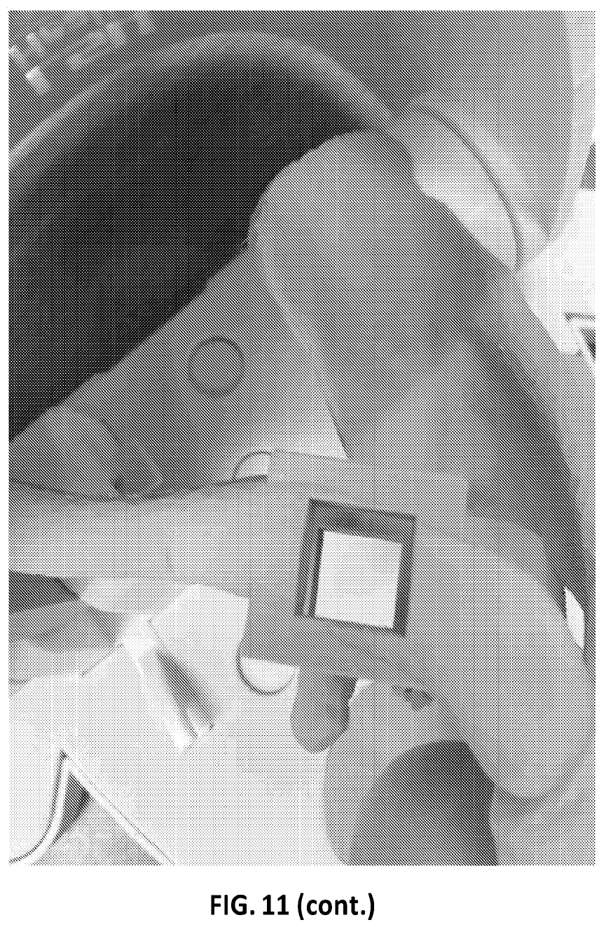

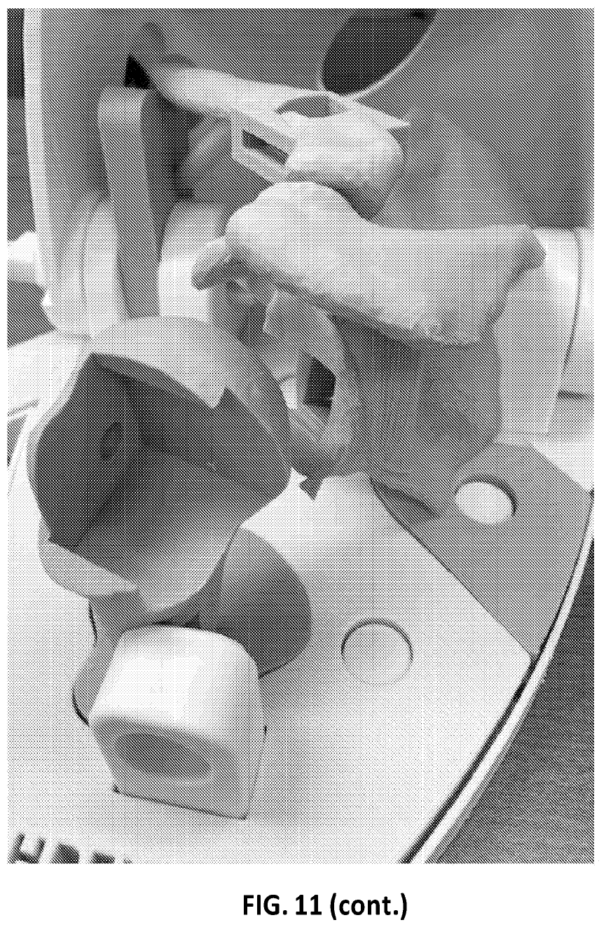

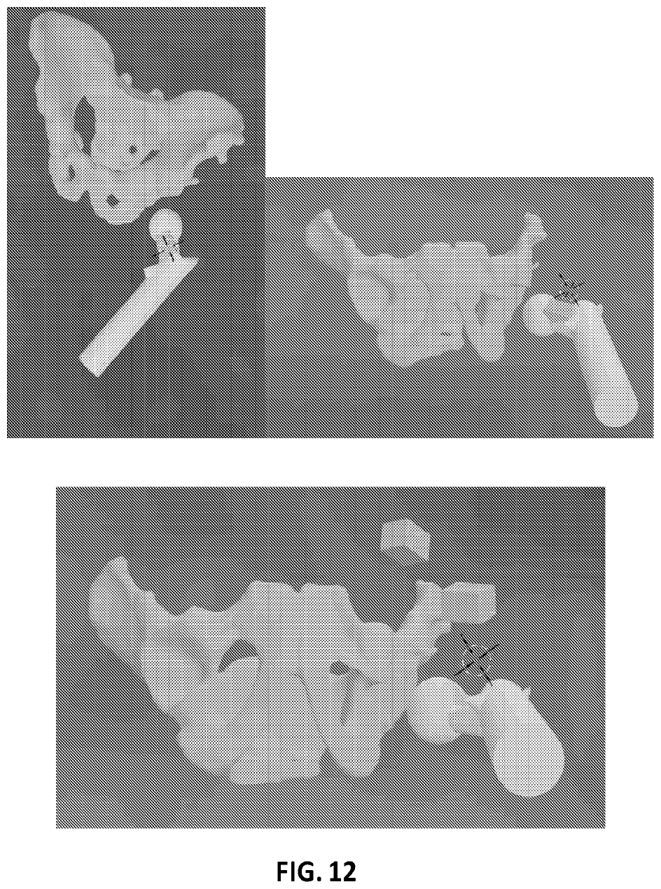

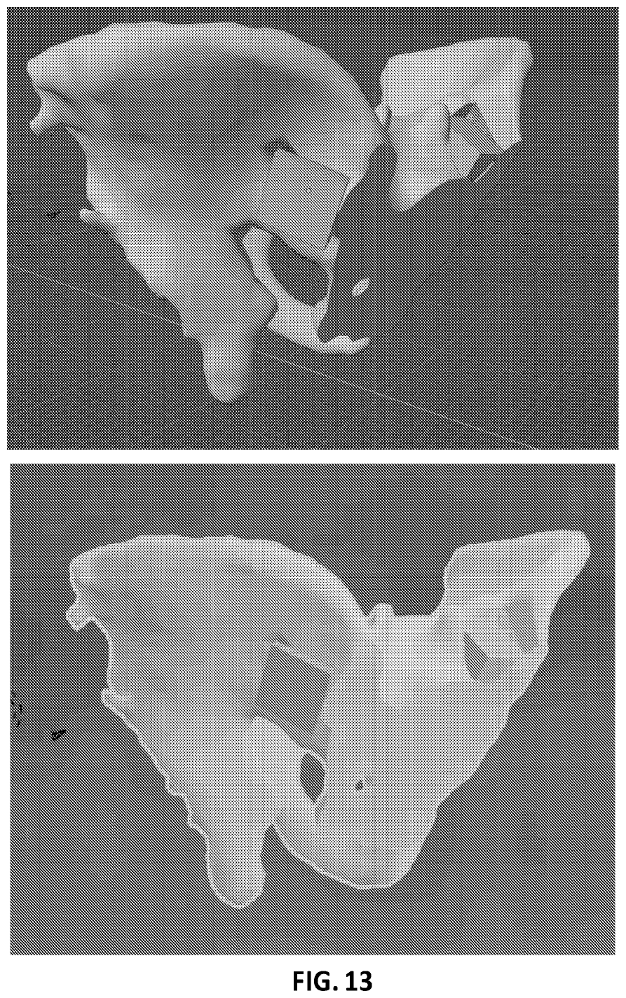

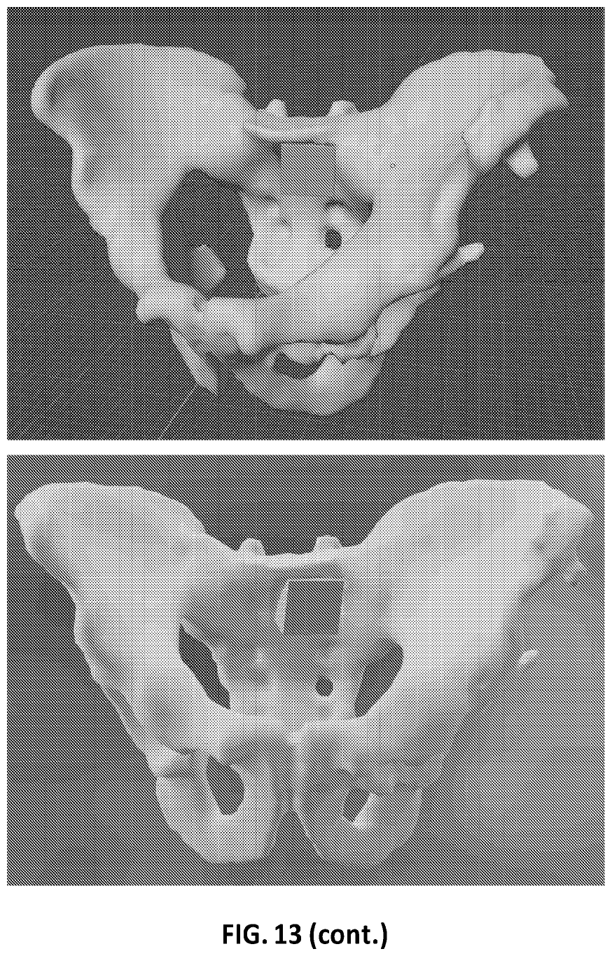

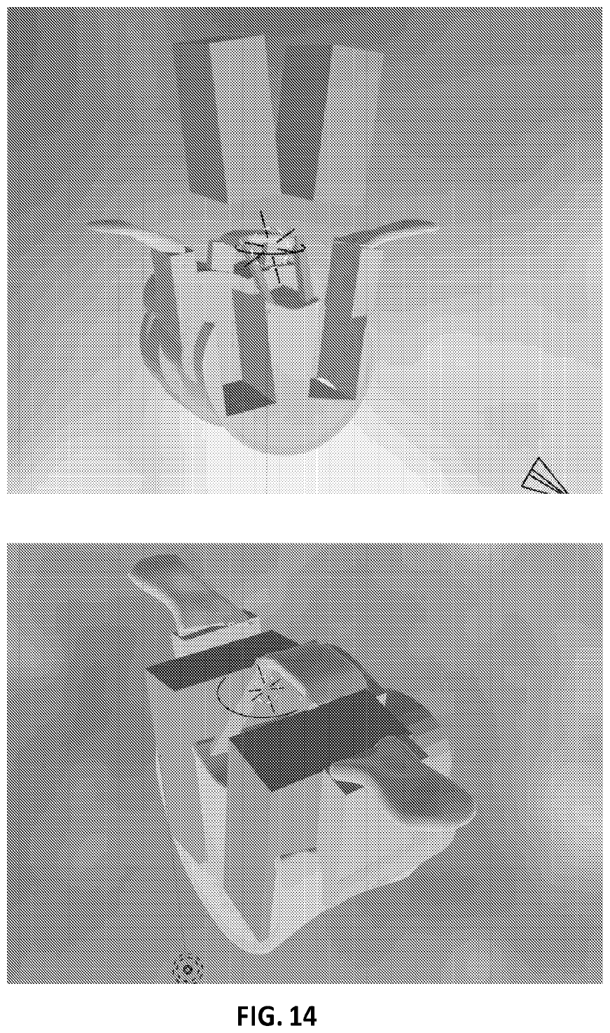

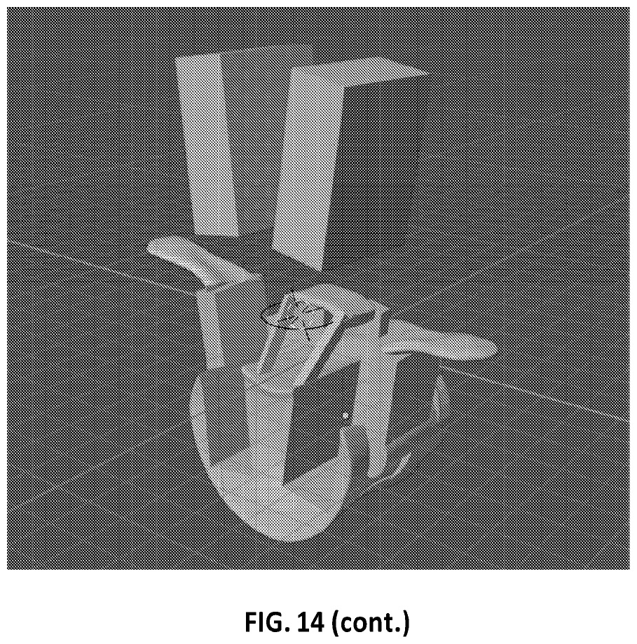

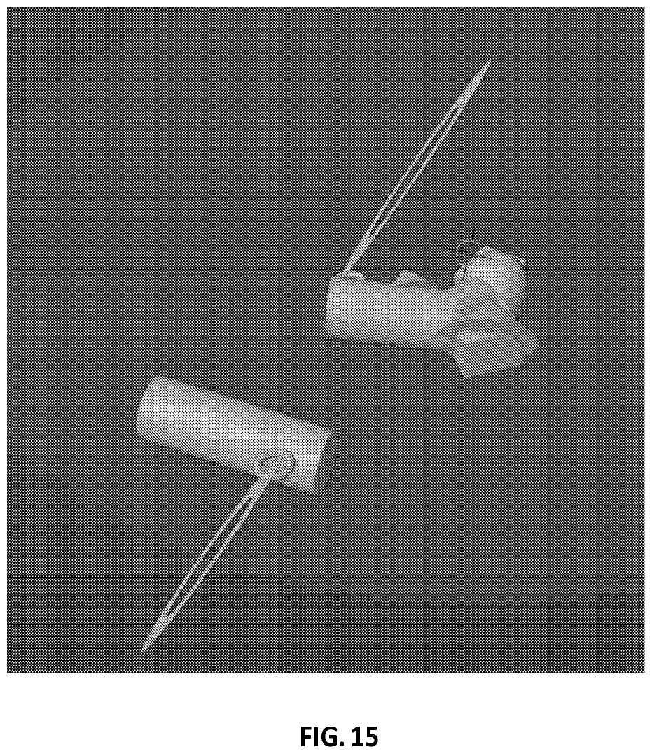

An example of the application of this device is the simulation of a rotator cuff repair. A polyisoprene strip is cut to resemble a torn supraspinatus tendon and secured to the scapula via surgical tape (see, for example, FIG. 10). The arthroscopic camera is inserted through the posterior (P) portal to view the shoulder joint and perform a diagnostic shoulder arthroscopy. The arthroscope is then inserted into the lateral (L) portal while an awl is inserted into the superior (S) portal and a pilot hole is made in the anterior medial position on the greater tuberosity. A suture anchor is then inserted into the superior (S) portal and inserted into the pilot hole in the anteromedial position. This process is repeated for the second medial anchor. The surgical awl is inserted via the superior (S) portal and a pilot hole is formed in the medial posterior position on the greater tuberosity. A second suture anchor with suture is then inserted via the superior (S) portal (all while being viewed from the arthroscope in the lateral (L) portal) and inserted into the medial posterior position. Attention is then turned to placement of the two lateral anchors. The arthroscope is placed in the Posterior Inferior (PI) portal and a surgical awl is placed in the lateral (L) portal. The awl is used to create a pilot hole for the lateral row anterior anchor. Once the pilot hole is created the awl is removed from the lateral (L) portal. A suture anchor is then inserted into the lateral portal under direct supervision from the arthroscope in the posterior inferior (PI) portal. The same process is repeated for the lateral row posterior anchor. This example details a double row rotator cuff repair. It is also possible to simulate a single row rotator cuff repair with this device by simply performing the first half of the above technique.

Another example of the application of this device is the simulator of an anterior labral repair (or Bankart repair). An orthopaedic sterile surgical glove can but cut and fit over the 4 pegs/cleats around the margin of the glenoid, in order to simulate a labrum. A variety of portals and labral fixation devices can be used depending on user preference and device availability. The replaceable sawbones 20 PCF sheet allows the trainee to practice drilling and anchor placement without damaging the 3D printed scapula.

A third application of this device is simulation of an acromioclavicular (AC) reconstruction. AC reconstruction is performed via drilling through both the clavicle and coracoid process and running suture and suture buttons to reduce the displaced clavicle and restore stability to the acromioclavicular joint. The two compartments (one in the clavicle and one in the coracoid process on the scapula) receive sawbone sheets that allow drilling and suture passing to simulate the steps taking in an actual AC reconstruction. Once completed the saw bone sheets can be removed and disposed of and new sheets can be reinserted to allow as many attempts as desired to practice an AC reconstruction. Our device allows simulation of this procedure via an arthroscopic and mini open approach. The elliptical opening above the clavicle simulates the small open incision a surgeon performs when reducing the clavicle and tightening the sutures to complete the AC repair. As with the Rotator cuff repair and Labral repairs, any repair devices can be used depending on device availability.

Embodiments of the disclosure are directed towards shoulder arthroscopy training simulators for orthopaedic surgery trainees.

Various arthroscopy training simulators currently exist, including cadaveric simulators, virtual reality simulators and a wide range of “bench-top” simulators with varying degrees of anatomic accuracy. Cadavers are the ideal training simulator for shoulder arthroscopy training however the high price and low availability of cadaver specimens limits their access to orthopaedic trainees. Virtual reality simulators lack the ability to simulate more complex procedures. “Bench-top” simulators include a variety of simulators produced by SawBones (Vashon Island, Washington). Examples include “Alex 2” and “Alex 3” arthroscopic simulators that replicate the human shoulder with and allow training for specific arthroscopic procedures. However, these simulators are expensive ranging in price from $786-1000 USD in addition to the need to purchase replacement parts depending on the specific procedure being simulated. Other simulators sold by SawBones include the “Dome rotator cuff anchor training block” and “MagneFAST Shoulder Kit.” These simulators do not provide anatomical accuracy but are geared towards providing simulation of various arthroscopic surgical tasks, to improve a trainee's surgical skill before stepping foot in the operating room. While these simulators have been shown to improve a trainee's specific arthroscopic skill, these simulators lack anatomical accuracy.

Embodiments as described herein include a modular device mimicking the human shoulder anatomy with multiple components that allow simulation of various specific shoulder arthroscopic procedures. A hood (representing the skin overlying the shoulder) overlies 3D printed modular parts representing the clavicle, scapula, and humerus. The hood contains multiple arthroscopic portals including A (Anterior), AS (Anterior Superior), AI (Anterior Inferior), S (Superior), L (Lateral), PI (Posterior Inferior), and P (posterior) portals. It also contains a slightly larger elliptical opening over the distal clavicle and coracoid process which simulates the small open incision performed by surgeons during an acromioclavicular reconstruction procedure.

3D reconstruction from a CT scan was used to accurately produce the bony anatomy of the shoulder and give a realistic representation of the anatomical relationships during shoulder arthroscopy. The humerus contains a 30 mm×30 mm×30 mm cubic inset in the anatomical position of the greater tuberosity and supraspinatus footprint. A sawbones 10 PCF block corresponding to the above dimensions can inserted into the humerus pocket thereby giving the operator a disposable bone mimicking block that can be used to simulate inserting anchors into the greater tuberosity as is done in rotator cuff repairs.

The scapula contains two separate compartments which receive 20 PCF sawbone sheets. One compartment is within the distal tip of the coracoid process which allows holes to be drilled and sutures and suture securing devices to be deployed when simulating an acromioclavicular reconstruction repair. The other compartment on the scapula is located on the articular surface of the glenoid. The glenoid compartment is and can receive a similar sawbone sheet 20 PCF. The compartment continues medially, within the scapular body to allow anchors to be placed when simulating a labral repair. Four pegs or cleats are arranged around the margin of the glenoid at the 2 o'clock, 4 o'clock, 7 o'clock, and 11 o'clock positions which act as anchors to hold an artificial labrum when simulating a labral repair. We have used latex orthopedic sterile gloves from the OR and cut them to make a cheap and disposable artificial labrum that can be hooked on the four pegs around the margin of the glenoid.

The clavicle contains a compartment which is positioned directly above the compartment within the coracoid. This compartment receives the same size and density (20 PCF) sawbone sheet to allow drilling and suture placement via the two compartments when simulating an Acromioclavicular reconstruction. The medial end of the clavicle is incorporated into the hinge that connects the hood to the base of the simulator. A rubber band is attached to the bottom of the hinge on the clavicle and tensioned in order to cause the clavicle to displace superiorly (thus demonstrating torn coracoclavicular ligaments). This requires the trainee to tension down the clavicle when simulating an acromioclavicular reconstruction, exactly as is done in an actual patient in the operating room.

An example of the application of this device is the simulation of a rotator cuff repair. An orthopedic sterile surgical glove was cut to resemble a torn supraspinatus tendon and secured to the scapula via surgical tape. The arthroscopic camera is inserted through the posterior (P) portal to view the shoulder joint and perform a diagnostic shoulder arthroscopy. The arthroscope is then inserted into the lateral (L) portal while an awl is inserted into the superior (S) portal and a pilot hole is made in the anterior medial position on the greater tuberosity. A suture anchor with suture is then inserted into the superior (S) portal and inserted into the pilot hole in the anteromedial position. This process is repeated for the second medial anchor. The surgical awl is inserted via the superior (S) portal and a pilot hole is formed in the medial posterior position on the greater tuberosity. A second suture anchor with suture is then inserted via the superior (S) portal (all while being viewed from the arthroscope in the lateral (L) portal) and inserted into the medial posterior position. Attention is then turned to placement of the two lateral anchors. The arthroscope is placed in the Posterior Inferior (PI) portal and a surgical awl is placed in the lateral (L) portal. The awl is used to create a pilot hole for the lateral row anterior anchor. Once the pilot hole is created the awl is removed from the lateral (L) portal. A suture anchor is then inserted into the lateral portal under direct supervision from the arthroscope in the posterior inferior (PI) portal. The same process is repeated for the lateral row posterior anchor. This example details a double row rotator cuff repair. It is also possible to simulate a single row rotator cuff repair with this device by simply performing the first half of the above technique.

Another example of the application of this device is the simulator of an anterior labral repair (or Bankart repair). An orthopaedic sterile surgical glove can but cut and fit over the 4 pegs/cleats around the margin of the glenoid, to simulate a labrum. A variety of portals and labral fixation devices can be used depending on user preference and device availability. The anatomical element comprising a tissue surrogate, such as a replaceable drillable block or sheet, allows the trainee to practice drilling and anchor placement without damaging the 3D printed scapula.

A third application of this device is simulation of an acromioclavicular (AC) reconstruction. AC reconstruction is performed via drilling through both the clavicle and coracoid process and running suture and suture buttons to reduce the displaced clavicle and restore stability to the acromioclavicular joint. The two compartments (one in the clavicle and one in the coracoid process on the scapula) receive sawbone sheets that allow drilling and suture passing to simulate the steps taking in an actual AC reconstruction. Once completed the saw bone sheets can be removed and disposed of and new sheets can be reinserted to allow as many attempts as desired to practice an AC reconstruction. Our device allows simulation of this procedure via an arthroscopic and mini open approach. The elliptical opening above the clavicle simulates the small open incision a surgeon performs when reducing the clavicle and tightening the sutures to complete the AC repair. As with the Rotator cuff repair and Labral repairs, any repair devices can be used depending on device availability.

### Example 2—Fracture Deformity Simulator

Fracture Deformity Simulator: A system for simulating fracture deformity forces for bone fractures, dislocations, or separations with Sockets for Blocks to simulate bone for drilling and placement of screws. This simulation system allows the user to practice reducing bones or making them straight with simulated deforming forces resisting the reduction. These forces are created by attaching elastic devices to the simulated bone and attaching the other end to a ring with hooks every 45 degrees.

An anatomic modeled synthetic bone can be created. A transverse or oblique or comminuted simulated fracture can be made in the body. Rectangular sockets can be placed in the bone on one side of the fracture and another set of sockets can be made on the other side of the fracture. Hooks can then be placed on each side of the fracture to attach elastic material (rubber or springs). This can then be attached to the fracture rings to create deforming forces which simulate muscle, tendon or ligaments in the human body.

Below are embodiments of various models and configurations. All sockets whereby simulated bone can be inserted are in orange.
1. Proximal Humerus Fracture Model
   a. Humerus shaft: An anteriormedial based hook which can have a elastic material attached.
      a. Simulates: Pectoralis Major
         i. deforming force: anterior and medial on the shaft
   b. Humerus Head: A lateral posterior hook which can have a elastic material attached.
      a. Simulates: Supraspinatous, infraspinatous, teres minor
         i. Deforming force: external rotation of the head/greater tuberosity
      c. Simulated surgery (blue)—plate and screws
2. Humerus Shaft Fracture Model
   a. Proximal Humerus Shaft: A lateral hook which can have a elastic material attached.
      a. Simulates: Deltoid
         i. Deforming force: abduction
   b. Distal Humerus Shaft: A medial based hook which can have a elastic material attached.
      a. Simulates: Biceps and Triceps
         i. deforming force: Shortening and medial displacement
      c. Simulated surgery (blue)—plate and screws
3. Distal Humerus Intra-articular T-type Fracture Model
   e. Proximal Humerus Shaft: A lateral hook which can have a elastic material attached.
      a. Simulates: Deltoid
         i. Deforming force: abduction
   f. Distal Fragments: A medial and lateral based hook which spreads the fragments.
      a. Simulates: Biceps and Triceps
         i. deforming force: Shortening and medial displacement
   g. Simulated surgery (blue)—medial and lateral plate with screws
4. Subtrochanteric Femur Fracture
   i. Proximal femur: An anterior lateral hook which can have a elastic material attached.
      a. Simulates: iliopsoas and gluteus medius
         i. Deforming force: abduction and flexion
   j. Distal Femur: A medial based hook which can have a elastic material attached.
      a. Simulates: adductors
         i. deforming force: Shortening and medial displacement
   k. Simulated surgery—nail with locking screws
5. Tibia plateau Fracture
   a. Multiple sockets in the proximal tibia with a simulated fracture at the metaphysis and sockets in the shaft.
   b. Simulated surgery—plate and screws
6. Tibia shaft fracture—intramedullary nail
   a. Medial and lateral sockets in the proximal tibia
   b. simulated mid shaft transverse fracture
   c. distal sockets for placement of locking screws
   d. simulated surgery—nail with locking screws
7. Distal fibula fracture-placement of lateral plate
   a. Proximal socket
   b. Distal socket
   c. Oblique simulated fracture
   d. simulated surgery-plate and screws
8. Medial malleolus
   a. Oblique simulated medial malleolus fracture
   b. Socket in metaphysis distally
   c. Socket in medial malleolus
9. Radial head—plate can be applied in blue
   a. Transverse radial neck simulated fracture
   b. Socket in radial head
   c. Socket in proximal radial shaft
   d. Simulated surgery (blue)—plate and screws
10. Olecranon fracture
   a. Transverse simulated fracture
   b. Proximal socket for olecranon tip
   c. Socket in coronoid region and shaft region
   d. Simulated surgery (blue)—plate and screws or tension band
11. Radius and ulna shaft
   a. Ulna transverse fracture simulated distally
   b. Ulna distal socket to simulated fracture
   c. Ulna proximal socket to fracture
   d. Radius simulated fracture in shaft
   e. Socket proximal and distal to fracture
   f. Simulated surgery (blue)—plate and screws
12. Distal Radius
   a. Distal radius fracture
   b. Distal ulnar aspect radius with socket
   c. Radial styloid with socket
   d. Metaphysis proximal to fracture with socket
   f. Simulated surgery (blue)—volar plate and screws
13. Posterior malleolus fracture
   a. Simulated vertical posterior malleolus fracture
   b. Socket in distal tibia plafond and metaphysis
   c. Socket in posterior malleolus
   d. Simulated surgery (blue)—posterior plate and screws
14. Calcaneus fracture
   a. Simulated mid body fracture
   b. Anterior and posterior sockets for lateral plate application (blue)
   d. Simulated surgery (blue)—lateral plate and screws
15. Lisfranc fracture dislocation
   a. 2nd metatarsal base socket
   b. Medial cuneiform base socket
   c. Simulated surgery (blue)—medial screw placement or button and rope placement
16. Acetabulum fracture
   a. Simulated transverse acetabulum fracture
   b. Socket superior to fracture
   c. Socket inferior to fracture
   d. Simulated surgery (blue)—plate placement with screws

### Example 3—Camera and Tool Holsters

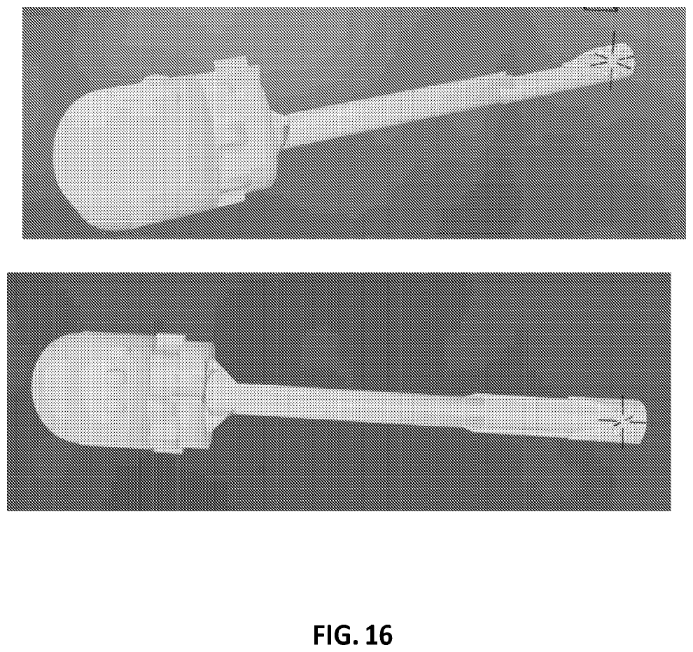

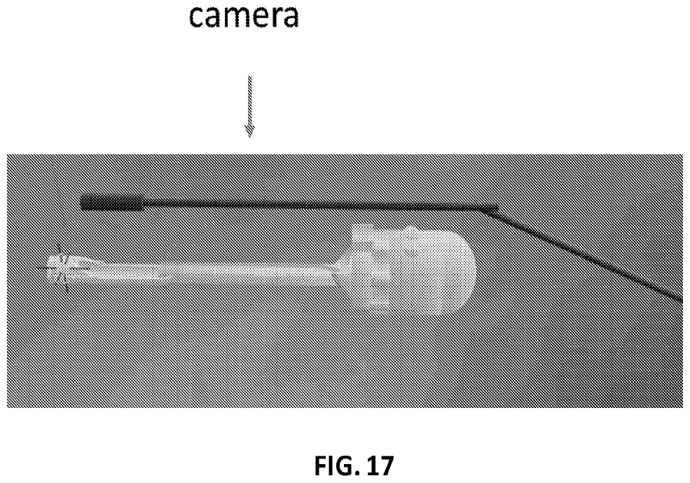

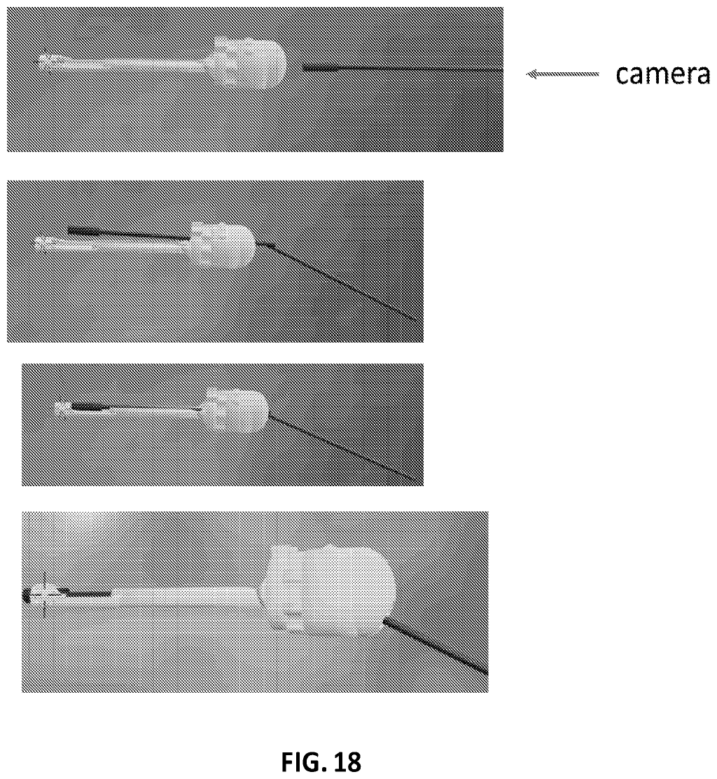

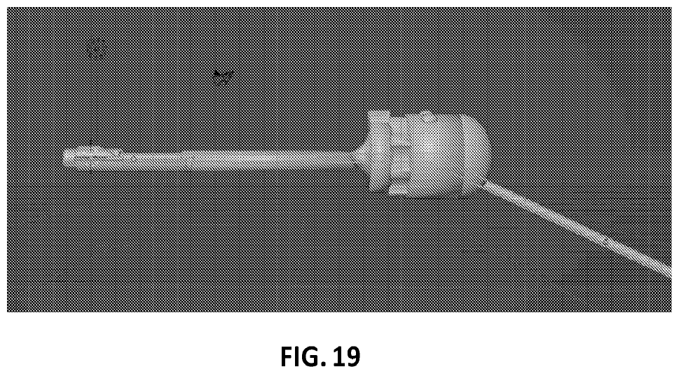

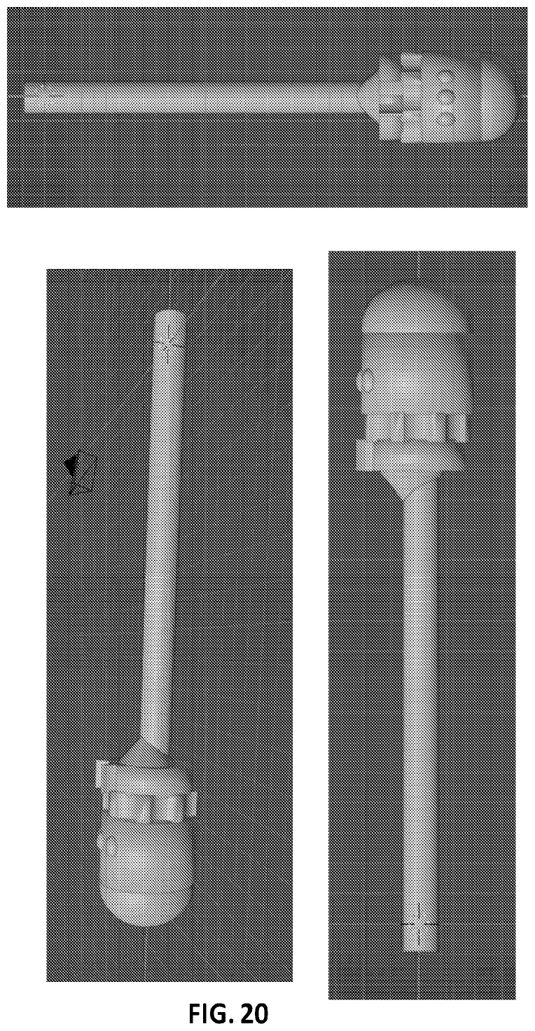

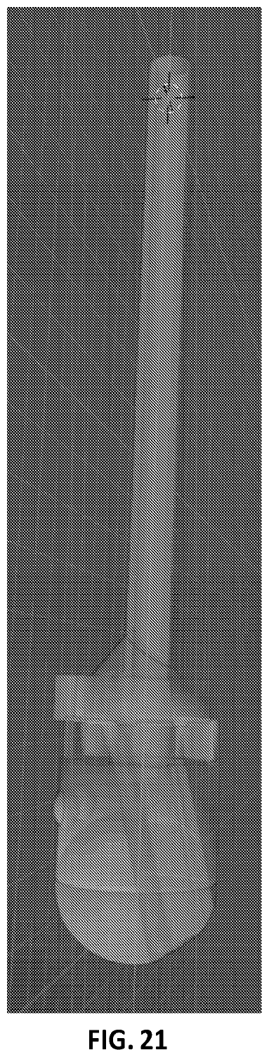

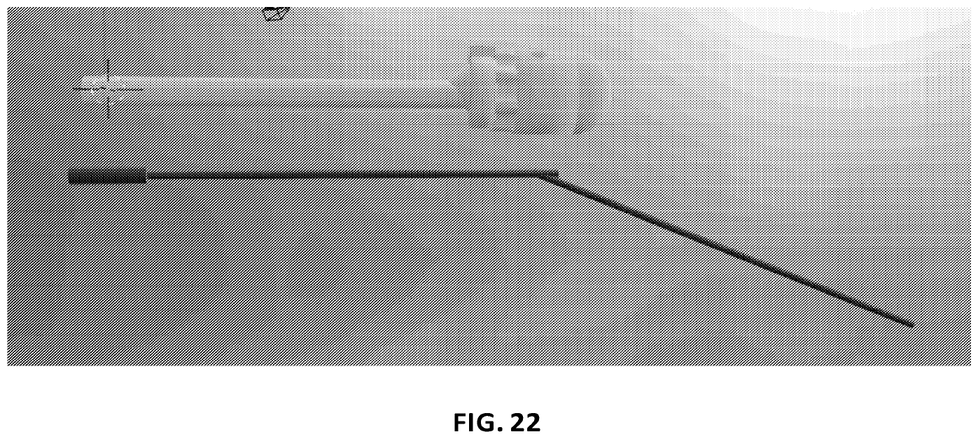

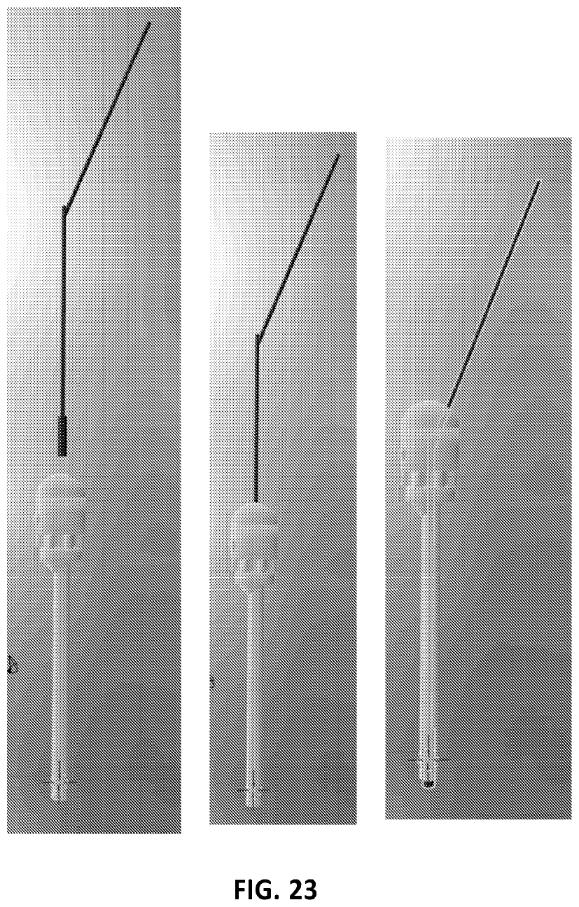

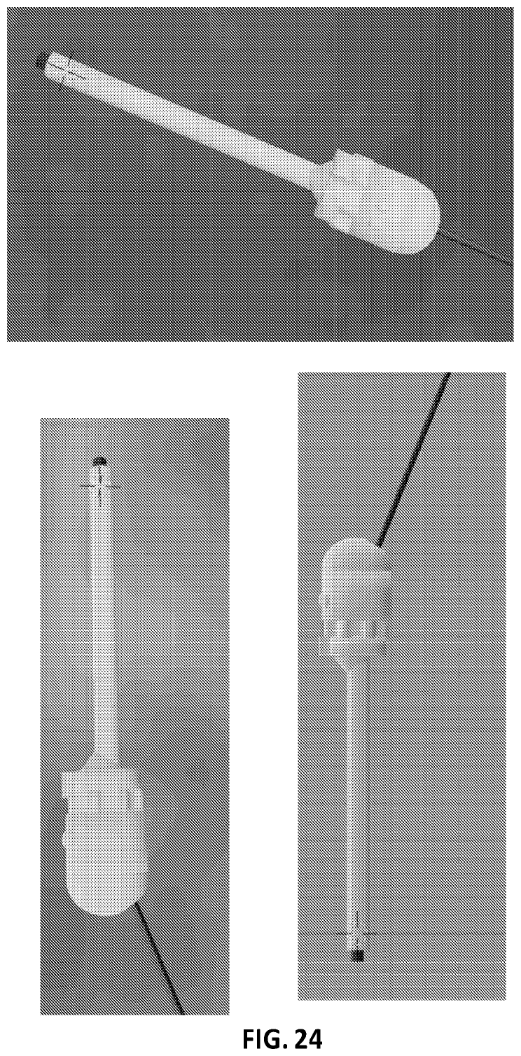

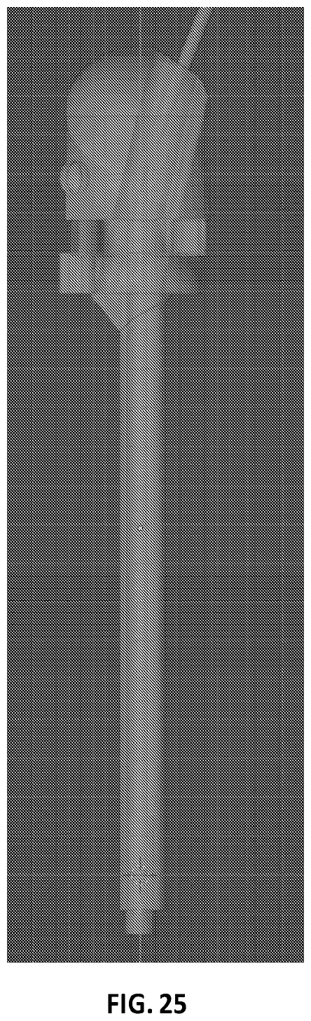

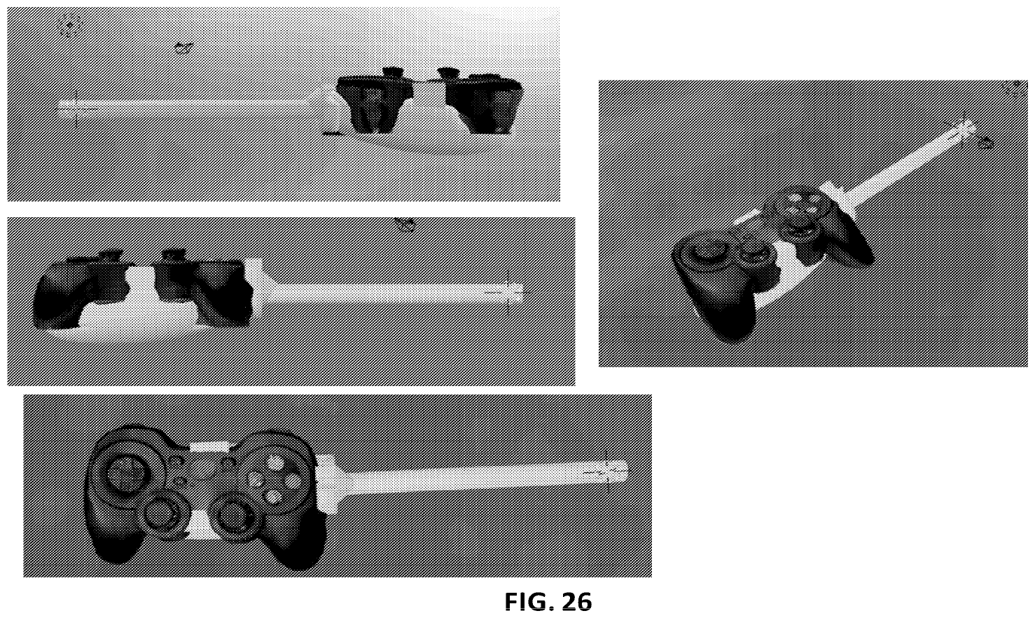

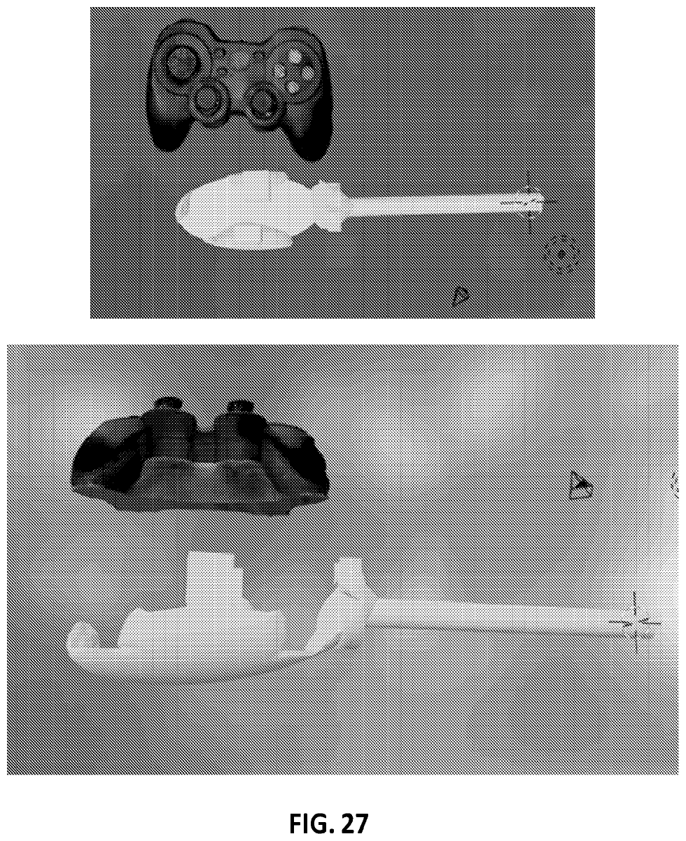

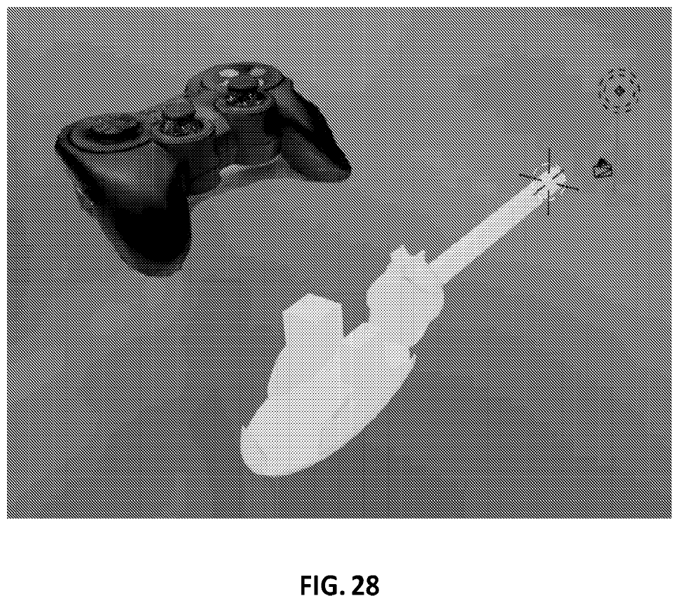

Camera handle with open architecture for placement of camera (FIG. 16).
A synthetic Arthroscopic Camera model that allows a camera to be inserted into a hole in the back and stick out to front to be used as a Arthroscopic camera analog (FIG. 17).

A synthetic Arthroscopic Camera model allows a camera to be inserted into a hole in the back and stick out to front to be used as an Arthroscopic camera analog. This arthroscopic camera may in fact detect markers. However, a fixed camera may be placed on the anatomical structure for viewing internal anatomical elements. A fixed camera may be used together with an arthroscopic camera. Under this embodiment, one camera may detect markers and the other camera is used for tracking, i.e. viewing the environment.

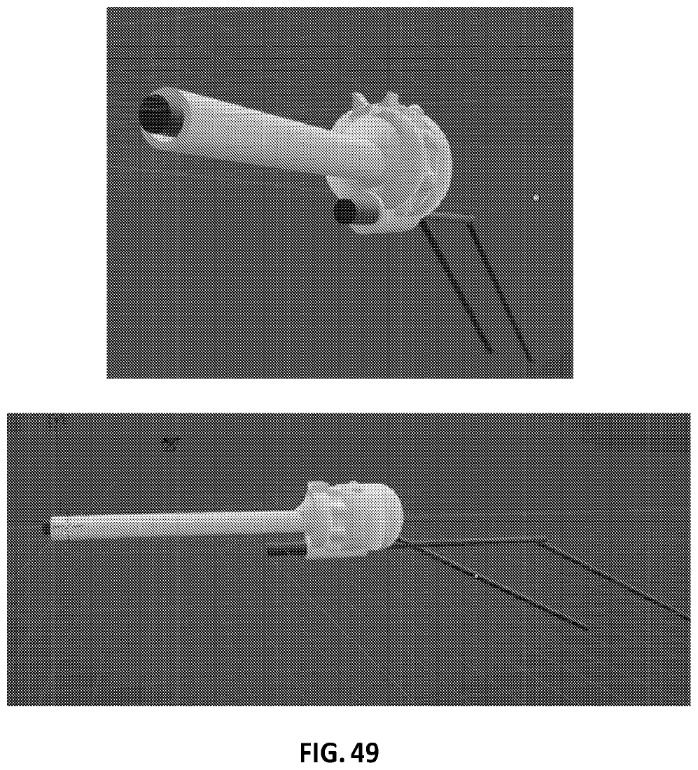

Under on embodiment, an arthroscopic analog may include two cameras as seen in FIG. 49. The first camera at the distal end of the arthroscopic analog views the internal environment of the anatomical structure. The second camera may be used to view an externally placed marker. The second camera detects an externally displayed marker and uses the location of the marker to orient the first and second camera to the space of the rendered structures. The modular anatomical system may then use this information to render a virtual representation of the elements within the anatomical structure and track the position of the arthroscopic analog within that structure. Under this embodiment, the second camera may provide for more precise tracking capabilities. Note however that an arthroscopic camera may not needed for the training of procedures that do not require an arthroscopic view. For example, in the case of spine surgery, you may have a camera to track the relative position of the tools with reference to the anatomy, but you do not perform the surgery through a camera view.

### Game Joystick inserted into Camera Holster

A synthetic Arthroscopic Camera model that allows a camera to be inserted into a hole in the back and stick out to front to be used as an Arthroscopic camera analog. Additionally, the handle has a mold to hold a joystick and/or gamepad which can interface with a computer.

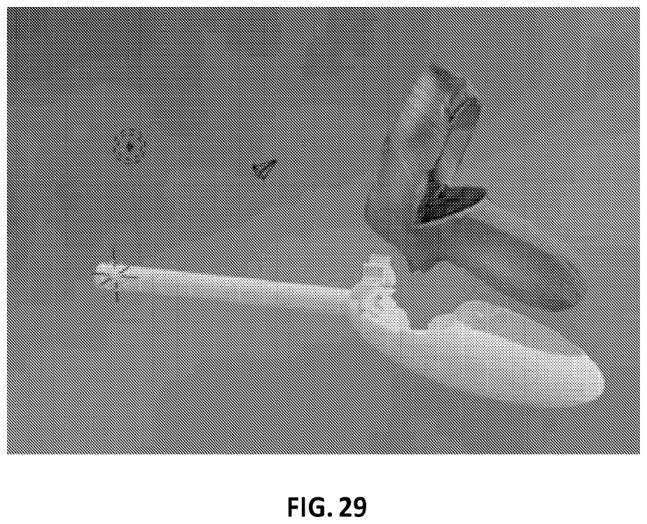

### Virtual Reality Controller (FIG. 29)

A synthetic Arthroscopic Camera model that allows a camera to be inserted into a hole in the back and stick out to front to be used as an Arthroscopic camera analog. Additionally, the handle has a mold to hold an Augmented reality/virtual reality/mixed reality controller with built in tracking software to track camera movements in relation to the Real-world simulation training module.

### Smart Phone

A synthetic Arthroscopic Camera model that allows a camera to be inserted into a hole in the back and stick out to front to be used as an Arthroscopic camera analog. Additionally, the handle has a mold to hold a smart phone or other optical tracking device with built in tracking software to track camera movements in relation to the Real-world simulation training module. The screen can then be facing the user to show a picture of the real-world environment in the arthroscopic training module or a mixed reality perspective.

### Arthroscopic Tool

A synthetic Arthroscopic tool model. The handle has a mold to hold a Augmented reality/virtual reality/mixed reality controller with built in tracking software to track the tool movements in relation to the Real world simulation training module. In the augmented/mixed reality/virtual reality environment the tool can then be visualized as a variety of instruments such as a suture passer, cautery device or shaver.

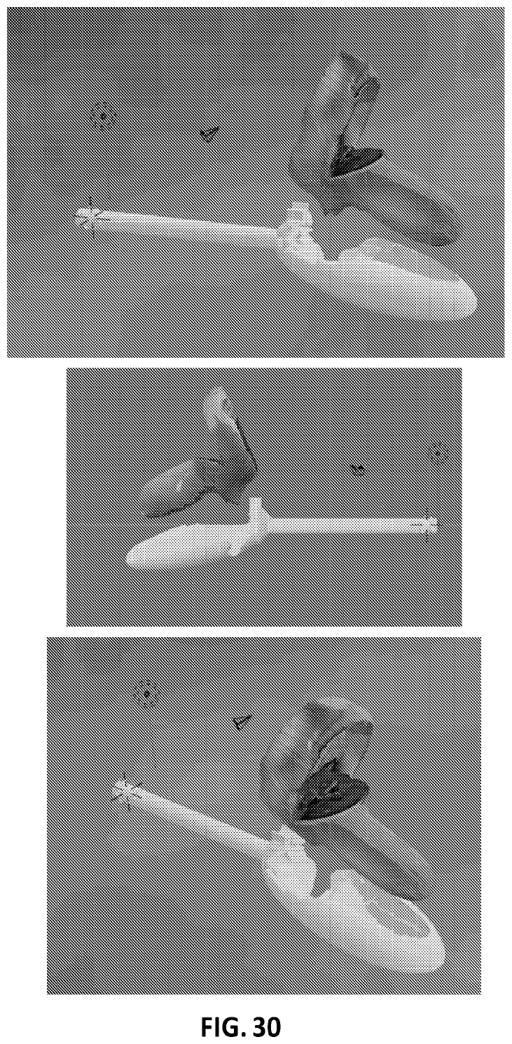

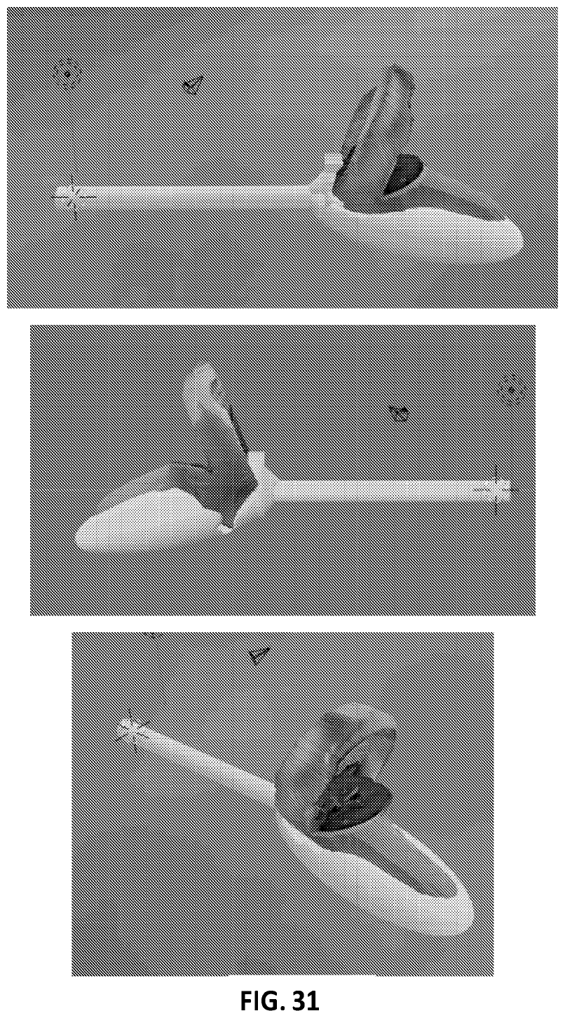

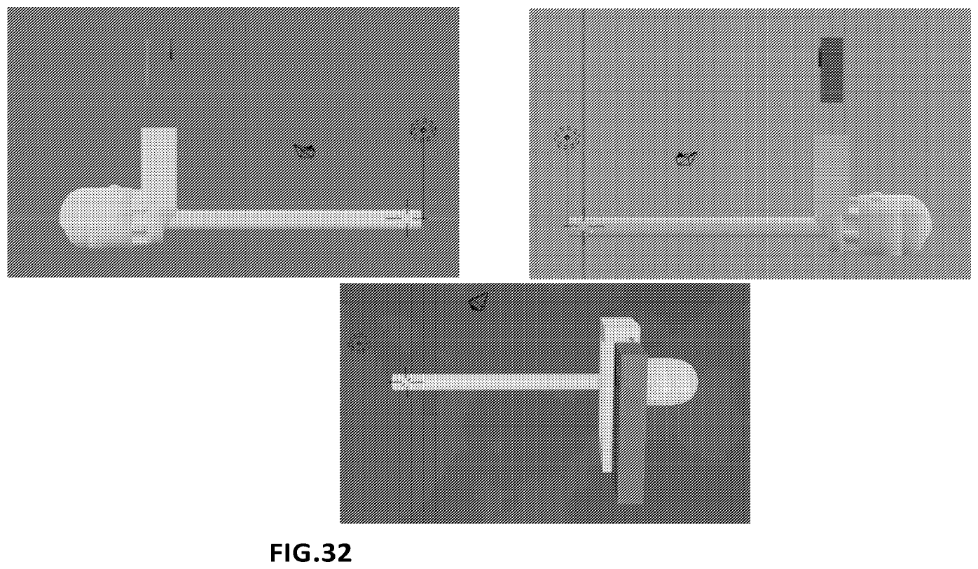

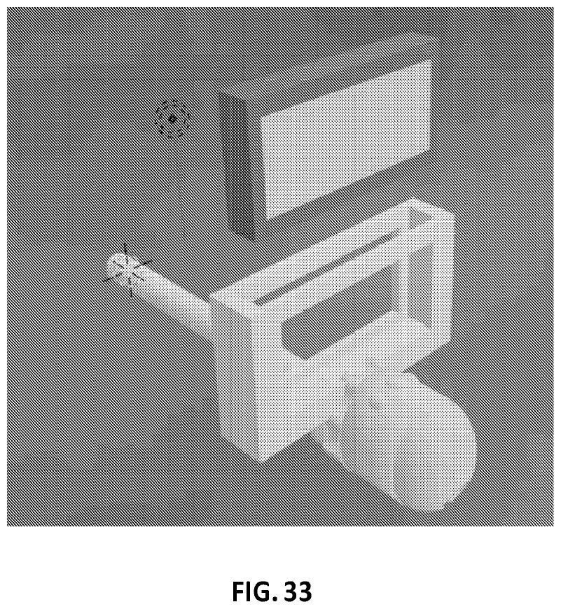

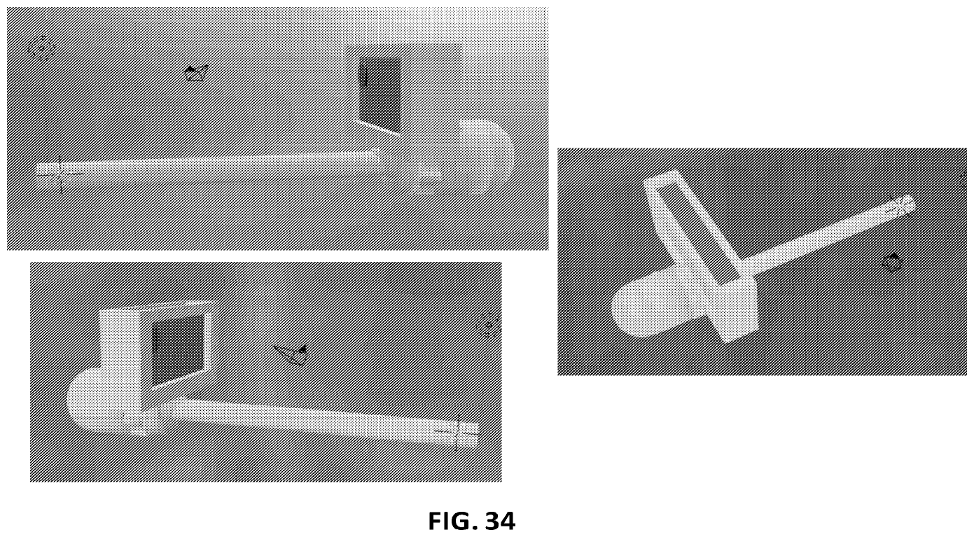

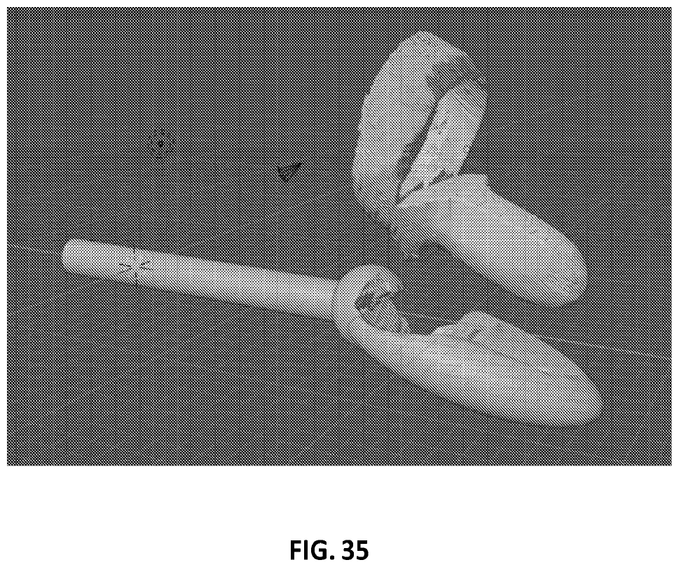

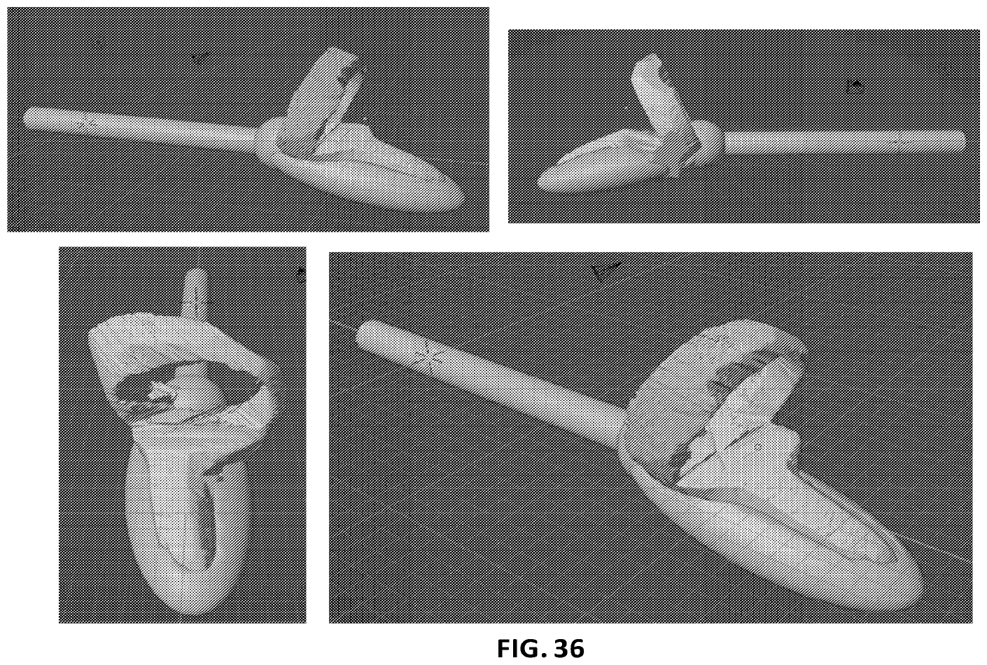

Under an embodiment, the virtual reality/mixed reality/augmented reality controller comprises an Oculus Quest 2 (now Meta) controller that communicates with a headset (see FIGS. 29-31 and FIGS. 35-37). If a VR headset allows you to see the virtual world, controllers allow you to interact with it. Controllers register a user's hand and finger movements in a virtual environment. They turn physical or mechanical mechanic movements of hands (and/or body) into a digital movements inside your chosen virtual world.

Most VR controllers come with a set of buttons, triggers, and typically a thumb stick that allow you to grab, push, throw, and move around virtual objects. For example, using a thumb stick can help you walk in a virtual world. In order to achieve this effect, the virtual reality headset needs to know the position of controller(s) related to its own position. The two most common tracking systems for controllers right now are lighthouse tracking and inside-out tracking.

The Oculus Quest 2 (now called Meta Quest 2) uses an inside-out tracking system. Every controller has a set of infrared LEDs located on the controller's rings. The cameras located on the headset detect said LEDs and continuously take images of them. Based on these images the so-called Constellation tracking system then triangulates the position of controllers in space.

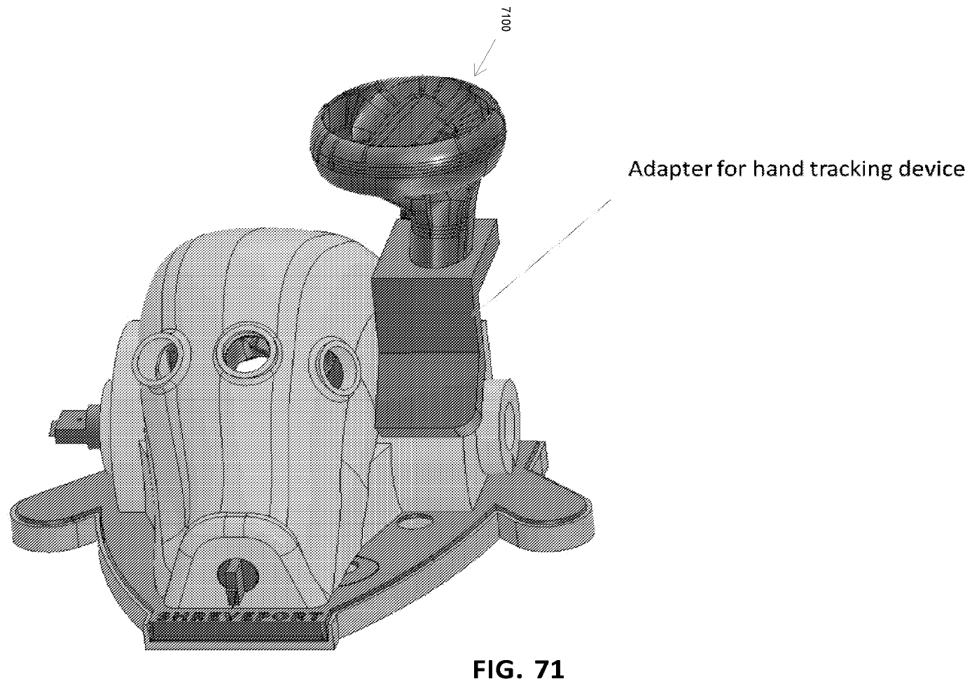

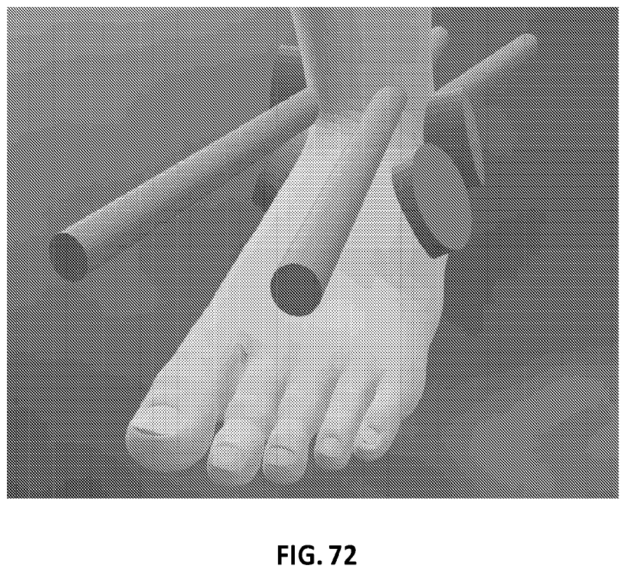

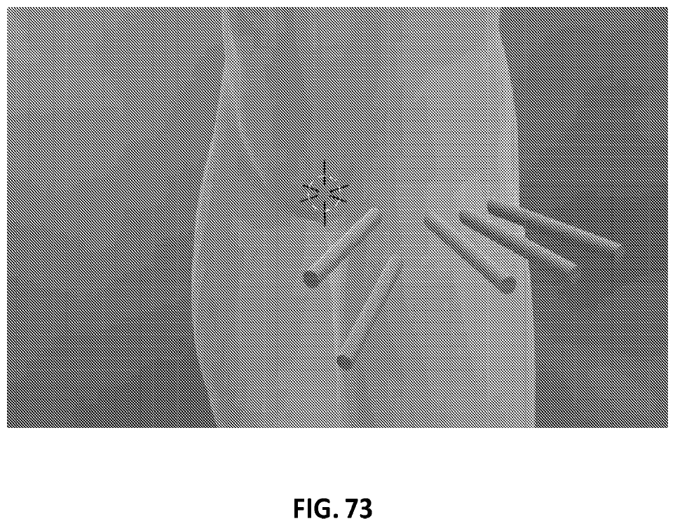

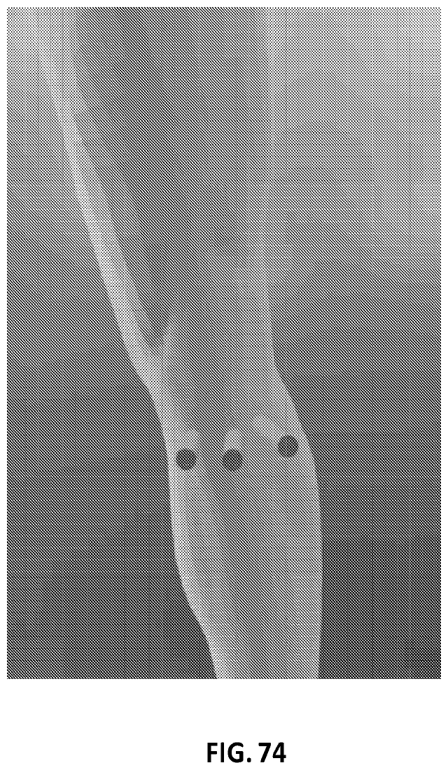

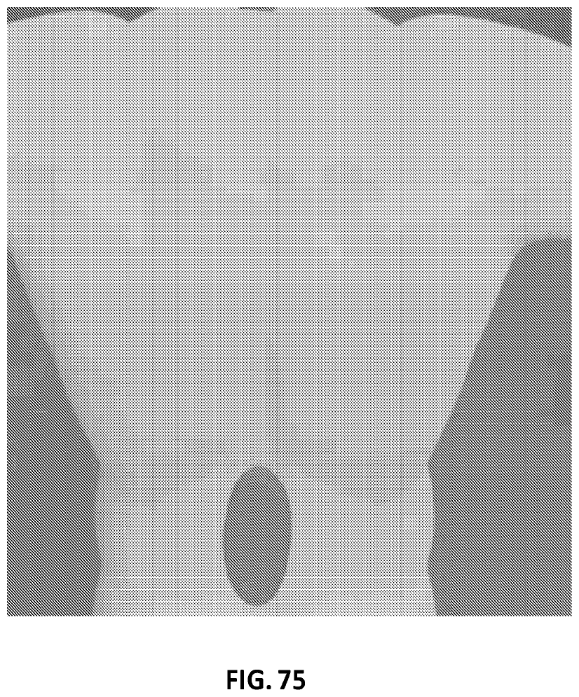

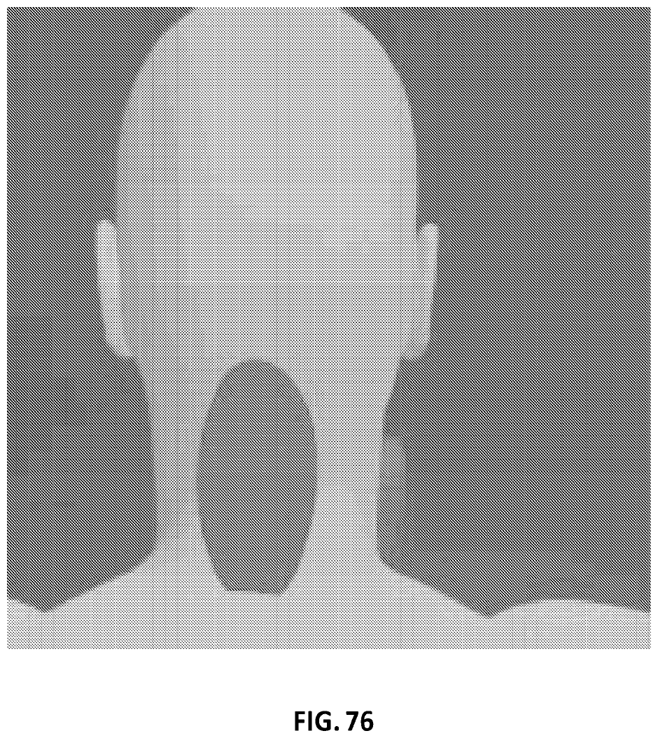

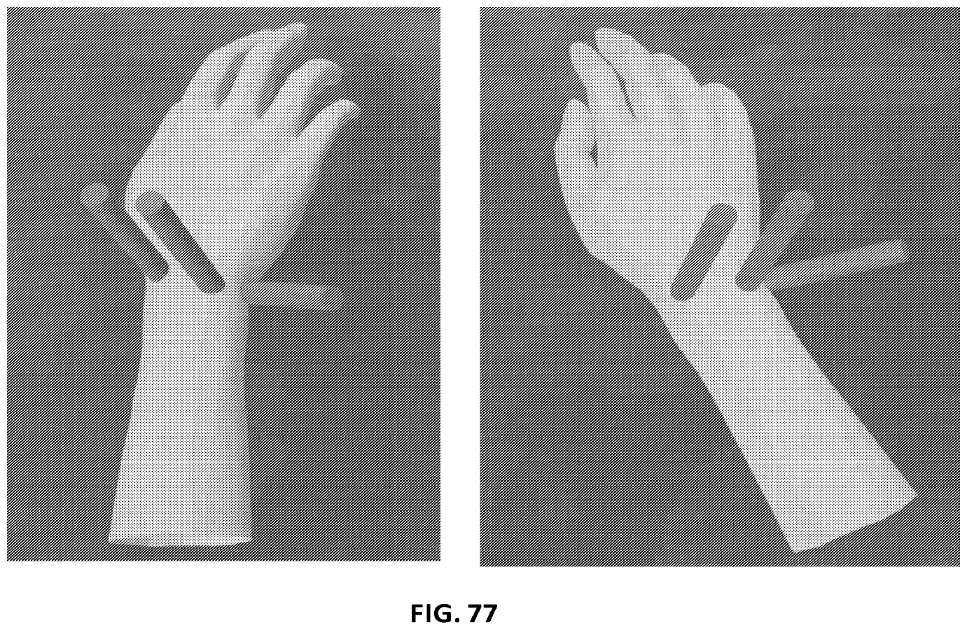

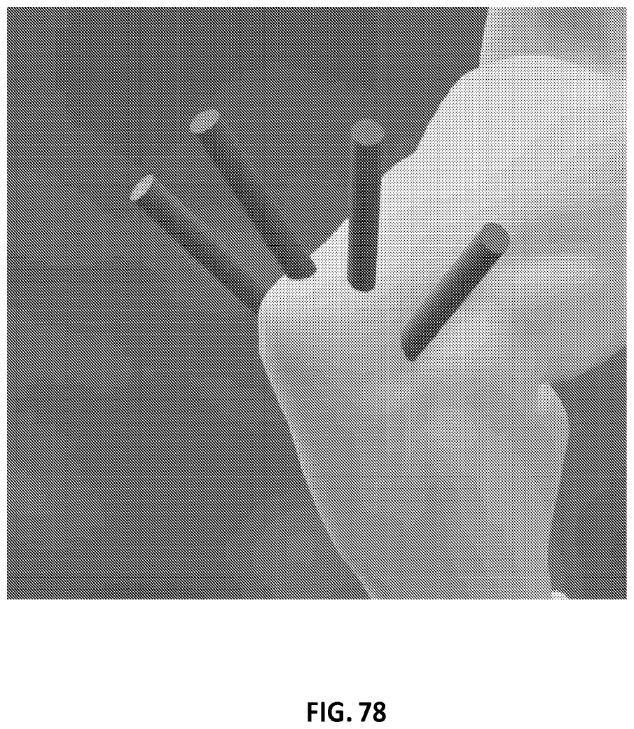

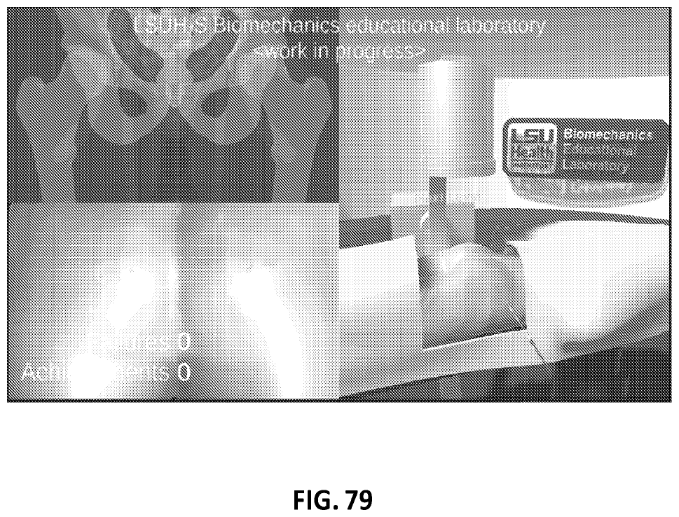

Under the regime of the modular anatomical system described herein, the controller must also be oriented to the space of the anatomical structure. Under an embodiment, the controller is placed in an adapter for the hand tracking controller. As seen in FIG. 71, the controller 7100 is seated in an adapter attached to a rendering of a human knee. The controller and headset then undergo a calibration process. During this process, the controller is oriented to the three-dimensional layout of the anatomical rendering. A three-dimensional model (including three-dimensional coordinate data) of the anatomical rendering is known to the headset. Further, the headset knows the location of the controller which is seated in the adapter during calibration, i.e. seated in a fixed location in space relative to the rendered structure. The headset learns where the controller is in space relative to the anatomical rendering of the knee. In other words, the x-y-z of the controller is mapped onto the x-y-z of the rendered structure.

The controller may then be removed and attached to an arthroscopic analog (as shown in FIGS. 29-31). A user may then insert the arthroscopic analog into the rendered knee and interact with the elements within the structure. The headset knows where the controller is in space relative to the anatomical structure and knows the position of the arthroscopic analog's distal end. Accordingly, the headset may render a virtual image of the arthroscopic device within the knee.

Under an alternative embodiment, a first controller may remain within the adapter. A second controller may then be attached to the arthroscopic analog. A user may then use this second controller as an arthroscopic analog to manipulate elements within the anatomical structure.

Under an embodiment, a VR headset may independently map out an environment. As one example, the Oculus Quest 2 (now Meta Quest 2) may use Simultaneous localization and mapping (SLAM). Under this approach a map of the unknown environment is built simultaneously whilst tracking the camera pose.

In mapping an environment, a headset needs to know where it is at any given point. The position where the headset starts off is the origin of the coordinate frame. Then, the headset moves around and it needs to estimate its trajectory as it is moving. The way it does this is by looking at landmarks in the environment. If the headset is moving around a room in a house, these landmarks could be room features (e.g., corners) or furniture pieces. What SLAM is doing is the headset estimates the positions of the landmarks with respect to itself and then because it knows the landmarks are not moving it is also estimating its own position with respect to the fixed landmarks. When the headset is estimating the position of the landmarks, it is mapping the world. When the headset is estimating its position, it is localizing against the map and the headset is doing both simultaneously. This mapping approach may then identify a marker in the environment. If the orientation of the marker is known relative to the elements withing the anatomical structure, then the headset may track the position of a controller (attached to an arthroscopic handle) relative to such elements.

Although tracking is described above with respect to the Oculus Quest 2 (now Meta), embodiments may employ other VR headsets that detect active or passive light.

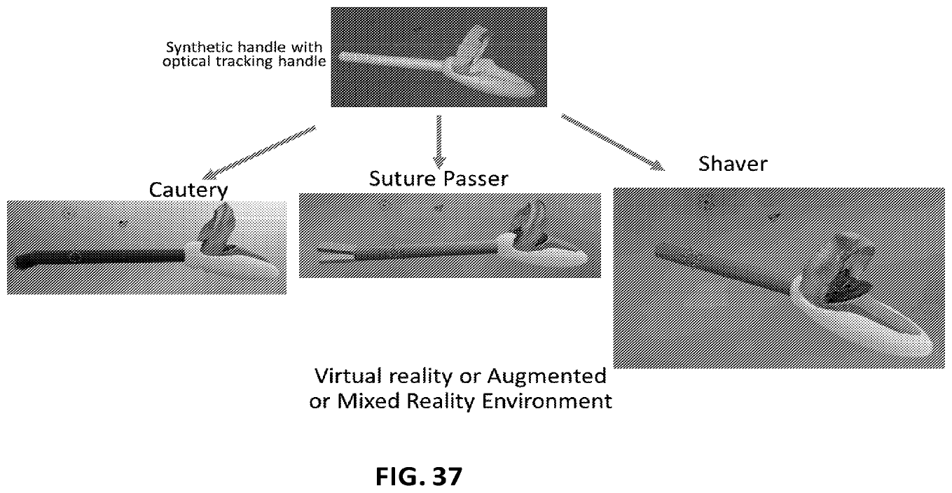

Under an embodiment, the controller may be attached to a general synthetic handle. As seen in FIG. 37, the headset may render the handle as a shaver, suture passer, or cautery. Under an alternative embodiment, the handle may actually comprise a shaver, suture passer, or cautery tool.

### Example 4—Fracture Deformity Simulator

Overview: Fracture Deformity Simulator: A system for simulating fracture deformity forces for bone fractures, dislocations, or separations with Sockets for Blocks to simulate bone for drilling and placement of screws. This simulation system allows the user to practice reducing bones or making them straight with simulated deforming forces resisting the reduction. These forces are created by attaching elastic devices to the simulated bone and attaching the other end to a ring with hooks every 45 degrees.

An anatomic modeled synthetic bone can be created. A transverse or oblique or comminuted simulated fracture can be made in the body. Rectangular sockets can be placed in the bone on one side of the fracture and another set of sockets can be made on the other side of the fracture. Hooks can then be placed on each side of the fracture to attach elastic material (rubber or springs). This can then be attached to the fracture rings to create deforming forces which simulate muscle, tendon or ligaments in the human body.

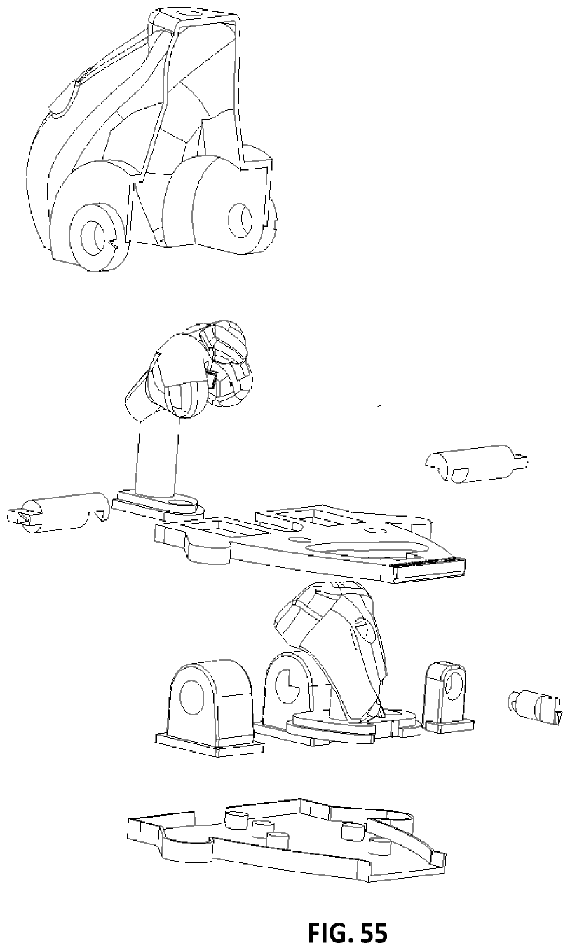

Herein is an example with a subtrochanteric femur fracture simulation (FIG. 55).

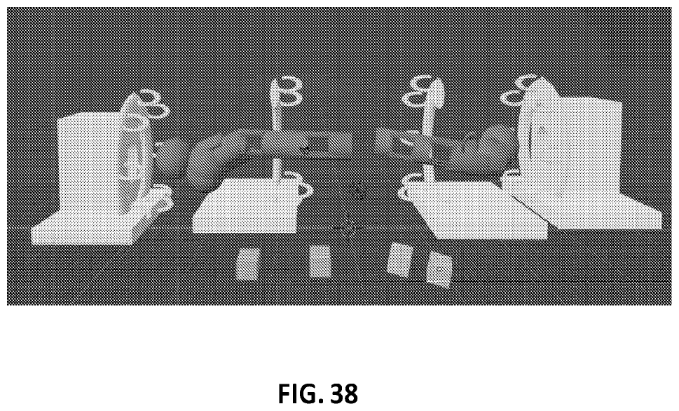

Fracture Deformity Simulator: A system for simulating fracture deformity forces for bone fractures, dislocations, or separations with Sockets for Blocks to simulate bone for drilling and placement of screws (FIG. 38). Simulated Bone in purple, Socket in Blue, Simulated bone block in orange.

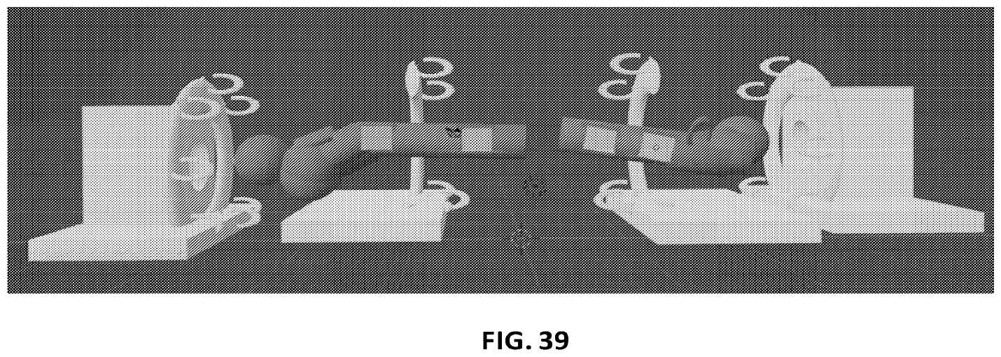

Simulated bone in purple, socket in blue, simulated bone block in orange which have been inserted into the sockets (FIG. 39).

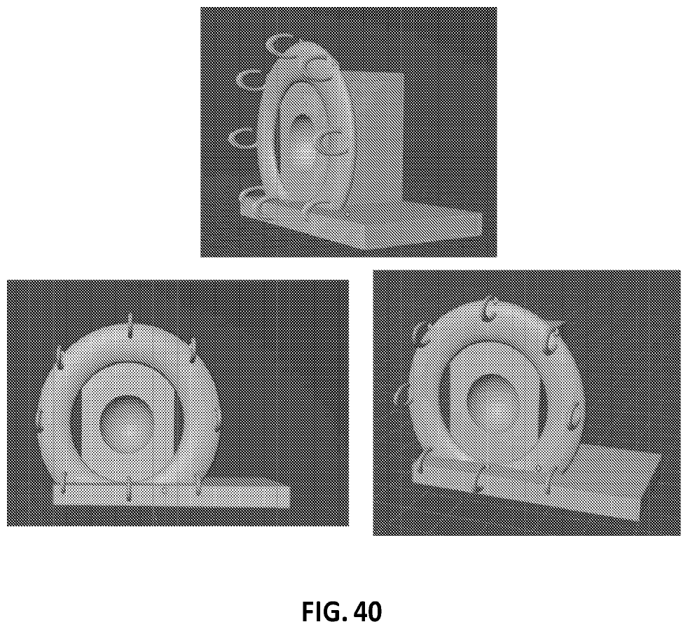

A spherical socket with base for clamping to table-top and 6 hooks around a ring every 45 degrees (FIG. 40).

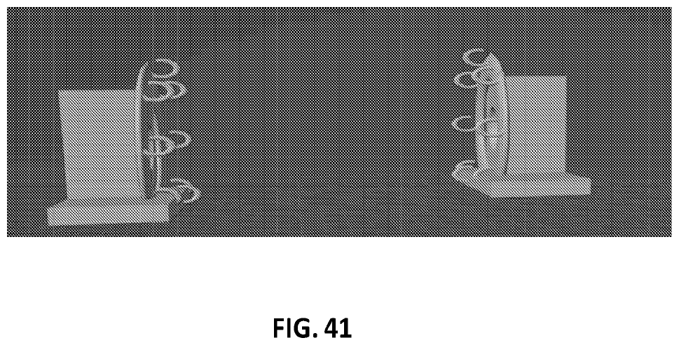

2 Ring top sockets on each end for stabilization of two bone ends (FIG. 41).

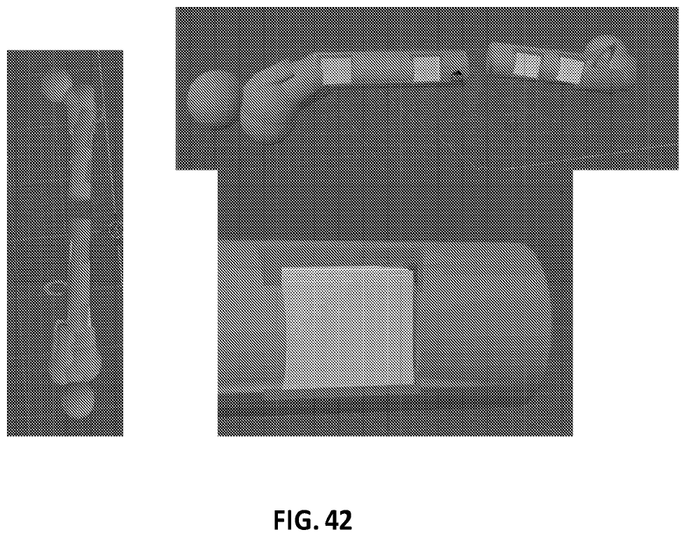

Femur Shaft Fracture model with sphere ends and hooks placed to recreate deforming forces on proximal and distal femur (FIG. 42).

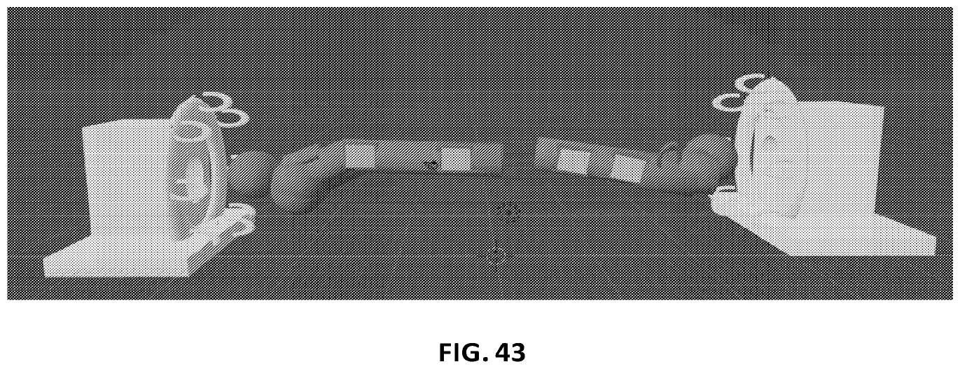

2 Ring top sockets with Femur model (FIG. 43).

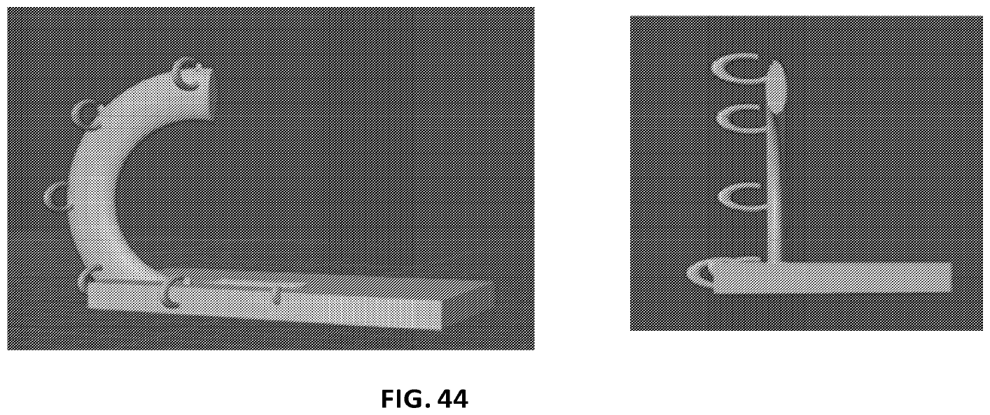

Semi-circular Ring top for clamping to table (FIG. 44).

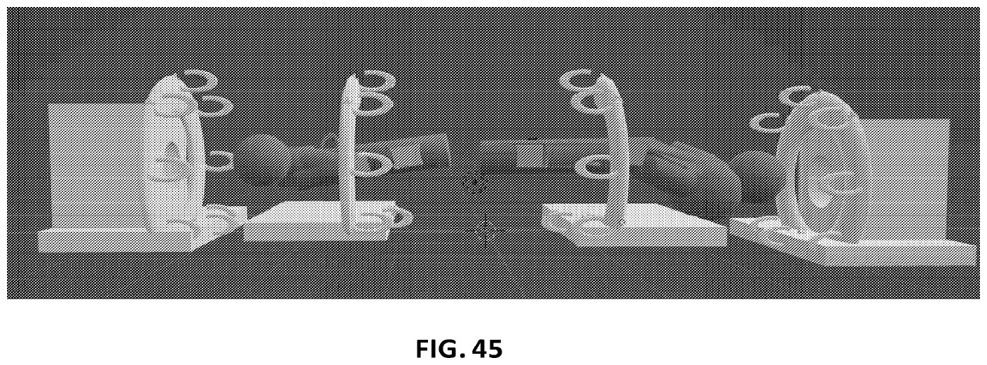

2 ringtop sockets and ringtops with simulated femur fracture with deforming hook attachments (FIG. 45).

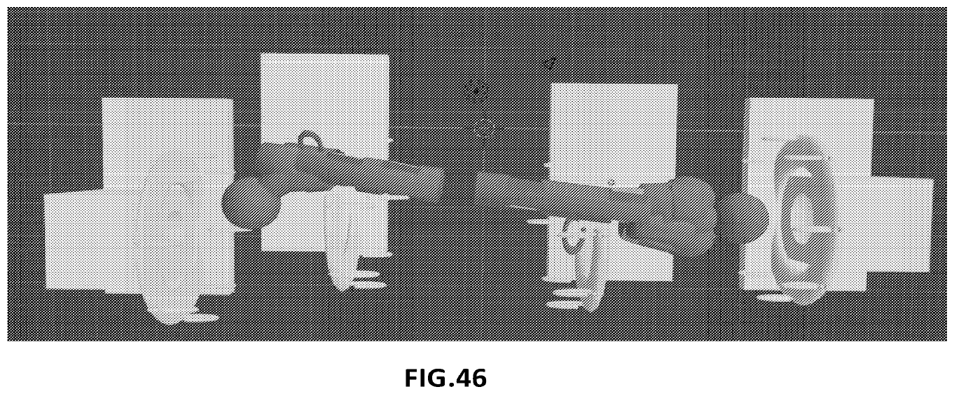

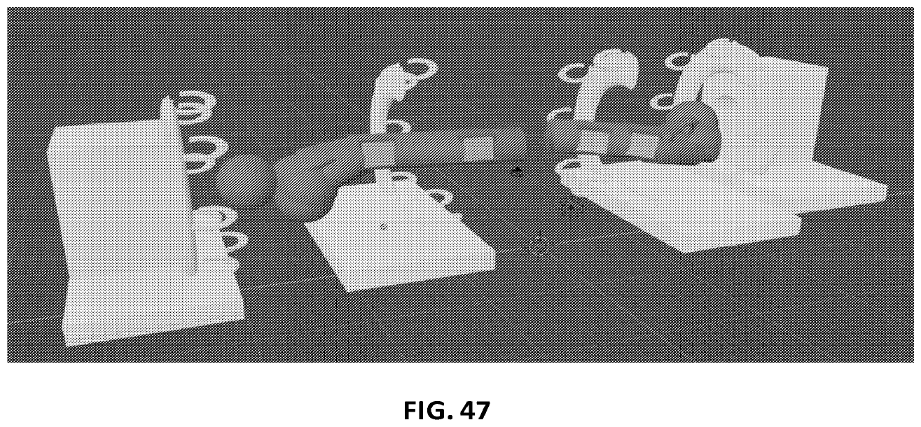

2 ringtop sockets and ringtops with simulated femur fracture with deforming hook attachments (FIG. 46).

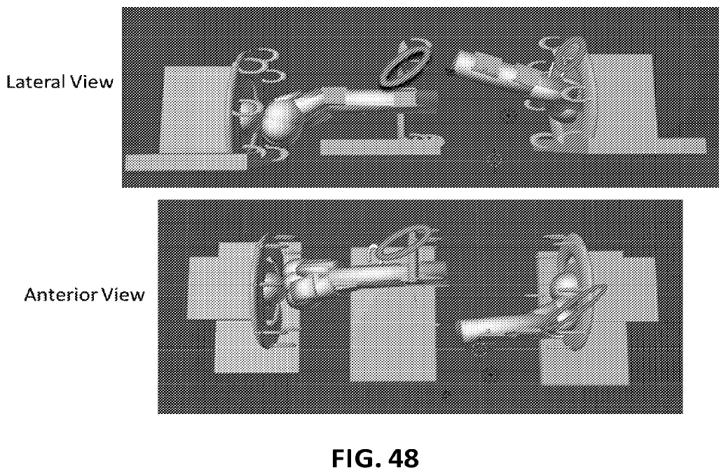

Attached Tension devices to femur bone and rings. Tension ring to distal femur medially to create adduction deforming force (red ring). Tension device anterior and lateral to proximal femur to create flexion and abduction deforming force (blue ring). (FIG. 48)

Preferred Embodiment for Arthroscopic camera simulator with additional camera for external marker tracking.

An arthroscopic camera model with socket for a small camera at the end (primary camera). Additionally, a socket in the handle for an additional camera (secondary camera). This secondary camera can be used to view external markers outside the arthroscopic model to calibrate the position of the simulated camera. This can be used to then create mixed reality in combination with the real video from the primary camera (FIG. 49).

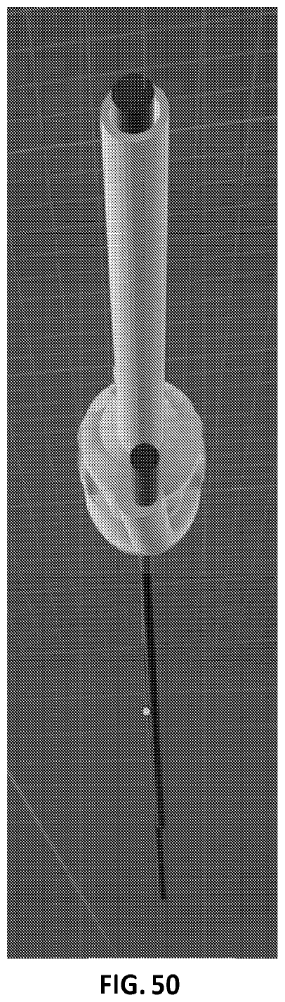

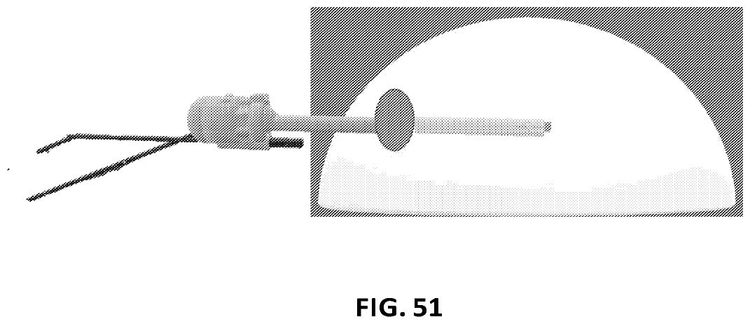

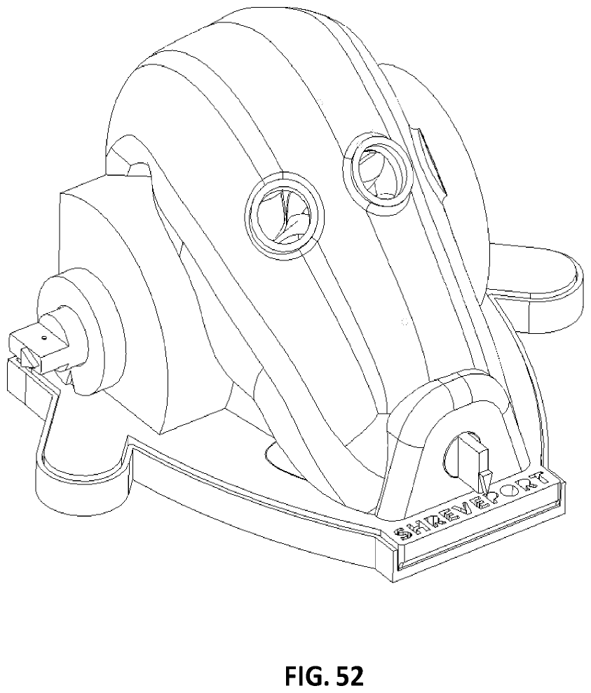

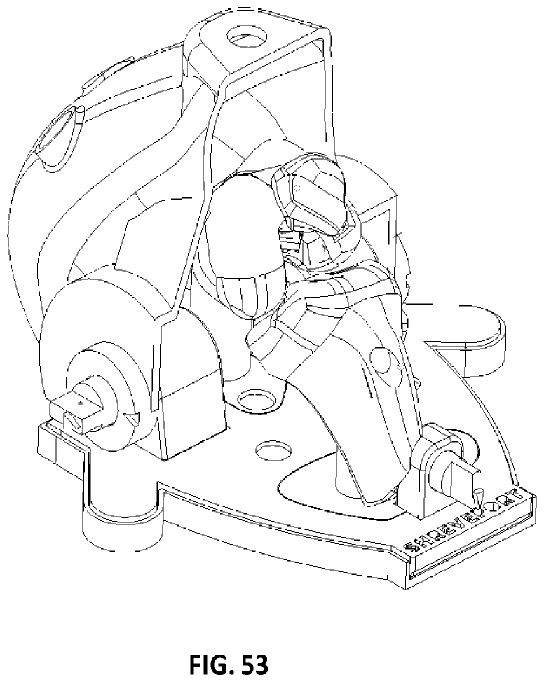

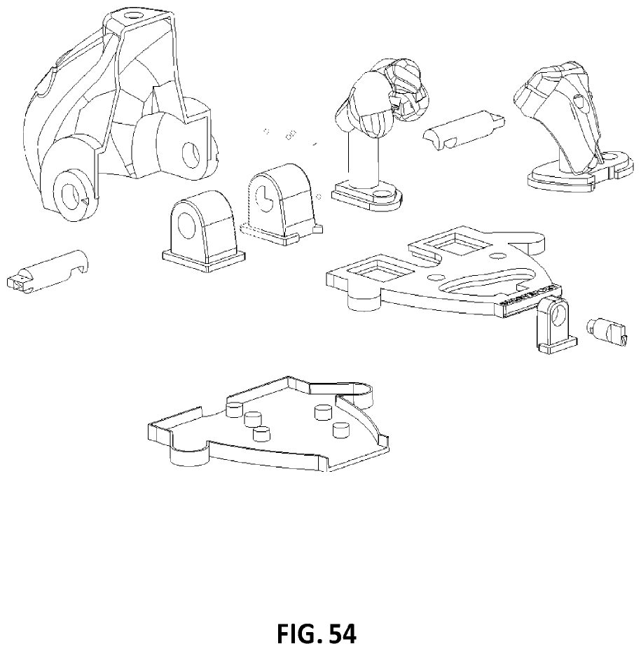

Primary camera on inside of model Secondary camera visualizing target (red) on outside of the arthroscopy model (FIG. 50).

### Example 5—Development of Tools for Surgical Training: The Role of the Haptic Feedback

In surgical training there is a variety of simulators with various levels of complexity but their systematic adoption in training programs is currently limited by the costs of existing solutions and their geographical availability. Simplified low-cost models have been previously proposed but their popularization has been limited by the low fidelity in replicating human anatomy. We have developed virtual reality surgical simulator and 3D printed anatomical models that are low cost and easy to share since they rely on cloud technologies or common Fused Deposition Modeling (FDM) printing technology. We validated the educational validity of a new 3D printed arthroscopic shoulder simulator (PASS) in relation to a widely adopted and commercially available shoulder simulator. The studies performed were prospective randomized control trials in which both Medical Students and Expert Surgeons were recruited. The studies were centered around surgical tasks that included, screw insertions, probing different locations, placing a suture anchor, pulling sutures through portals, and measuring anatomy. The subjects completed anatomy test before and after the given tasks and a questionnaire as well. Educational value was determined by anatomy test scores before and after performing the simulation tasks, user feedback, and construct validity was determined by measuring the time to completion. Tools such as the PASS can create ground for widespread training techniques that can overcome economical and geographical barriers. Improved anatomy knowledge and consistency in duration that is crucial for the adoption of these tools in structured educational programs has been documented.

### Example 6—Validity of a 3D Printed Arthroscopic Shoulder Simulator for Arthroscopic Experience Assessment and Educational Value

Current arthroscopic shoulder simulators can range in price from $1000 to $30,000. We developed a 3D printed shoulder simulator that can be printed with a standard 3D printer for less than $100.00 in supply costs and easily deployed across the entire world to provide education value at a much lower cost. The purpose of this study was to validate the validity of a new 3D printed arthroscopic shoulder simulator and compare it to a commercially available shoulder simulator.

Methods: This study was a prospective randomized control trial approved by the local IRB. Subjects were recruited for 2 groups: Medical Students and Expert Surgeons. Medical students were 3^{rd} or 4^{th} year medical students who had completed surgical rotations. Expert Surgeons were Orthopaedic Surgery Attending surgeons who have completed a sports medicine or shoulder and elbow fellowship or who have completed at least 250 shoulder arthroscopic procedures. Each subject was randomized to perform arthroscopic tasks on a novel 3D printed shoulder simulator or a commercially available shoulder simulator, the Alex 3 (Sawbones, Vashon Island, Washington). Subjects performed 4 arthroscopic tasks including probing different locations, placing a suture anchor, pulling sutures through portals and measuring anatomy. Subjects also completed a shoulder anatomy test before and after the tasks as well as a questionnaire after completion of the tasks.

Construct validity was determined by measuring the differences in time to completion of the tasks between the two groups based on experience. Educational value was determined by anatomy test scores before and after performing the simulation tasks. A Student 2 sample t-test was used to compare numerical data between two groups.

### Results

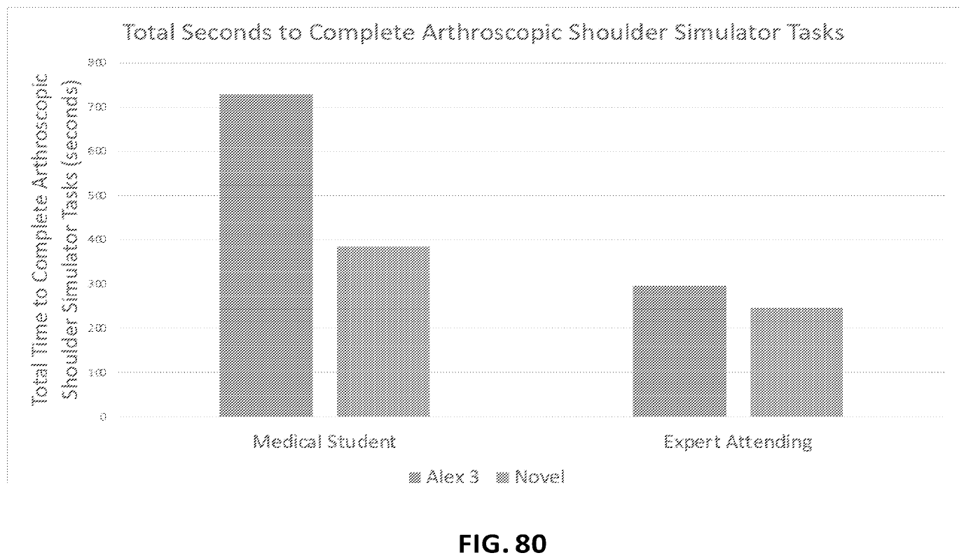

On average, the medical student group took 729 seconds to complete the simulation tasks on the commercial model and 385 seconds on the 3d model (p=0.01, see FIG. 80). The expert surgeon group took 295 seconds vs 248 seconds to complete the arthroscopic tasks on the commercial model vs 3d model respectively (p=0.51). The medical student group had longer time to completion of the arthroscopic tasks than the expert surgeon group on the commercial simulator (p=0.003) and 3D printed simulator (p=0.046).

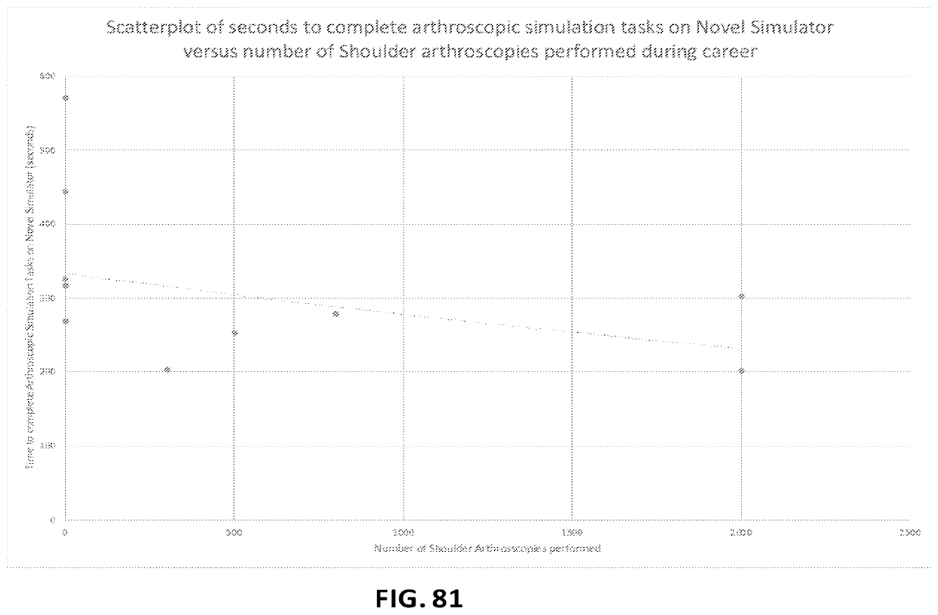

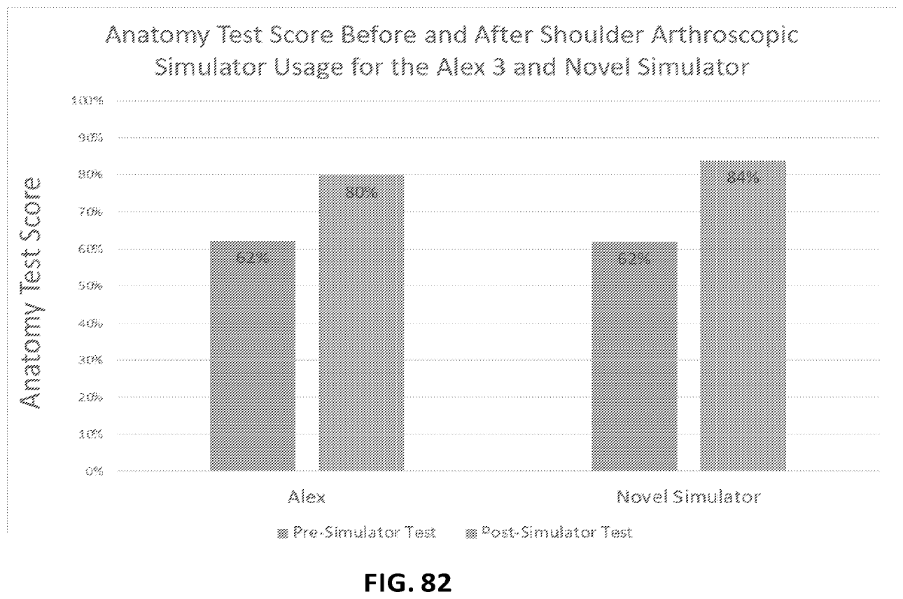

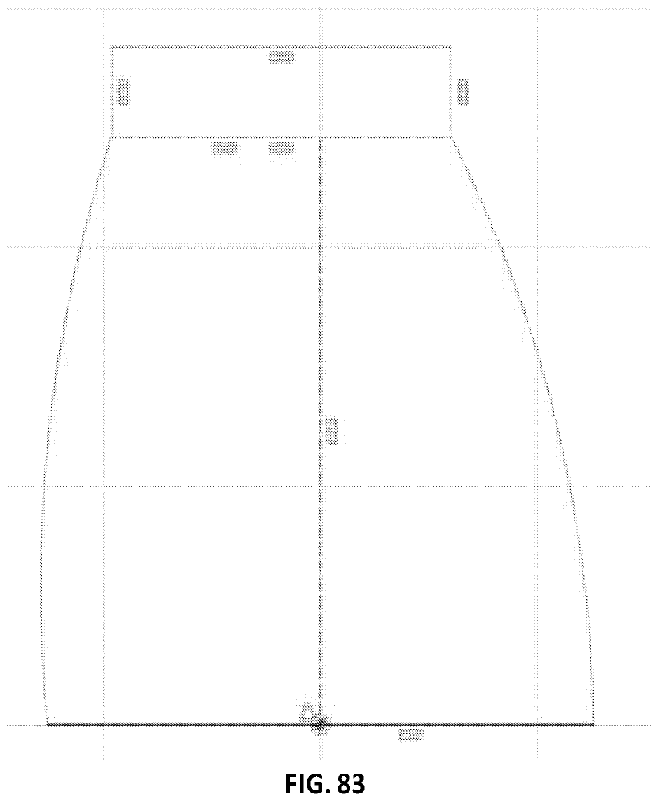

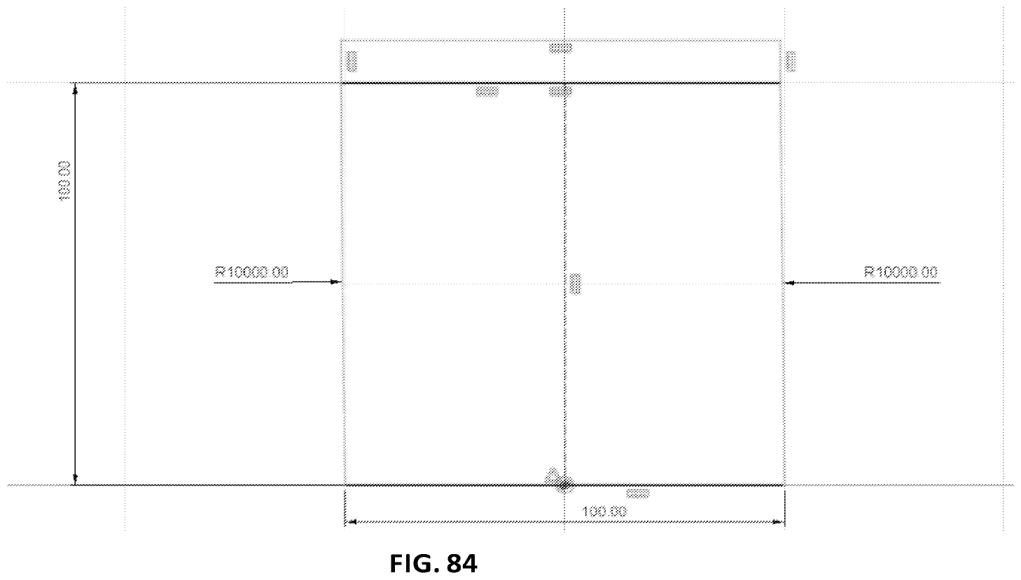

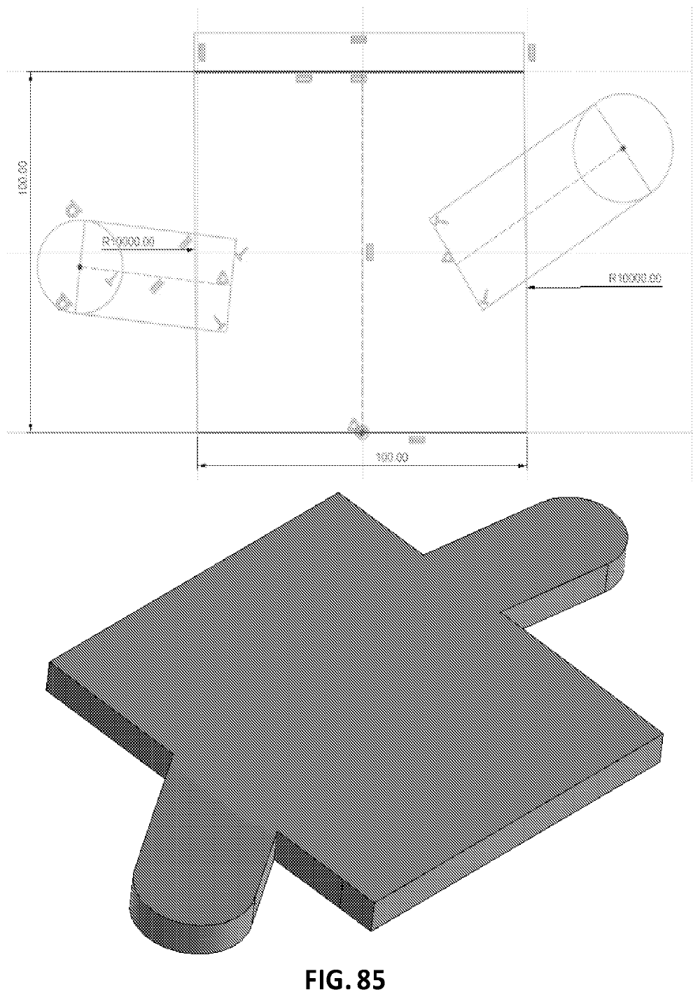

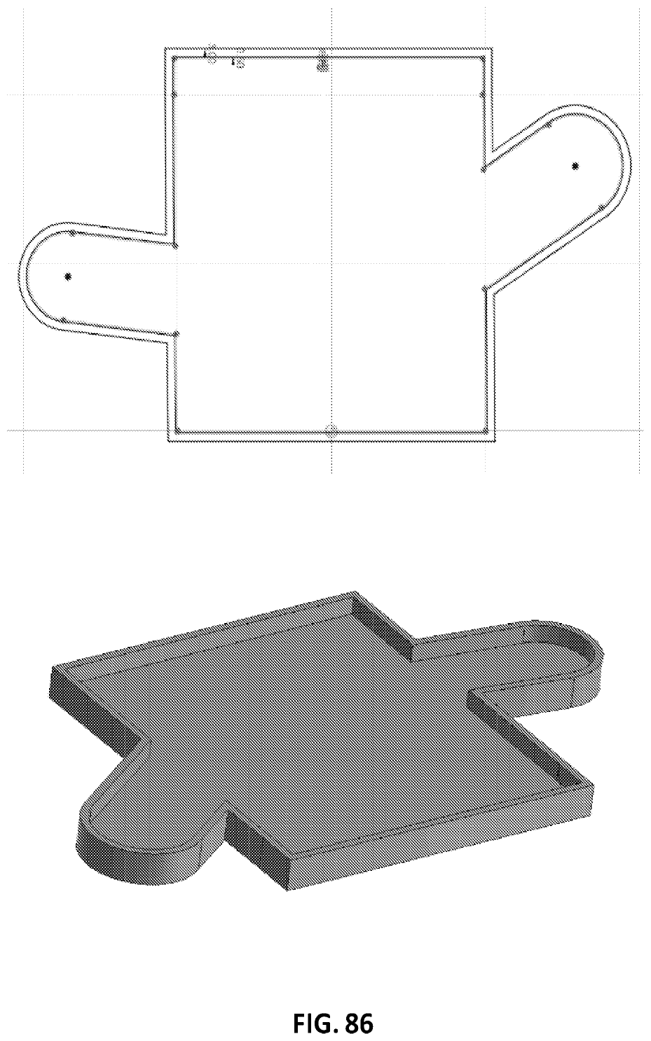

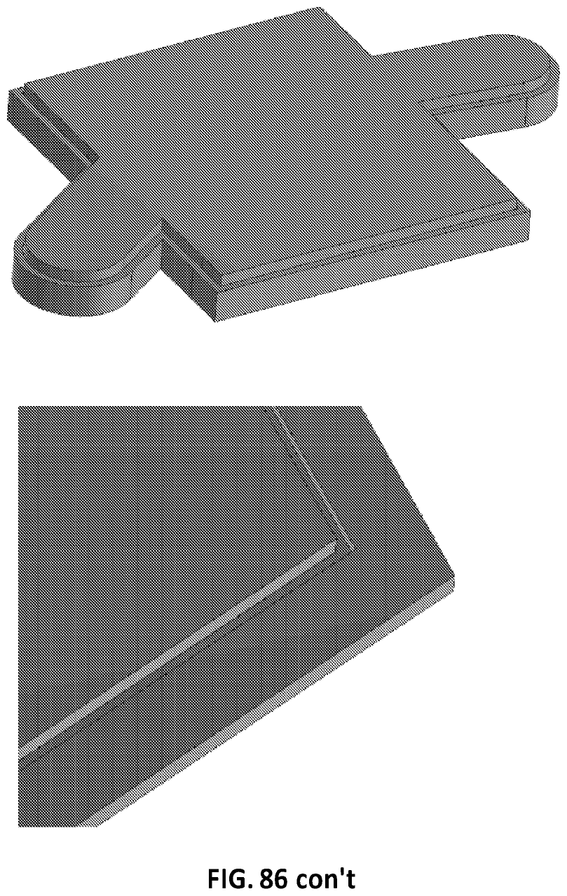

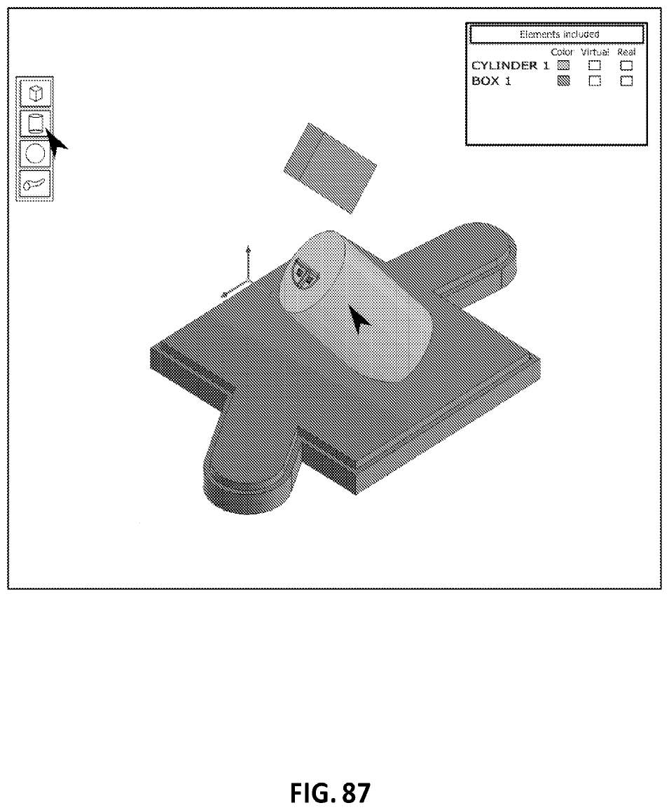

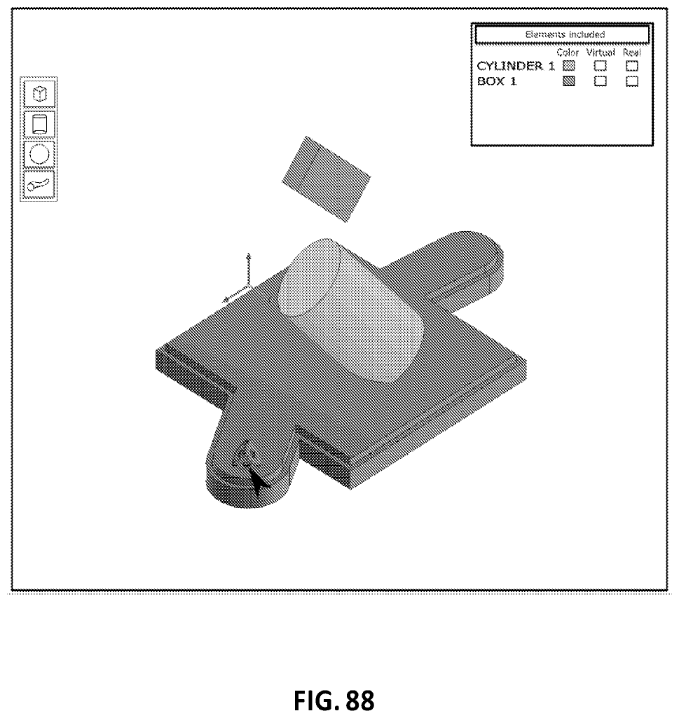

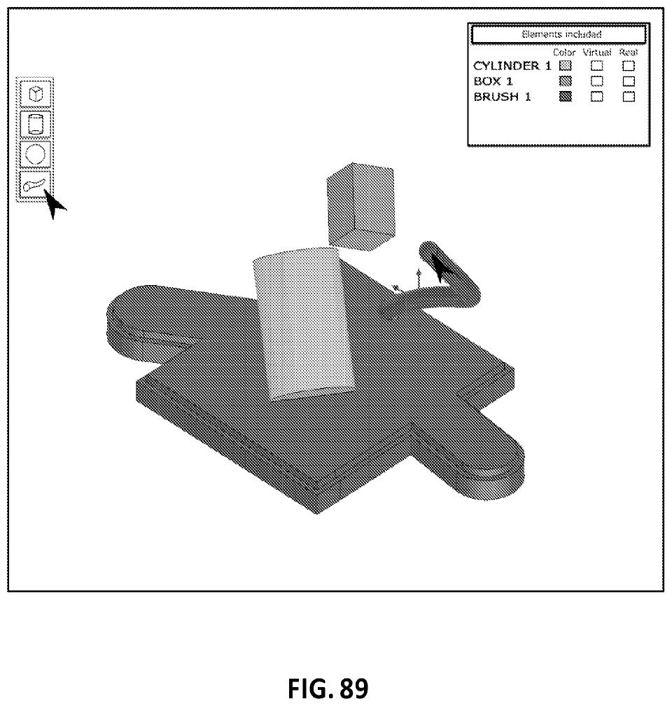

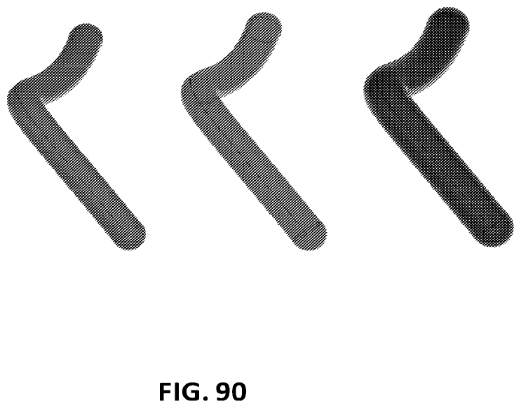

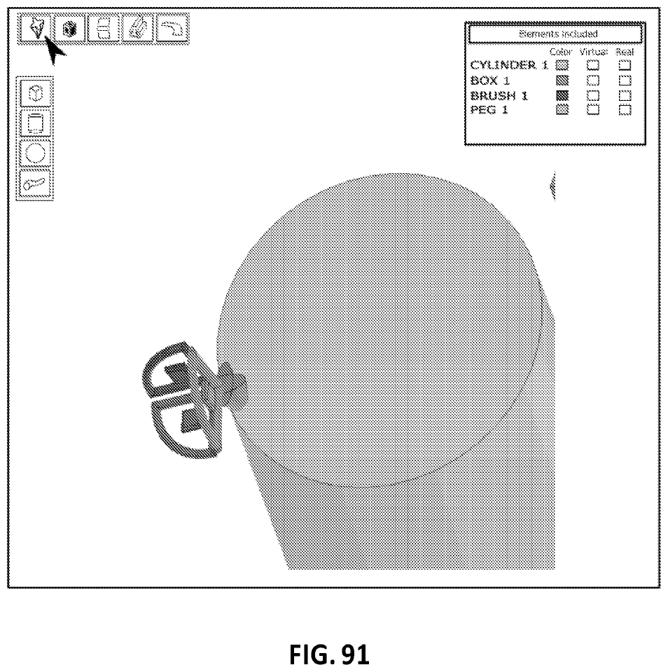

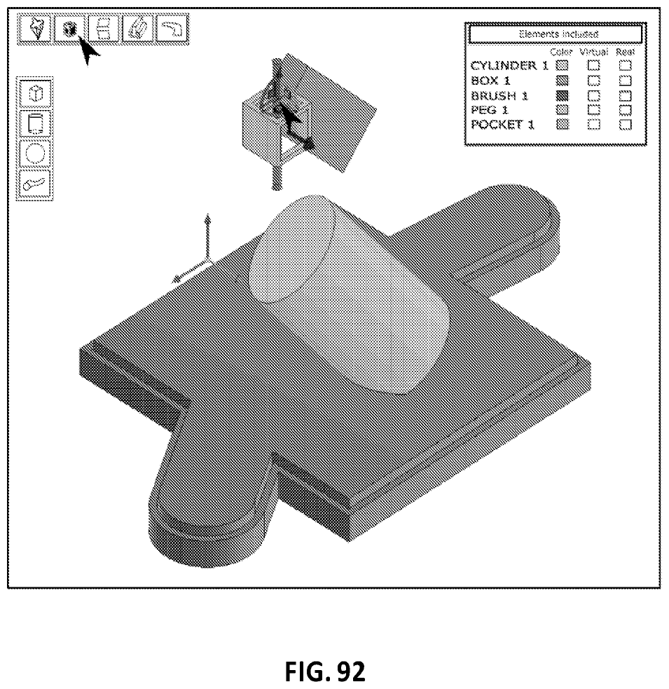

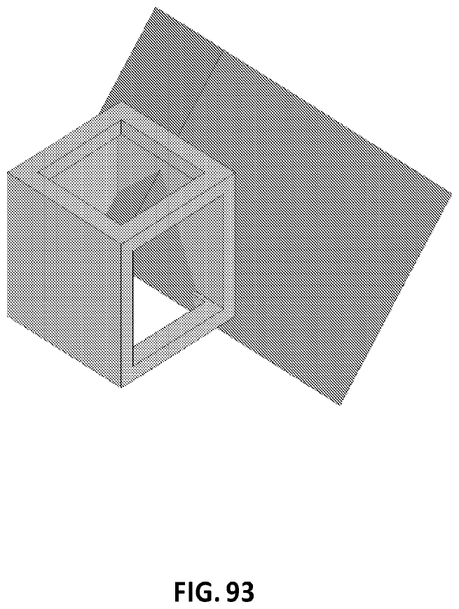

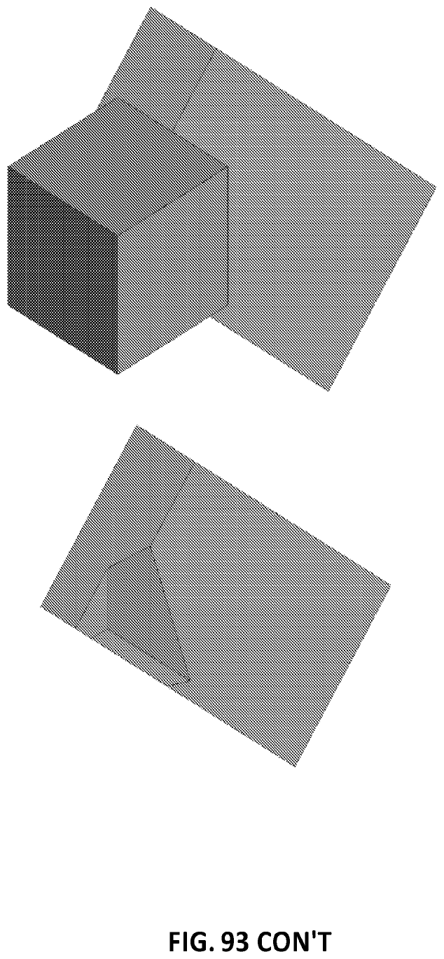

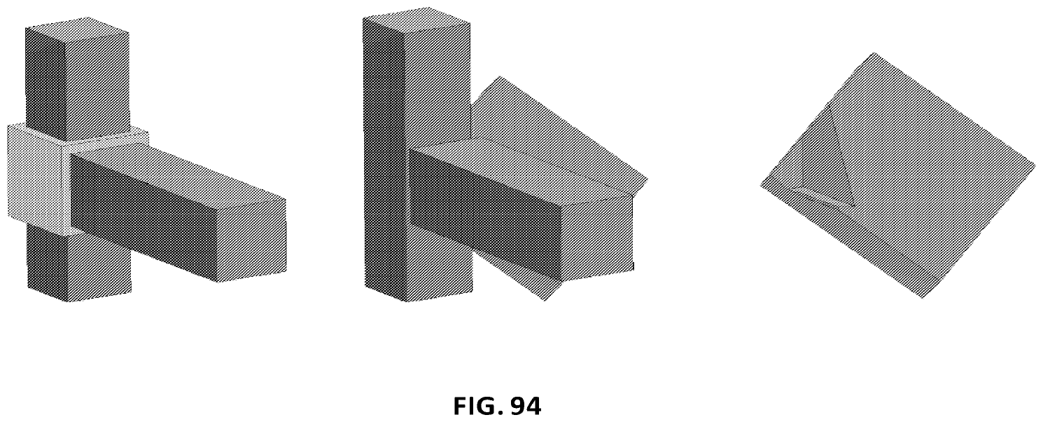

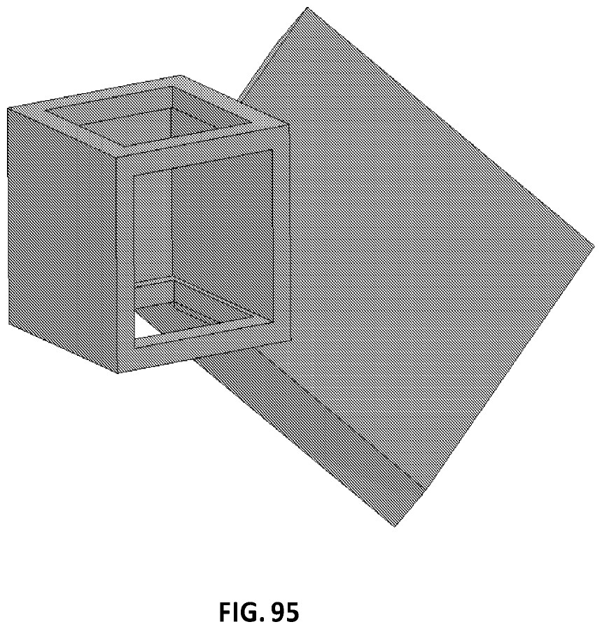

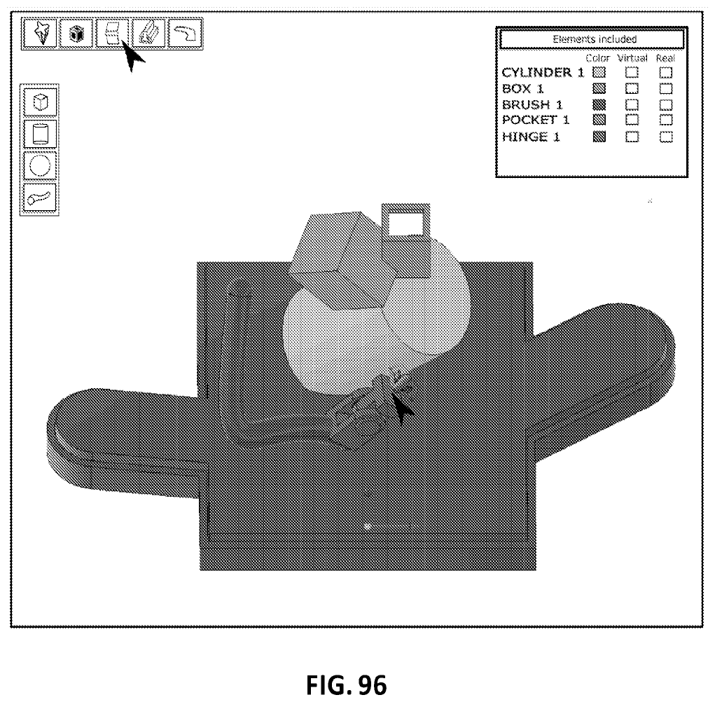

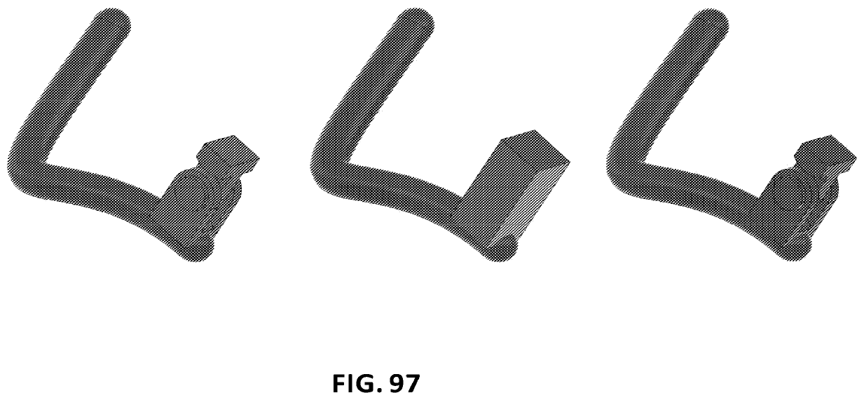

There was a moderate negative correlation between the number of shoulder arthroscopies a user had performed and the amount of time to completion of the simulation tasks on both the commercial simulator (r=−0.60) and 3d printed simulator (r=−0.43). (see FIG. 81). Subjects improved on their anatomy test (see FIG. 82) from a 62% to a 80% (p=0.022) after performing the 4 tasks on the commercial simulator and from 62% to 84% on the 3D printed model (p=0.049).

Additionally, the expert surgeons rated the 3d simulator as more portable, and more likely to improve suture management skills than the commercial simulator. (p=0.004 and p=0.04 respectively).

Conclusion: The 3D printed arthroscopic shoulder simulator demonstrated construct validity and educational value comparable to a commercially available simulator. Additionally, medical students were able to complete arthroscopic tasks faster with the 3D printed shoulder simulator compared to the commercial simulator.

### Example 7

Here are described the steps to create an embodiment of the system for surgical task training and the features of a Computer Aided Design System for this purpose. These steps can be performed through a software environment that provides visualization and editing of tridimensional representation of the anatomy.

In this environment, when the user wants to create a new surgical trainer, it is asked to choose between three scenarios:
Create training platform using Basic Primitives.
Create training platform on custom CT/MRI based tridimensional data.
Create training platform use the standard Anatomical Model

### Create Training Platform Using Basic Primitives

The user is prompted in a 3d environment that shows a platform centered in the world coordinate system. Such platform can be composed by a base, a hosting plate, and extending arms for the clamping of the platform to a workbench. The “base” is created flat and composed by a trapezium enriched by a rectangle to host text. The trapezium has two sides made of two arcs that at the start of the project are characterized by an infinitesimal curvature. In the default configuration, the trapezium is dimensioned to resemble a square with side dimension of 100 mm.

The topology of the base rectangle is enriched by extending arms made of a circle connected to the trapezium through a rectangle that in the default configuration is orthogonal to the vertical axis of the trapezium. The base plate is then automatically built for extrusion of this profile in direction of the vertical axis.

### Illustration of How the Base is Geometrically Composed

The external profile of the hosting plate is then generated through the extrusions of the offset profiles performed on the external edges of the base plate. The offset of the base profile is performed at a first distance that could be of 0.4 mm for FDM printing technology while the second offset that creates the external wall of the hosting plate can be of various dimensions with 4 mm being the dimension already implemented in the existing prototypes.

### Illustration on How the Holding Plate is Automatically Generated

The user can add primitives in correspondence of the base trough a selection menu available in the user interface (UI). The primitives are placed in the 3D environment (3DE) trough drag and drop. Random unique colors are assigned to each element by the system as soon as it is inserted into the 3DE. Each element becomes also listed in a dedicated sidebar window in which the user can select single or group of elements, delete them or indicate if the element in the training system is going to be virtual, real or both. For the geometries that have edges below the plane of the base, a cut is performed using this plane. Further manipulation of the geometries following the drop are performed trough a “Gizmo” tool that allows operations such as positioning, scaling, and stretching. The Gizmo appears on the entity as soon as it is selected by the user.

Same tool is also used to move in the plane the lateral arms for the clamping and appears when the user pointer is positioned in correspondence of the arm center.

A “Drawing tool” is also included for which the system creates a sweep of a circular section along a path decided by the user through the locations of the pointer. For the latter, the curve is determined from the path ideally with a single NURBS curve created for each continuous input received by the user (examples: left mouse button pressed for computer-based modeling while index-thumb tip-pinch or handheld controller button pressed for VR-AR based systems.

In this system, the elements indicated as real will be indicated with solid colors while virtual elements will be displayed in transparency and elements that are indicated as both will be solid and surrounded by a transparent surface created offsetting the element surface by a preset distance.

In addition to the insertion and editing of entities, a menu of features is also available for the user to add elements such as: pegs for anchoring soft tissues surrogates, pockets to host bone surrogates, joints such as sliders and hinges, and hooks to anchor springs or rubber bands.

These elements, differently from the geometries when positioned in place following a confirmation from the user are merged to the interfering geometry trough a Boolean operation. The pegs when moved in correspondence of the geometric element are by default disposed so their main axis is perpendicular to the surface of the geometric element at the point of intersection between the main axis and the surface.

The pockets for bone surrogates when dragged in the 3DE are displayed to the user with an arrow indicating the direction of extraction of the bone surrogate and the axis along which the user can interact in performing the training.

The merging of the pocket to the geometric elements is performed in the following automated steps:
The box delimiting the pocket is subtracted from the geometrical entity.
Two additional Boolean subtractions are internally performed with the parallelepipeds created at the windows of the pockets two ensure access of the bone surrogates for use and extraction.
The final configuration is obtained merging the pocket with the geometrical entity

For the pocket feature tool, the gizmo allows Euclidean transformations with difference in behavior for the scaling given the standardized sizes of the bone surrogates, in performing the scaling a snapping is performed on the dimensional values for which the bone surrogates will be released to the public. In embodiments, dimensions can be: 20×20×20 mm, 30×30×30 mm, 20×20×3 mm, 30×30×3 mm, 20×20×3 mm, 30×30×3 mm, 20×20×40 mm, 20×20×60 mm, 30×30×60 mm.

Hinges, Sliders, and Hooks are similarly introduced in the 3DE.

These features are also manipulated with the gizmo and snapping of their functional axis is performed to existing elements in the 3DE such as the orthogonal axes. Functional axes can be the axis of rotation for the hinge or the direction of sliding for the slider When placed in interference with a geometric element, internal Boolean operations are performed to merge these features. Their bounding box is subtracted from the geometric entity. An error message is displayed to the user if both of the two portions belonging to hinge or slider are in contact with the same geometrical element, so the user can reposition the hinge to allow functionality of the mechanism.

Following the positioning of the elements in the 3DE, the user can choose to verify the status of the entities in relation to their merging to the base.

The merged elements are then included in this list as individual items and indicated with an alphanumeric symbol (*).

In this process, in the object view, each isolated element has a Real green box if connected to the base while the elements not in contact with the base have a virtual green box. This is a default configuration for which the elements marked as real will be physically realized (3d printed) while the elements marked as virtual will be saved as 3d models and associated to augmented reality markers.

The user at this point could accept this realization of the trainer or select the Real box for the elements that they want to be physically realized.

### Example 8—Construct Validity of a 3D Shoulder Simulator: A Comparison of Medical Students, Novice Surgeons, and Expert Surgeons

Purpose: To validate the construct validity and educational value of an embodiment of the 3D printed arthroscopic shoulder simulator (3D-PASS) as compared to a widely adopted and commercially available shoulder simulator (CASS).

Methods: This study was a prospective randomized control trial approved by the local Institutional Review Board (IRB). Twenty-four subjects were recruited for 3 groups: 8 Medical Students, 8 novice arthroscopy orthopaedic surgeons and 8 Expert arthroscopy orthopaedic Surgeons. Each subject was equally randomized to perform arthroscopic tasks on the 3D-PASS or on the CASS. All subjects completed a timed assessment of 4 arthroscopic tasks. All of the subjects completed a shoulder anatomy test before and after the given tasks to assess educational value. Construct validity was determined by time to completion of tasks. An ANOVA with post-hoc testing done to compare data.

### Results

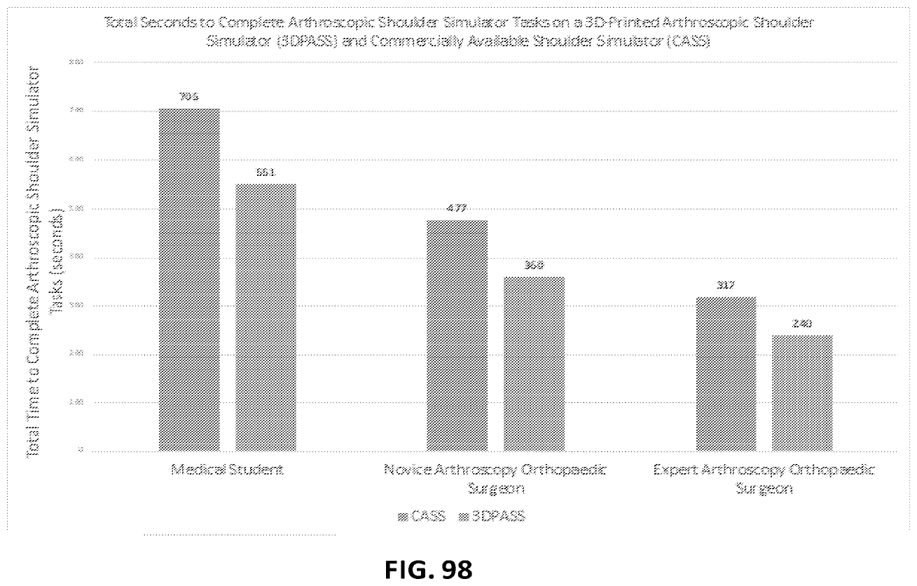

As shown in FIG. 98, there was a difference in the time to completion of the simulation tasks among the three levels of training for the CASS and 3D-PASS (p=0.002 and p=0.014 respectively). On the 3D-PASS, expert surgeons and novice surgeons performed faster than medical students (p=0.004 and p=0.046 respectively). On the CASS, expert surgeons and novice surgeons performed faster than medical students (p=0.001 and 0.013 respectively).

There was a moderate negative correlation between the number of shoulder arthroscopies previously performed and the time to task completion on both the CASS (r=−0.46) and 3D-PASS (r=−0.46). Among all participants, subjects improved on their anatomy test from a 55% to a 72% (p=0.005) after performing the 4 tasks on the CASS and from 48% to 73% on the 3D-PASS (p=0.01).

Conclusion: The 3D printed arthroscopic shoulder simulator demonstrated construct validity with more experienced arthroscopy surgeons performing tasks faster and educational value comparable to a commercially available shoulder simulator.

### Example 9—Validity Assessment of a 3D Printed Arthroscopic Shoulder Simulator: An Experimental Evaluation of Construct Validity and Educational Value

Introduction: Adoption of arthroscopic shoulder simulator in training programs is currently limited by the costs of existing solutions ($1000 to $30,000) and their geographical availability. We have developed a 3D printed anatomic shoulder simulator that is low cost and deployable worldwide since it relies on common Fused Deposition Modeling (FDM) printing technology. The purpose of this study was to validate the educational validity of embodiments of the 3D printed arthroscopic shoulder simulator (3D-PASS) and compare it to a commercially available shoulder simulator (CASS).

Methods: This study was a prospective randomized control trial approved by the local Institutional Review Board (IRB). Twenty Subjects were recruited for 2 groups: 10 Medical Students and 10 Expert Surgeons. Medical students were 3rd or 4th year medical students who had completed surgical rotations. Expert Surgeons were Orthopaedic Surgery Attendings who have completed a sports medicine or shoulder and elbow fellowship or who have completed at least 250 shoulder arthroscopic procedures. Each subject was randomized to perform arthroscopic tasks on the 3D-PASS or on the CASS. After randomization there were 5 medical students for the 3D-PASS and 5 medical students for the CASS groups and 5 expert surgeons for the 3D-PASS and 5 expert surgeons in the CASS group. All subjects completed a timed assessment of arthroscopic tasks on their designated shoulder simulator. The four arthroscopic tasks included probing different locations, inserting a suture anchor into the greater tuberosity, pulling sutures through portals, and measuring anatomy. All of the subjects completed a shoulder anatomy test before and after the given tasks as well as a questionnaire.

Educational value was determined by anatomy test scores before and after performing the simulation tasks while construct validity was determined by measuring the differences in time to completion of the tasks between the two groups based on experience. A Student 2 sample t-test was used to compare numerical data between two groups.

### Results

On average, the medical student group took 729 seconds to complete the simulation tasks on the CASS versus 385 seconds on the 3D-PASS (p=0.01). The expert surgeon group took 295 seconds versus 248 seconds to complete the arthroscopic tasks on the CASS versus 3D-PASS, respectively (p=0.51). The medical student group had longer time to completion of the arthroscopic tasks than the expert surgeon group on both the CASS (p=0.003) and 3D-PASS (p=0.046).

There was a moderate negative correlation between the number of shoulder arthroscopies a user had performed and the amount of time to completion of the simulation tasks on both the CASS (r=−0.60) and 3D-PASS (r=−0.43). Subjects improved on their anatomy test from a 62% to a 80% (p=0.022) after performing the 4 tasks on the CASS and from 62% to 84% on the 3D-PASS (p=0.049).

Additionally, the expert surgeons rated the 3D-PASS as more portable, and more likely to improve suture management skills than the CASS. (p=0.004 and p=0.04 respectively).

Conclusion: The 3D printed arthroscopic shoulder simulator demonstrated construct validity and educational value comparable to a commercially available shoulder simulator. Additionally, medical students were able to complete arthroscopic tasks faster with the 3D printed shoulder simulator compared to the commercial simulator.

### Introduction

Surgical Simulators have proven to be an invaluable tool for surgical training. It has already been established that training on surgical simulators transfers to improved surgical skills in the operating room.1 Arthroscopic training is something that requires a lot of practice to be proficient. Many experts believe that at least 50 arthroscopies are required to perform basic arthroscopic tasks, and 150 arthroscopies are required to perform complex arthroscopies.2,3 As work hour restrictions have been placed, the number of real arthroscopies performed by residents may be decreasing, making it more challenging to meet these proficiency numbers. 4,5 Newer challenges such as the COVID-19 pandemic and nursing shortages may place additional restrictions on the number of cases residents are graduating with.6 Lastly, financial pressures and decreased autonomy of resident trainees may be placing additional pressures to decrease resident case load and training.5

All of these factors may be increasing the need for simulation-based training. The majority of stakeholders in residency training believe that simulators should be an essential part of training. Recently, 84% of surgical trainees and 86% of program directors believed surgical simulation should be a mandatory part of surgical training.7,8 Additionally, 100% of residents surveyed believe simulators are an important part of their surgical training.7 Despite this agreement among program directors and residents, 80% of residents have reported that there is no surgical skills lab at their program for arthroscopic training.9 This may be reflected in the fact that the majority of residents (93%) don't feel comfortable when performing their first arthroscopy.9

There are a variety of factors that may contribute to arthroscopic simulation training not being standard for orthopaedic residency training. Without wishing to be bound by theory, factors contributing to the lack of simulation based training are the lack of faculty interest, lack of dedicated space and the lack of resident interest.8 The overwhelming majority of program directors (87.3%), however, believe that the primary barrier is lack of available funding.8 Most programs believe it will cost between $1000 to $15,000 to create a simulation lab, while only 15% of programs are willing to spend more than $30,000.8 This creates quite a conodrum when Simulators cost anywhere from $3,500 to $114,000.10 In order to remove the financial barriers to arthroscopic simulation training, we have developed a 3D printed anatomic shoulder simulator that is low cost. It is also deployable worldwide since it relies on common Fused Deposition Modeling (FDM) printing technology. The purpose of our study was to validate the educational and construct validity of embodiments of a 3D printed arthroscopic shoulder simulator (3D-PASS) and compare it to a commercially available shoulder simulator (CASS).

### Method

This study was a prospective randomized control trial approved by the local Institutional Review Board (IRB). Twenty Subjects were recruited for 2 groups: 10 Medical Students and 10 Expert Surgeons. Medical students were 3rd or 4th year medical students who had completed surgical rotations. Expert Surgeons were Orthopaedic Surgery Attendings who have completed a sports medicine or shoulder and elbow fellowship or who have completed at least 250 shoulder arthroscopic procedures. Each subject was randomized to perform arthroscopic tasks on the 3D-PASS or on the CASS (Alex 3, Sawbones, Vashon Island, Washington). After randomization there were 5 medical students for the 3D-PASS and 5 medical students for the CASS groups and 5 expert surgeons for the 3D-PASS and 5 expert surgeons in the CASS group. All subjects completed a timed assessment of arthroscopic tasks on their designated shoulder simulator.

The four arthroscopic tasks included probing different locations, inserting a suture anchor into the greater tuberosity, pulling sutures through portals, and measuring anatomy. Subjects also completed a shoulder anatomy test before and after the tasks as well as a questionnaire after completion of the tasks. Arthroscopic tasks were recorded and the time to completion of all of the tasks was measured. The videos were reviewed in a blinded fashion by a sports medicine surgeon who completed an accredited sports medicine fellowship and had dual board certification by the American Board of Orthopaedic Surgery (ABOS) in orthopaedic surgery and sports medicine. Each subject was graded using the Arthroscopic Surgery Skill Evaluation Tool (ASSET) Global Rating Scale.

Construct validity was determined by measuring the differences in ASSET to completion of the tasks between the two surgeon groups based on experience. Additional Construct Validity was measured using the time to completion of all arthroscopic tasks. Educational value was determined by anatomy test scores before and after performing the simulation tasks. A Student 2 sample t-test was used to compare numerical data between two groups.

### Results

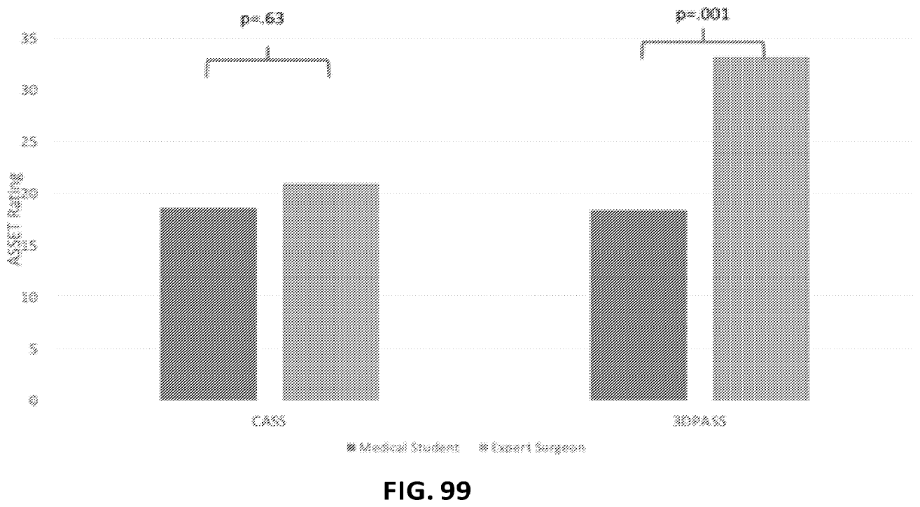

The ASSET rating was significantly different between the medical students and the expert surgeons when they were tested on the 3DPASS (p=0.001, see FIG. 99). There was not a significant difference in ASSET rating between the medical student and expert sugeon. (p=0.63)

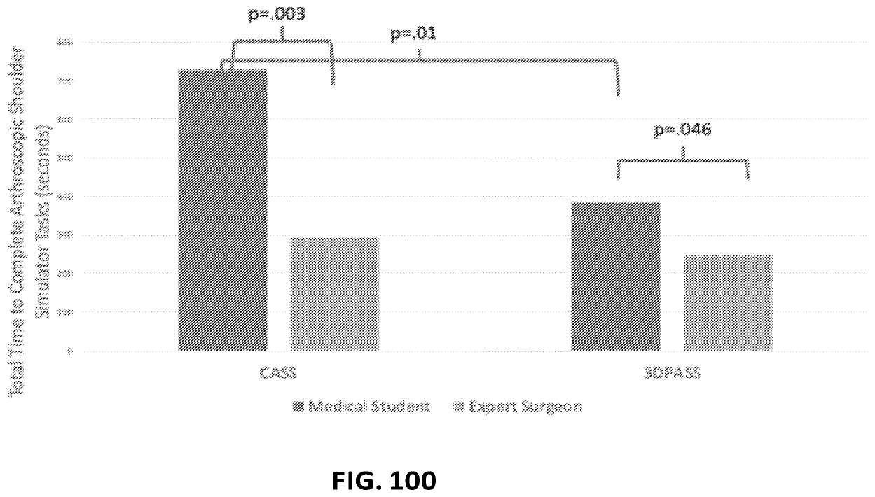

On average, the medical student group took 729 seconds to complete the simulation tasks on the CASS versus 385 seconds on the 3D-PASS (p=0.01, see FIG. 100). The expert surgeon group took 295 seconds versus 248 seconds to complete the arthroscopic tasks on the CASS versus 3D-PASS, respectively (p=0.51). The medical student group had longer time to completion of the arthroscopic tasks than the expert surgeon group on both the CASS (p=0.003) and 3D-PASS (p=0.046).

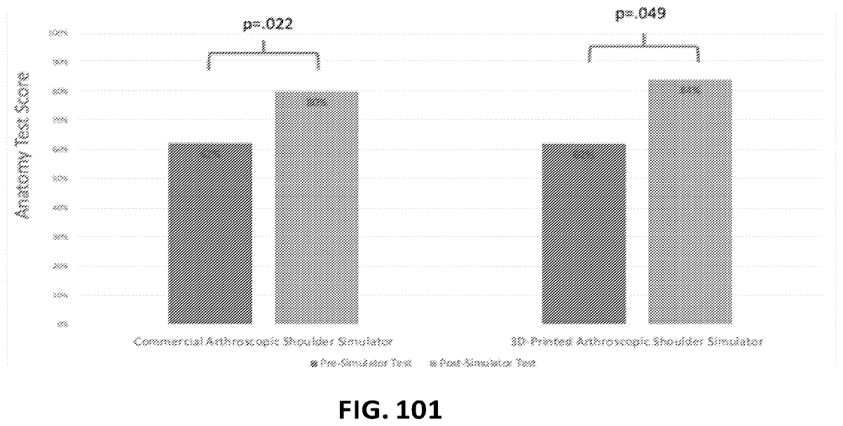

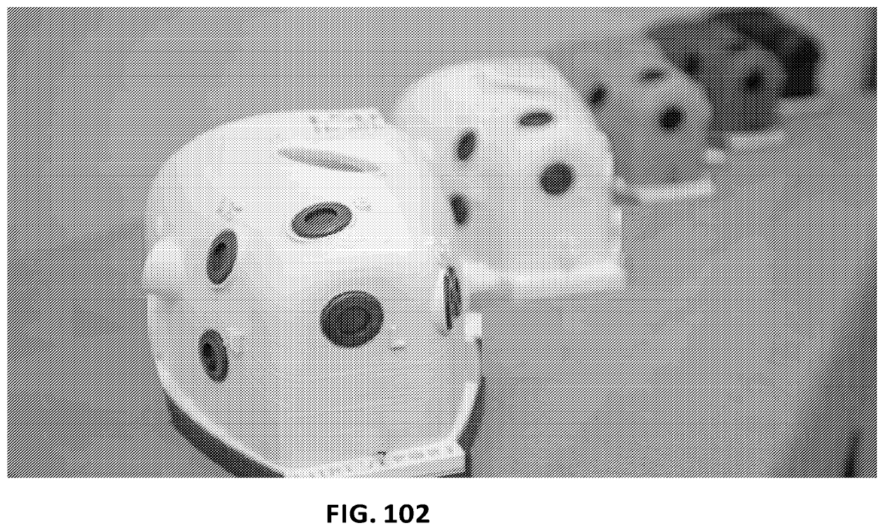

There was a moderate negative correlation between the number of shoulder arthroscopies a user had performed and the amount of time to completion of the simulation tasks on both the CASS (r=−0.60) and 3D-PASS (r=−0.43). Subjects improved on their anatomy test from a 62% to a 80% (p=0.022) after performing the 4 tasks on the CASS and from 62% to 84% on the 3D-PASS (p=0.049, see FIG. 101).

Additionally, the expert surgeons rated the 3D-PASS as more portable, and more likely to improve suture management skills than the CASS. (p=0.004 and p=0.04 respectively).

### Discussion

The overwhelming majority of orthopedic residents and attendings agree that surgical simulators should be widely incorporated in resident education.7,8 However, in reality, less than 20% of US orthopedic residents have access to arthroscopic surgical simulators.9

The CASS was the Alex 3, Sawbones shoulder simulator model. A study by Ceponis et al. demonstrated hands-on training with the Alex model in combination with teaching videos was at least as effective as the use of cadavers in teaching orthopaedic surgery residents' fundamental knowledge of diagnostic shoulder arthroscopy.11 This study similarly had participants complete a pre- and post-test to evaluate the Alex 3 simulator's effectiveness compared to a cadaver simulator. Our study demonstrated equal improvement in anatomy test scores between the 3D-PASS and CASS; the latter which has been previously shown to be equally effective as cadaver simulators.

Medical students took nearly twice as much time to complete the 4 tasks on the CASS as they did on the 3D-PASS. In addition, expert surgeons did not differ in time to complete tasks between the two simulators. Therefore, novice medical students can complete more repetitions of arthroscopy simulation than they could in the same amount of time on the CASS. In the field of surgical training, where repetitions to a skill level considered proficient can be as high as 250 procedures, completing more tasks in a shorter amount of time can potentially lead to a faster rate of achieving proficiency.2,3

Using the ASSET grading scale, two expert surgeons individually reviewed the video recordings of each subject's four tasks. When grading participants on the 3DPASS, a statistically significant difference was found between expert surgeons and medical students (p=0.001). The ASSET ratings between expert surgeons and medical students on the CASS were nearly equal. Based on these results, the 3DPASS demonstrates construct validity. Construct validity is the ability of a simulator to discriminate between novice and expert subjects. A simulator with construct validity is a useful tool in surgical training as it more closely simulates the level of skill it takes to perform an actual surgical procedure with proficiency.

Conclusion: The 3D printed arthroscopic shoulder simulator demonstrated construct validity and educational value comparable to a commercially available shoulder simulator. Additionally, medical students were able to complete arthroscopic tasks faster with the 3D printed shoulder simulator compared to the commercial simulator.

### REFERENCES CITED IN THIS EXAMPLE

1. Waterman B R, Martin K D, Cameron K L, Owens B D, Belmont P J. Simulation training improves surgical proficiency and safety during diagnostic shoulder arthroscopy performed by residents. Orthopedics. 2016;39(3):e479-e485. doi:10.3928/01477447-20160427-02
2. Middleton R M, Vo A, Ferguson J, et al. Can Surgical Trainees Achieve Arthroscopic Competence at the End of Training Programs? A Cross-sectional Study Highlighting the Impact of Working Time Directives. Arthrosc J Arthrosc Relat Surg. 2017;33(6):1151-1158. doi:10.1016/J. ARTHRO.2016.10.025
3. O'Neill P J, Cosgarea A J, Freedman J A, Queale W S, McFarland E G. Arthroscopic proficiency: A survey of orthopaedic sports medicine fellowship directors and orthopaedic surgery department chairs. Arthrosc J Arthrosc Relat Surg. 2002;18(7):795-800. doi:10.1053/JARS.2002.31699
4. Fairfax L M, Christmas A B, Green J M, Miles W S, Sing R F. Operative Experience in the Era of Duty Hour Restrictions: Is Broad-Based General Surgery Training Coming to an End? https://doi.org/101177/000313481007600619. 2010;76(6):578-582. doi:10.1177/000313481007600619
5. Hope W W, Griner D, Van Vliet D, Menon R P, Kotwall C A, Clancy T V. Resident Case Coverage in the Era of the 80-Hour Workweek. J Surg Educ. 2011;68(3):209-212. doi: 10.1016/J.JSURG.2011.01.005
6. Ghoshal S, Rigney G, Cheng D, et al. Institutional Surgical Response and Associated Volume Trends Throughout the COVID-19 Pandemic and Postvaccination Recovery Period. JAMA Netw Open. 2022;5(8):e2227443-e2227443. doi:10.1001/JAMANETWORKOPEN.2022.27443
7. Seil R, Hoeltgen C, Thomazeau H, Anetzberger H, Becker R. Surgical simulation training should become a mandatory part of orthopaedic education. J Exp Orthop. 2022;9(1):1-5. doi:10.1186/S40634-022-00455-1/FIGURES/1
8. Karam M D, Pedowitz R A, Natividad H, Murray J, Marsh J L. Current and future use of surgical skills training laboratories in orthopaedic resident education: A national survey. J Bone Jt Surg. 2013;95(1). doi:10.2106/JBJS.L.00177
9. Keith K, Hansen D M, Johannessen M A. Perceived value of a skills laboratory with virtual reality simulator training in arthroscopy: A survey of orthopedic surgery residents. J Am Osteopath Assoc. 2018;118(10):667-672. doi:10.7556/JAOA.2018.146/MACHINEREADABLECITATION/RIS
10. Hansen J, Lee C, Hewins B, et al. Cost Analysis of an In-House Arthroscopic Skills Simulator. J Orthop Bus. 2022;2(1):7-9. doi:10.55576/JOB.V211.8
11. Ceponis P J M, Chan D, Boorman R S, Hutchison C, Mohtadi N G H. A randomized pilot validation of educational measures in teaching shoulder arthroscopy to surgical residents. Can J Surg. 2007;50(5):387. Accessed Dec. 6, 2022./pmc/articles/PMC2386192/

### Example 10—A New 3D Printed Surgical Simulation Platform for Surgical Training

What does the U.S. Airforce think about simulators? “Simulators train aircrew at fraction of cost” https://www.af.mil/News/Article-Display/Article/500033/simulators-train-aircrew-at-fraction-of-cost/
Learn from mistakes in a simulator to prevent mistakes in a real airplane
You can learn fundamentals in a low stress environment
Time in sim is more than a real plane
   124 hours in a simulator
   35 hours in a real plane

What do orthopaedic surgeons think about simulators?
84% of Surgical Trainees Believe Simulation should be Mandatory
86% of Program Directors of Trainees Believe Simulation should be Mandatory
93 % of residents were uncomfortable when they did their first arthroscopy
80% of residents reported no Surgical skills lab at their training program for arthroscopy
Karam, M. D., Pedowitz, R. A., Natividad, H., Murray, J., & Marsh, J. L. (2013). Current and future use of surgical skills training laboratories in orthopaedic resident education: a national survey. JBJS, 95(1), e4.
Seil, R., Hoeltgen, C., Thomazeau, H., Anetzberger, H., & Becker, R. (2022). Surgical simulation training should become a mandatory part of orthopaedic education. Journal of Experimental Orthopaedics, 9(1), 1-5.
Keith, K., Hansen, D. M., & Johannessen, M. A. (2018). Perceived value of a skills laboratory with virtual reality simulator training in arthroscopy: a survey of orthopedic surgery residents. Journal of Osteopathic Medicine 118(10), 667-672.

Why are simulators for surgical training not standard like training to fly airplanes?
80% of residents reported no surgical skills lab at their training program for arthroscopy
87% of Orthopaedic Residency Program Directors Identified Lack of Funding as #1 Reason for no Surgical Simulation Training
Simulators Cost Too Much Money
Implementation is too Expensive
Karam, M. D., Pedowitz, R. A., Natividad, H., Murray, J., & Marsh, J. L. (2013). Current and future use of surgical skills training laboratories in orthopaedic resident education: a national survey. JBJS, 95(1), e4.

Embodiments as described herein can increase access and revolutionize surgical training
Accessobility
   Low cost
   Scalable
   Durable
Object Recognition/Feedback
   Visul recognition
   Acoustic recognition
   Haptic (touch) recognition

Current simulators may not be anatomically accurate, may required 6-12 week delivery time, may provide no haptic feedback, may be expensive, and may be high maintenance.

Advantages of embodiments of the invention:
No tools required for assembly, rather embodiments assemble like legos
PLA biodegradable
Real time upgrades in seconds
Global deployment

2 major validation studies:
Study that compared 3D printed simulator to commercial simulator
Study that evaluated training on orthopaedic residents to improve surgical skills on a cadaver arthroscopy

### Results

3d Printed Simulator—Excellent Educational Validity and Construct Validity
3D Printed Simulator valid for training residents—improved Surgical Skills on a cadaver
Expert surgeons rated our Simulator higher for the following items
   should be incorporated into training of residents, well designed and constructed
      ease of use, should be made available to all surgical trainees, as more portable, and more likely to improve suture management skills

### Conclusions

The 3D printed arthroscopic shoulder simulator is valid as a training tool for surgical trainees
Low cost
Can be deployed internationally to train worldwide

### Example 11—3D Printed Arthroscopic Should Simulator for Surgical Training: A Randomized Study

### Abstract

Background: Most training programs are limited by cost and geographic availability when it comes to implementing arthroscopic shoulder simulators into their curriculum.

Objective: The construct validity of a new 3D printed simulator and a commercially available simulator were compared using arthroscopic tasks performed by three different groups of people.

Results: There was a difference in the time to completion of the simulation tasks among the three levels of training for the CASS and 3D-PASS (p=0.002 and p=0.014 respectively)

Conclusion: The 3D printed simulator exhibited construct validity with more experienced arthroscopy surgeons performing tasks faster and educational value comparable to a commercially available simulator.

### Background

Adoption of arthroscopic shoulder simulator in training programs is currently limited by the costs of existing solutions ($1000 to $130,000) and their geographical availability.1. 84% of surgical trainees and 86% of program directors believed surgical simulation should be a mandatory part of surgical training.2,3

### Objective

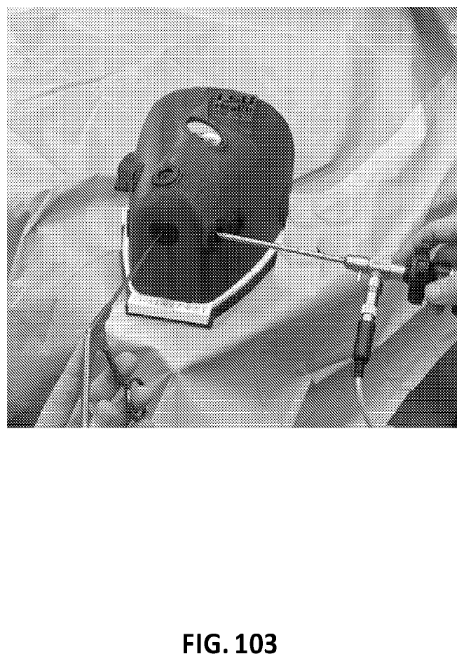

To compare learning value and validity of a new 3D printed arthroscopic shoulder simulator (3D-PASS) (FIG. 103) and compare to a commercially available shoulder simulator (CASS).

### Methods

Grouping—24 subjects were evenly and randomly divided into 3 groups:
medical students,
novice arthroscopy surgeons
expert arthroscopy surgeons.
Subjects were randomized to do tasks on the 3D-PASS or on the CASS. This study was a prospective randomized control trial approved by the local Institutional Review Board (IRB).

### Methods: Testing

Timed assessment of 4 arthroscopic tasks was done by all subjects. These included probing, placing a screw, pulling suture, and passing suture through rotator cuff.
An anatomy test was also performed by all subjects to assess learning value. Construct validity was determined by time to completion of tasks. An ANOVA was performed with post-hoc testing done to compare data.

### Results

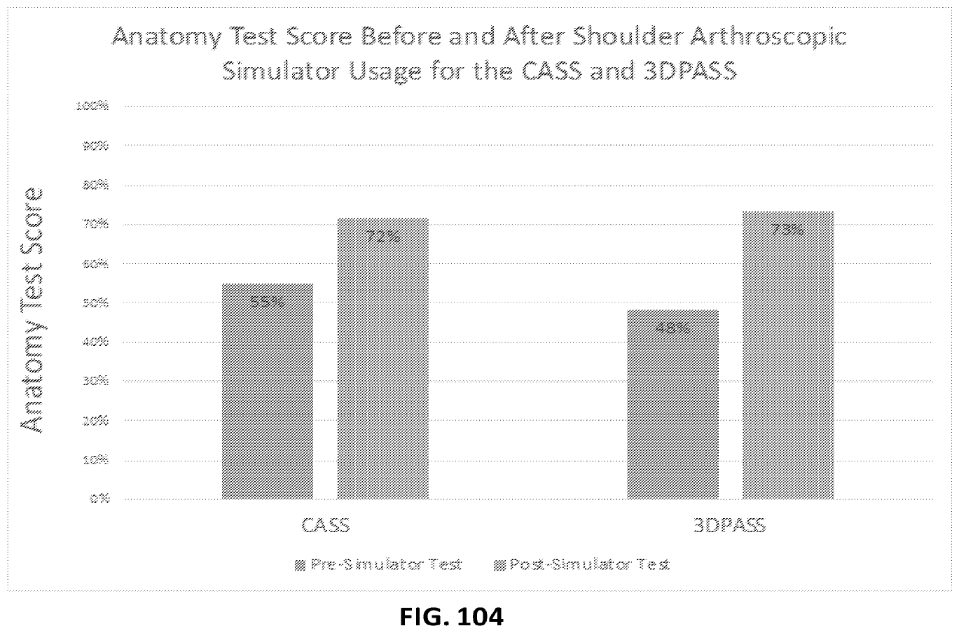

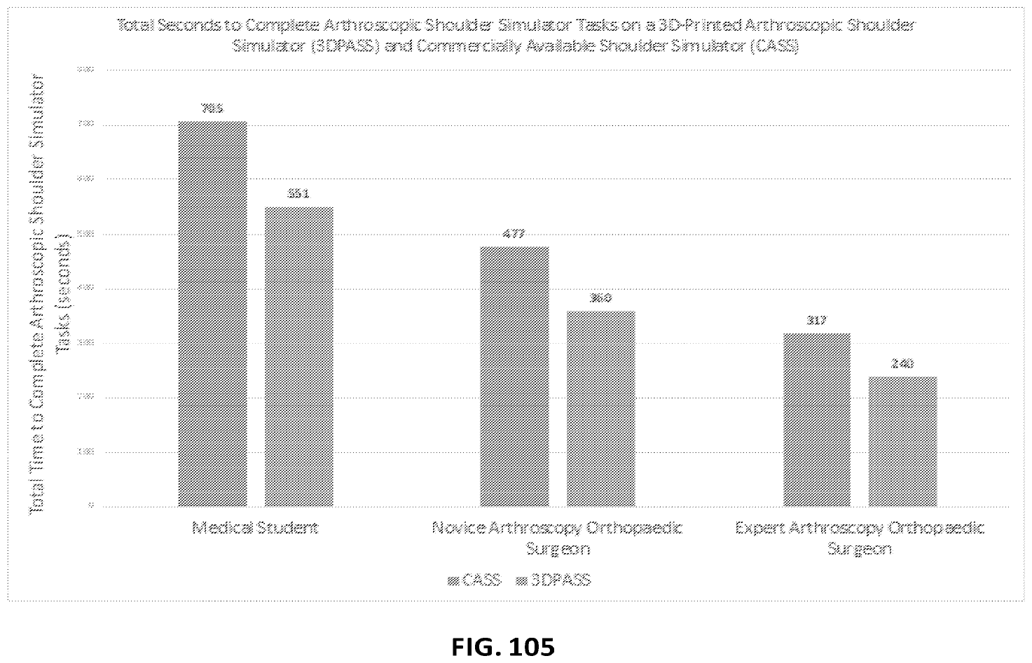

The more shoulder arthroscopies a subject had performed was associated with faster times on both models: 3D-PASS (r=−0.46). and CASS (r=−0.46)
Performing 4 tasks improved anatomy scores (FIG. 104).
55% to a 72% on the CASS (p=0.005)
48% to 73% on the 3D-PASS (p=0.01)
A significant difference was found for time to completion of the simulation tasks among the three levels of training for the 3D-PASS and CASS (p=0.014 and p=0.002 respectively, see FIG. 105).
CASS: novice surgeons and expert surgeons performed faster than medical students (0.013 and p=0.001 respectively).
3D-PASS: novice and expert surgeons performed faster than medical students (p=0.046 and p=0.004 respectively)

### Conclusion

The 3D printed arthroscopic shoulder simulator demonstrated validity comparable to a commercially available shoulder simulator
The 3D Simulator also demonstrated learning value.

### REFERENCES CITED IN THIS EXAMPLE

1. Hansen, J., Lee, C., Hewins, B., MacDonald, A., Rasmussen, A., Weissbrod, E., & Franklin, B. (2022). Cost Analysis of an In-House Arthroscopic Skills Simulator. Journal of Orthopaedic Business, 2(1), 7-9.
2. Karam, M. D., Pedowitz, R. A., Natividad, H., Murray, J., & Marsh, J. L. (2013). Current and future use of surgical skills training laboratories in orthopaedic resident education: a national survey. JBJS, 95(1), e4.
3. Seil, R., Hoeltgen, C., Thomazeau, H., Anetzberger, H., & Becker, R. (2022). Surgical simulation training should become a mandatory part of orthopaedic education. Journal of Experimental Orthopaedics, 9(1), 1-5.

### Example 12—Validity Assessment of a 3D Printed Arthroscopic Shoulder Simulator: An Experimental Evaluation of Construct Validity of Medical Students versus Novice and Expert Orthopaedic Arthroscopy Surgeons

Introduction: Adoption of arthroscopic shoulder simulator in training programs is currently limited by the costs of existing solutions ($1000 to $30,000) and their geographical availability. We have developed a 3D printed anatomic shoulder simulator that is low cost and deployable worldwide since it relies on common Fused Deposition Modeling (FDM) printing technology. The purpose of this study was to validate the educational validity of a new 3D printed arthroscopic shoulder simulator (3D-PASS) in relation to a widely adopted and commercially available shoulder simulator (CASS).

Methods: This study was a prospective randomized control trial approved by the local Institutional Review Board (IRB). Twenty-four subjects were recruited for 3 groups: Medical Students, novice arthroscopy orthopaedic surgeons and Expert arthroscopy orthopaedic Surgeons. Medical students were current medical students who had not completed an orthopaedic sub-internship. Novice Surgeons were Orthopaedic Surgeons who had not completed a sports medicine or shoulder and elbow fellowship and have done less than 250 shoulder arthroscopic procedures. Expert Surgeons were Orthopaedic Surgery Attendings who have completed a sports medicine or shoulder and elbow fellowship or who have completed at least 250 shoulder arthroscopic procedures. Each subject was randomized to perform arthroscopic tasks on the 3D-PASS or on the CASS. After randomization to each group, all subjects completed a timed assessment of arthroscopic tasks on their designated shoulder simulator. The four arthroscopic tasks included probing different locations, inserting a suture anchor into the greater tuberosity, pulling sutures through portals, and measuring anatomy. All of the subjects completed a shoulder anatomy test before and after the given tasks as well as a questionnaire.

Educational value was determined by anatomy test scores before and after performing the simulation tasks while construct validity was determined by measuring the differences in time to completion of the tasks between the three groups based on experience. An ANOVA with post-hoc testing was used to compare numerical data between the three groups.

### Results

On average, there was a difference in the time to completion of the simulation tasks for the CASS among the three different groups (p=0.002). The average time for completion on the CASS model was 705 seconds, 477 seconds, and 317 seconds for the medical student group, novice group and expert groups respectively. There was also a difference in time to completion of the simulation tasks on the 3D-PASS model among the three different groups (p=0.014). The average time to completion of simulation tasks on the 3D-PASS was 551 seconds, 360 seconds, and 240 seconds respectively.

There was a moderate negative correlation between the number of shoulder arthroscopies a user had performed and the amount of time to completion of the simulation tasks on both the CASS (r=−0.46) and 3D-PASS (r=−0.46). Among all participants, subjects improved on their anatomy test from a 55% to a 72% (p=0.005) after performing the 4 tasks on the CASS and from 48% to 73% on the 3D-PASS (p=0.01, see FIG. 105).

Additionally, the expert surgeons rated the 3D-PASS higher than the CASS for the following items: should be incorporated into training of residents, ease of use should be made available to all surgical trainees, well designed and constructed, as more portable, and more likely to improve suture management skills.

Conclusion: The 3D printed arthroscopic shoulder simulator demonstrated construct validity with more experienced arthroscopy surgeons performing tasks faster. The 3d printed arthroscopic shoulder simulator demonstrated construct validity and educational value comparable to a commercially available shoulder simulator. Additionally, medical students were able to complete arthroscopic tasks faster with the 3D printed shoulder simulator compared to the commercial simulator.

### Example 13—3D Printed Technology and Haptic Feedback

Three Dimension (3D) Printed simulators are a newer concept. Artificial models are sent from a computer to a 3D printer and a real-world model is created for trainees to train with. One of the major advantages of this technology is unique global deployment. There is the potential for a smaller carbon footprint, as models can be printed on-site instead of transported via vehicles. Another advantage is the material printed is sourced from corn and made as polylactic acid (PLA), which is biodegradable.

Recently, a 3D printed shoulder simulator was shown to have excellent construct validity and face validity, and improved user anatomy knowledge. This simulator can be printed to remote sites utilizing a 3D printer and PLA. The components are printed separately and then the shoulder simulator can be assembled without difficulty and is immediately ready for training. In their study, the authors compared expert arthroscopic surgeons versus 3rd and 4th year medical students performing 4 basic arthroscopic tasks including probing, placing a suture anchor, passing a suture through rotator cuff tendon, and measuring landmarks. The authors also randomized users to a 3D printed simulator versus a commercially available should simulator. They found that expert surgeons were able to complete the tasks faster than the medical students on both simulators. Only the 3D printed simulator demonstrated construct validity when measured by the ASSET though. Finally, exercises on both simulators improved anatomy test scores. Surgeons also rated the 3D printed simulator as being very realistic compared to a real shoulder. Training exercises such as a double row rotator cuff repair are available on this 3D printed simulator.

Another basic 3D printed simulator has been created which only costs $12 in filament to produce. There are several different configurations to do basic arthroscopic skills. The authors reported that residents improved arthroscopic skills with repeated efforts on the simulator. Finally, another group of authors created a 3D printed hip arthroscopy simulator. This hip arthroscopy simulator has a synthetic skin to simulate a patient's thigh and is complete with an acetabulum and labrum. The authors reported high construct validity, with performance correlating with surgeon experience. Early studies show good construct validity and face validity. Their greatest advantage is the potential for rapid implementation due to their low cost and ability to be printed remotely.

### Example 14—Validity Assessment of a 3D Printed Arthroscopic Shoulder Simulator: An Experimental Evaluation of Construct Validity of Medical Students versus Novice and Expert Orthopaedic Arthroscopy Surgeons

### Purpose

To evaluate the construct validity and educational value of a new 3D printed arthroscopic shoulder simulator (3D-PASS) and compare to a widely adopted and commercially available shoulder simulator (CASS) across 3 different levels of training

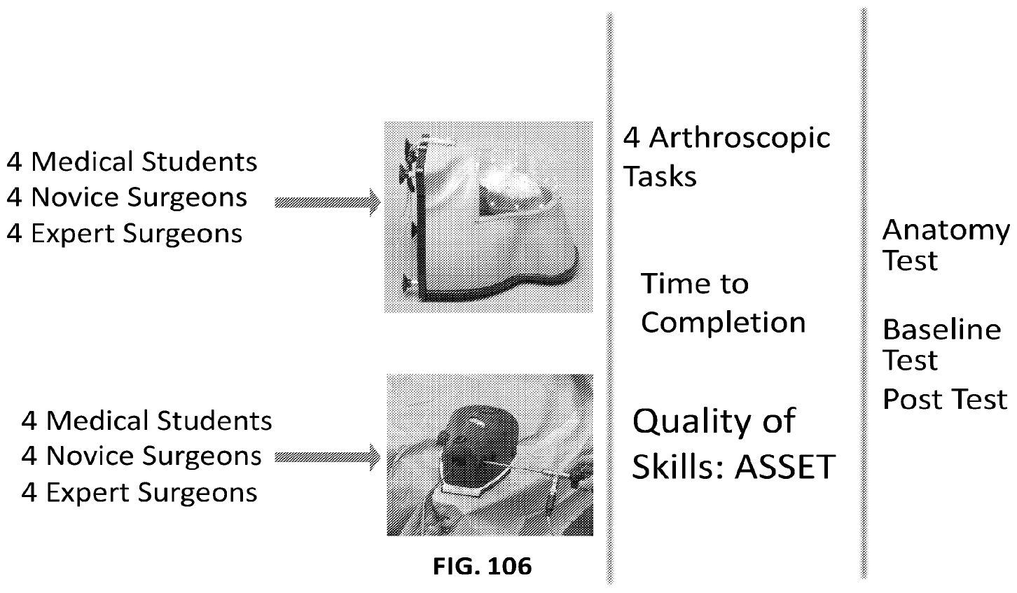

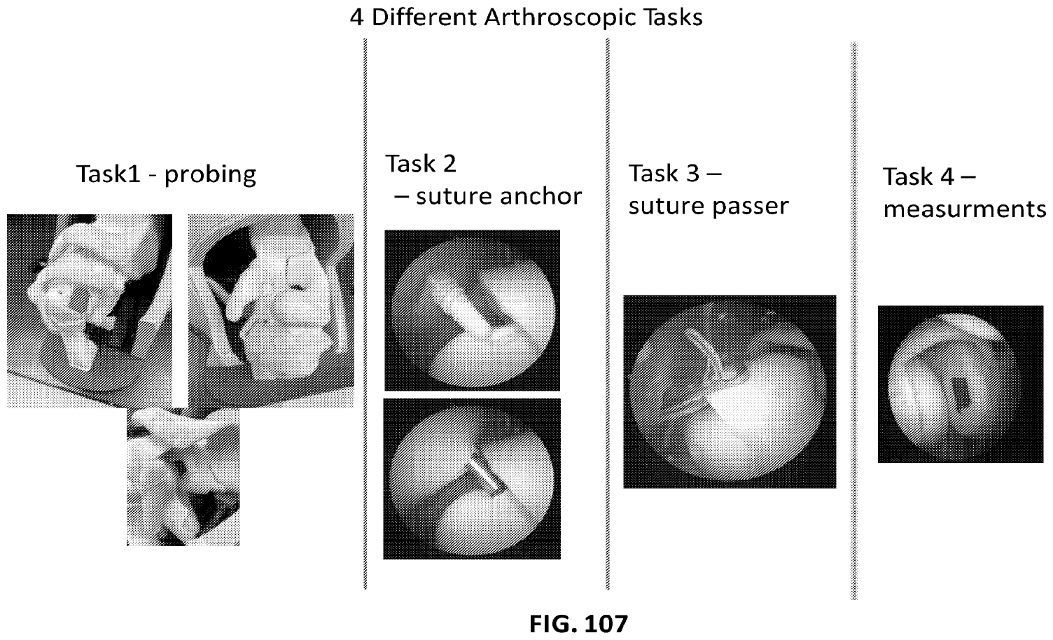

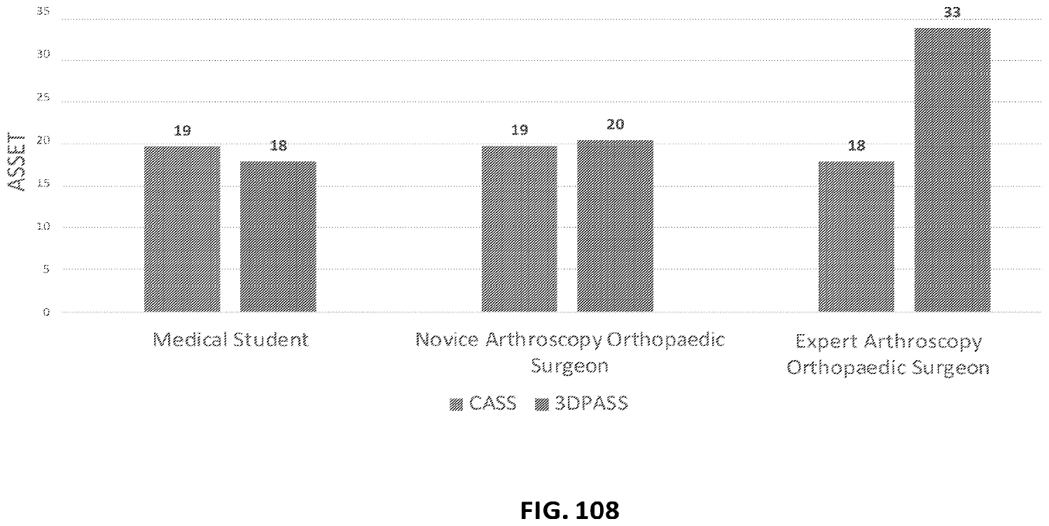

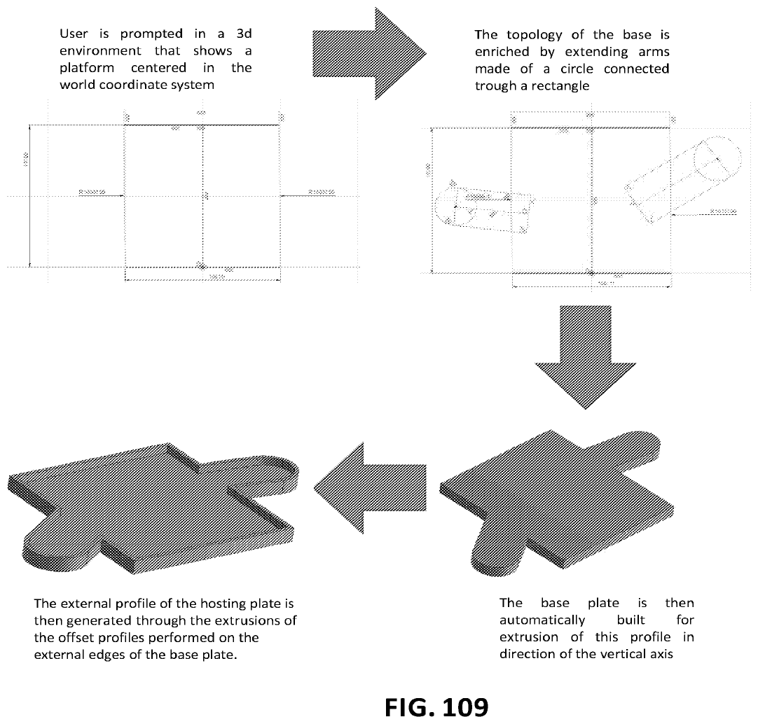

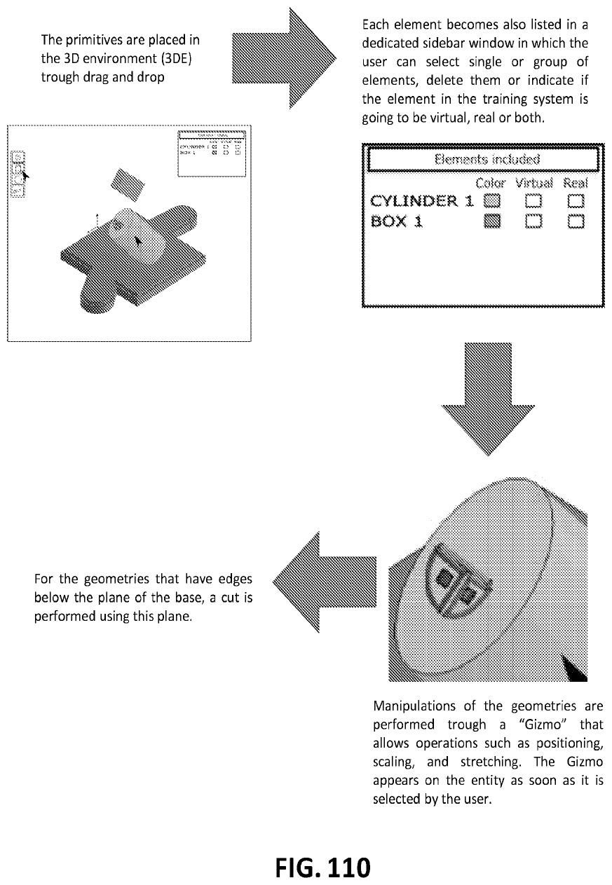

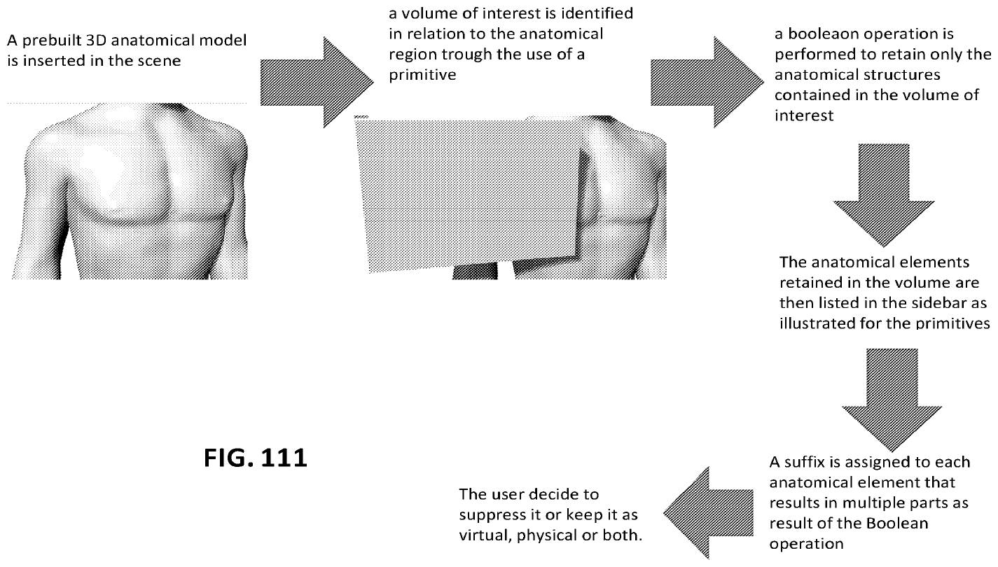

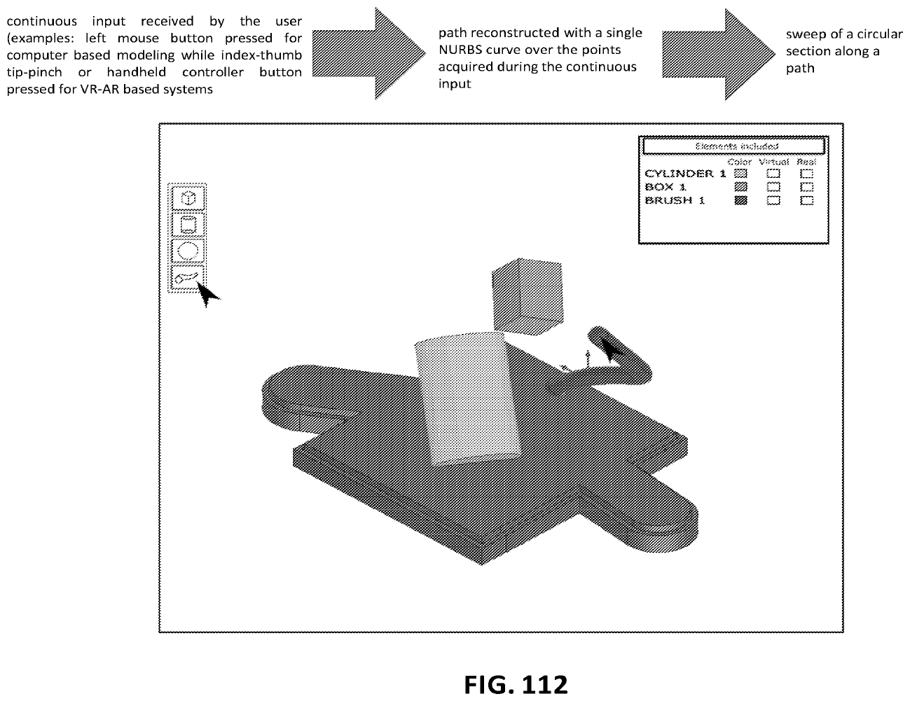

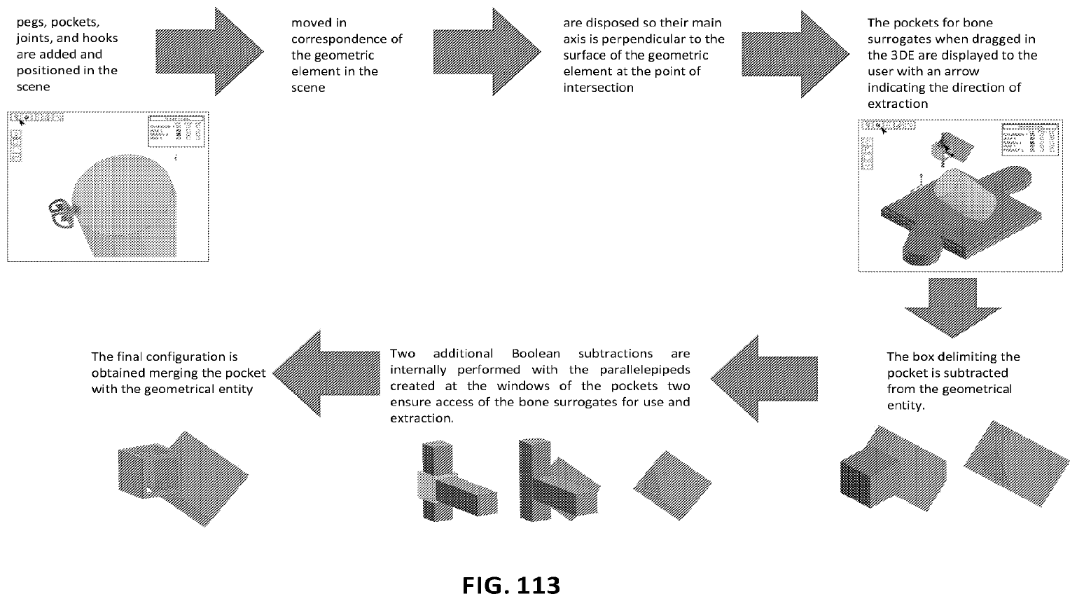

### Methods: see FIG. 106-FIG. 107

### Results

Expert and novice surgeons were faster than medical students on both simulators (see FIG. 105)
   A. There was a difference in the time to completion of the simulation tasks among the three levels of training for the CASS and 3D-PASS (p=0.002 and p=0.014 respectively).
   B. On the 3D-PASS, expert surgeons and novice surgeons performed faster than medical students (p=0.004 and p=0.046 respectively).
   C. On the CASS, expert surgeons and novice surgeons performed faster than medical students (p=0.001 and 0.013 respectively).
ASSET on a 3D-printed arthroscopic should simulator (PASS) and commercially available shoulder simulator (CASS)
   A. For 3D printed Simulator, Expert surgeons had higher ASSET than Novice and Med students (p=0.02 and 0.001, respectively)
   B. No differences between ASSET among all 3 groups for CASS (p=0.91)
   C. No differences between novice surgeons and medical students on 3DPASS (p=0.55)
Anatomy Test Score Before and After Should Arthroscopic Simulator Usage for the Alex 3 (CASS) and the new simulator. (See FIG. 104)
   A. There was a moderate negative correlation between the number of shoulder arthroscopies previously performed and the time to task completion on both the CASS (r=−0.46) and 3D-PASS (r=−0.46).
   B. Among all participants, subjects improved on their anatomy test from a 55% to a 72% (p=0.005) after performing the 4 tasks on the CASS and from 48% to 73% on the 3D-PASS (p=0.01).

### Conclusions

The 3D printed arthroscopic shoulder simulator demonstrated construct validity with more experienced arthroscopy surgeons performing tasks faster and educational value comparable to a commercially available shoulder simulator.
The 3D printed arthroscopic shoulder simulator demonstrated validity for both time and the ASSET
The Commercially Available Simulator demonstrated construct validity with respect to time, but not ASSET
The 3D printed arthroscopic shoulder simulator is valid as a training tool for surgical trainees
Low cost—For the cost of a cigar box simulator you can instead have a fully functioning high fidelity simulator
Can be deployed internationally to train worldwide

A modular anatomical system is described herein for demonstrating, practicing, or evaluating a medical procedure or technique. Under an embodiment, a second modular anatomical system identical to a first modular anatomical system (as described herein) may be located remotely from the first modular anatomical system. The second modular anatomical system may be communicatively coupled to the first modular anatomical system. A trainer using the first modular anatomical system may perform a medical procedure or technique which is remotely displayed on a virtual display available to a trainee, wherein the trainee may follow along using the second modular anatomical system. A trainee using the second modular anatomical system may perform a medical procedure or technique which is remotely displayed on a display available to a trainer, wherein the trainer may use the first modular anatomical system to perform instructional actions visible to the trainee. This remote training capability may include any number of modular anatomical systems.

One or more applications running on processors of the modular anatomical system may implement artificial intelligence for providing virtual instructions to a user of the modular training system. The instructions may comprise virtual pointers, virtual simulations of procedures, written instructions, verbal instructions, or any combination thereof. The artificial intelligence may monitor activities of the user and provide real time corrections.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor-controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The modular anatomical system can be a component of a single system, multiple systems, and/or geographically separate systems. The modular anatomical system can also be a subcomponent or subsystem of a single system, multiple systems, and/or geographically separate systems. The components of modular anatomical system can be coupled to one or more other components of a host system or a system coupled to the host system.

One or more components of the modular anatomical system and/or a corresponding interface, system or application to which the modular anatomical system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

Aspects of the modular anatomical system and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the modular anatomical system and corresponding systems and methods include: microcontrollers with memory (such as electronically erasable programmable read only memory (EEPROM)), embedded microprocessors, firmware, software, etc. Furthermore, aspects of the modular anatomical system and corresponding systems and methods may be embodied in microprocessors having software-based circuit emulation, discrete logic (sequential and combinatorial), custom devices, fuzzy (neural) logic, quantum devices, and hybrids of any of the above device types. Of course, the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

The above description of embodiments of the modular anatomical system is not intended to be exhaustive or to limit the systems and methods to the precise forms disclosed. While specific embodiments of, and examples for, the modular anatomical system and corresponding systems and methods are described herein for illustrative purposes, various equivalent modifications are possible within the scope of the systems and methods, as those skilled in the relevant art will recognize. The teachings of the modular anatomical system and corresponding systems and methods provided herein can be applied to other systems and methods, not only for the systems and methods described above.

The elements and acts of the various embodiments described above can be combined to provide further embodiments. These and other changes can be made to the modular anatomical system and corresponding systems and methods in light of the above detailed description.

We claim:

1. A modular anatomical system for demonstrating, practicing, or evaluating a medical procedure or technique, the system comprising:
an anatomical structure comprising a base portion and one or more anatomical elements, wherein the one or more anatomical elements are removably secured to the base, wherein the one or more anatomical elements comprise a hosting element for receiving and securing a tissue surrogate, wherein an insertion direction of the tissue surrogate comprises a direction perpendicular to forces generated by the procedure or technique to thereby inhibit displacement of the tissue surrogate during the procedure or technique, wherein the tissue surrogate is interchangeable to mimic a part of the corresponding one more anatomical elements;
at least one tracking element;
at least one camera for receiving visual information of the anatomical structure and the at least one tracking element; and
one or more applications running on at least one processor of a computing device, the one or more applications configured to use information of the at least one tracking element to overlay three dimensional virtual features over the marker in a virtual display of at least a portion of the anatomical structure.

2. The system of claim 1, wherein the one or more anatomical elements are a representation of a bone, joint, tissue, structure, nerve, vessel, or surgical hardware.

3-4. (canceled)

5. The system of claim 1, wherein the anatomical structure further comprises a covering portion, wherein the covering portion comprises at least one access portal, wherein the at least one access portal comprises anterior, anterior superior, anterior inferior, superior, lateral, posterior, inferior, posterior, or any combination thereof.

6-8. (canceled)

9. The system of claim 1, wherein the hosting element comprises a receptacle, pocket, peg, hook, slide, hole or socket to host the tissue surrogate, wherein the hosting element is embedded into the one or more anatomical elements.

10. (canceled)

11. The system of claim 1, wherein the tissue surrogate comprises a cadaver tissue, a synthetic tissue, or an animal tissue, wherein the synthetic tissue comprises bone, connective tissue, vasculature tissue, muscle tissue, adipose tissue, dermal tissue, nerve tissue, a medical device, or a combination thereof.

12-13. (canceled)

14. The system of claim 1, wherein the one or more anatomical elements can be articulated or actuated.

15. The system of claim 1, wherein the one or more anatomical elements can be actuated by an elastic element.

16. (canceled)

17. The system of claim 1, wherein the system is configured to simulate a medical procedure.

18. (canceled)

19. The system of claim 17, wherein the medical procedure comprises a surgical procedure, wherein the surgical procedure comprises an otolaryngology procedure, a neurosurgery, a gastroenterology procedure, a urology procedure, a cardiovascular surgery, an oral surgery, a pediatric surgery, a plastic surgery, an orthopedic surgery, a cardiothoracic surgery, dentistry, podiatry, or any a combination thereof.

20. (canceled)

21. The system of claim 19, wherein the medical procedure comprises an arthroscopic procedure, a laparoscopic procedure, an endoscopic procedure, fluoroscopic image guided procedure, an ultrasound guided procedure, or an image guided procedure.

22. The system of claim 21, wherein the surgical procedure comprises acromioclavicular reconstruction, rotator cuff repair, shoulder anterior labral repair, posterior labral repair, superior labral repair, humeral avulsion of the glenohumeral ligament repair, shoulder arthroscopic procedures, knee arthroscopic procedures (anterior cruciate ligament reconstruction, posterior cruciate ligament reconstruction, medial collateral ligament reconstruction, lateral collateral ligament reconstruction, osteochondral autograft transfer, osteochondritis dissecans fixation, meniscus repair), hip arthroscopic procedures (CAM resection, femur osteochondroplasty, labrum repair), ankle arthroscopic procedures (osteochondral fracture fixation, osteochondral autograft transfer, loose body removal, ankle distraction, ankle fusion), elbow arthroscopy (osteophyte debridement, loose body removal, osteochondral fragment excision, microfracture, osteochondral autograft transfer, plica excision), wrist arthroscopy, or a combination thereof.

23. The system of claim 1, wherein the one or more anatomical elements are arranged to model a procedure, an anatomical feature, deformity, or pathology, wherein the procedure, the anatomical feature, deformity, or pathology comprises a human anatomical feature, deformity, or pathology, a maxillofacial procedure, neurosurgical procedure, proximal humerus fracture, a humerus shaft ffacture, a distal humerus intra-articular T-type fracture, a subtrochanteric femur fracture, a tibia plateau fracture, a tibia shaft fracture, a distal fibula fracture, a medial malleolus, a radial head, a olecranon fracture, a radius and ulna shaft, a distal radius, a posterior malleolus fracture, a calcaneus fracture, a Lisfranc fracture dislocation, an acetabulum fracture, an acctabulum and femur neck, a sacroiliac joint, a spine pedicle, a subtrochanteric fracture, a spherical socket, and a femur shaft fracture.

24-25. (canceled)

26. The system of claim 1, wherein the at least one tracking element comprises an alphanumeric code, an optical marker, or a chip.

27. The system of claim 1, wherein the at least one tracking element is located within the anatomical structure.

28. The system of claim 1, wherein the at least one tracking element is externally attached to the anatomical structure.

29. The system of claim 1, wherein the at least one camera comprises the computing device.

30. The system of claim 1, wherein a second modular anatomical system identical to the modular anatomical system is located remotely from the modular anatomical system, wherein the second modular anatomical system is communicatively coupled to the modular anatomical system, wherein a trainer using the moduler anatomical system performs a medical procedure or technique which is remotely displaved on a virtual or augmented reality display available to a trainee, wherein the trainse may follow along using the second modular anatomical system, wherein a trainee using the second modulor anatomical systom performs a medical procedure or technique which is remotely displayed on a virtual display available to a trainer, wherein the trainer uses the modular anatomical system to perform instructional actions visit to the trainee.

31-34. (canceled)

35. A modular anatomical system for demonstrating, practicing, or evaluating a medical procedure or technique, the system comprising:
an anatomical structure comprising a base portion and one or more anatomical elements, wherein the one or more anatomical elements are removably secured to the base, wherein the one or more anatomical elements comprise a hosting element for receiving and securing a tissue surrogate, wherein an insertion direction of the tissue surrogate comprises a direction perpendicular to forces generated by the procedure or technique to thereby inhibit displacement of the tissue surrogate during the procedure or technique wherein the tissue surrogate is interchangeable to mimic a part of the corresponding one more anatomical elements;
a virtual reality controller, wherein the virtual reality controller is attached to a surgical probe;
a virtual reality camera device;
one or more applications running on one or more processors of at least one of the virtual reality controller and the virtual reality camera device, the one or more applications configured to:
establish a position of the virtual reality controller relative to the virtual reality camera;
receive three-dimensional data of the anatomical structure including the one or more anatomical elements within the anatomical structure;
map an x-y-z position of the controller to an x-y-z position of the anatomical structure using the three-dimensional data;
track a position of the surgical probe relative to the anatomical elements using information of the mapping; and
generate a virtual display of the surgical probe within an environment of the anatomical structure.

36. The system of claim 35, wherein the mapping comprises placing the virtual reality controller in a fixed location relative to the anatomical structure.

37. The system of claim 35, wherein the mapping comprises the virtual reality camera mapping the environment.

38. The system of claim 37, wherein the mapping comprises the virtual reality camera using the information of the environmental mapping and the three-dimensional data to map the x-y-z position of the controller to the x-y-z position of the anatomical structure.

39. The system of claim 35, wherein the one or more anatomical elements are a representation of a bone, joint, tissue, structure, nerve, vessel, or surgical hardware.

40-41. (canceled)

42. The system of claim 35, wherein the anatomical structure further comprises a covering portion, wherein the covering portion comprises at least one access portal, wherein the at least one access portal comprises anterior, anterior superior, anterior inferior, superior lateral, posterior interior, posterior, or any combination thereof.

43-45. (canceled)

46. The system of claim 35, wherein the hosting element comprises a receptacle, pocket, peg, hook, slide, hole or socket to host the tissue surrogate, wherein the hosting element is embedded into the one or more anatomical elements.

47-48. (canceled)

49. The system of claim 35, wherein the tissue surrogate comprises a cadaver tissue, a synthetic tissue, or an animal tissue, wherein the synthetic tissue comprises bone, connective tissue, vasculature tissue, muscle tissue, adipose tissue, dermal tissue, nerve tissue, a medical device, or a combination theroof.

50. (canceled)

51. The system of claim 35, wherein the one or more anatomical elements can be articulated or actuated.

52. The system of claim 35, wherein the one or more anatomical elements can be actuated by an elastic element.

53. (canceled)

54. The system of claim 35, wherein the system is configured to simulate a medical procedure.

55. (canceled)

56. The system of claim 54, wherein the medical procedure comprises a surgical procedure, wherein the surgical procedure comprises an otolaryngology procedure, a neurosurgery, a gastroenterology procedure, a urology procedure, a cardiovascular surgery, an oral surgery, a pediatric surgery, a plastic surgery, an orthopedic surgery, a cardiothoracic surgery, dentistry, podiatry, or any a combination thereof.

57. (canceled)

58. The system of claim 56, wherein the medical procedure comprises an arthroscopic procedure, a laparoscopic procedure, an endoscopic procedure, fluoroscopic image guided procedure, an ultrasound guided procedure, or an image guided procedure.

59. The system of claim 58, wherein the surgical procedure comprises acromioclavicular reconstruction, rotator cuff repair, shoulder anterior labral repair, posterior labral repair, superior labral repair, humeral avulsion of the glenohumeral ligament repair, shoulder arthroscopic procedures, knee arthroscopic procedures (anterior cruciate ligament reconstruction, posterior cruciate ligament reconstruction, medial collateral ligament reconstruction, lateral collateral ligament reconstruction, osteochondral autograft transfer, osteochondritis dissecans fixation, meniscus repair), hip arthroscopic procedures (CAM resection, femur osteochondroplasty, labrum repair), ankle arthroscopic procedures (osteochondral fracture fixation, osteochondral autograft transfer, loose body removal, ankle distraction, ankle fusion), elbow arthroscopy (osteophyte debridement, loose body removal, osteochondral fragment excision, microfracture, osteochondral autograft transfer, plica excision), wrist arthroscopy, or a combination thereof.

60. The system of claim 35, wherein the one or more anatomical elements are arranged to model a procedure, an anatomical feature, deformity, or pathology, wherein the procedure, the anatomical feature, deformity, or pathology comprises a human anatomical feature, deformity, or pathology, a maxillofacial procedure, neurosurgical procedure, proximal humerus fracture, a humerus shaft fracture, a distal humerus intra-articular T-type fracture, a subtrochanteric femur fracture, a tibia plateau fracture, a tibia shaft fracture, a distal fibula fracture, a medial malleolus, a radial head, a olecranon fracture, a radius and ulna shaft, a distal radius, a posterior malleolus fracture, a calcaneus fracture, a Lisfranc facture dislocation, an acetabulum fracture, an acetabulum and femur neck, a sacroiliac joint, a spine pedicle, a subtrochanteric facture, a spherical socket, and a femur shaft fracture.

61-62. (canceled)

63. The system of claim 35, wherein a second modular anatomical system identical to the modular anatomical system is located remotely from the modular anatomical system, wherein the second modular anatomical system is communicatively coupled to the modular anatomical systent, wherein a trainer using the modular anatomical system performs a medical procedure or technique which is remotely displayed on a virtual or augmented reality display available to a trainee, wherein the trainee follows along using the second modular anatomical system, wherein a trainee using the second modular anatomical system performs a medical procedure or technique which is remotely displayed on a virtual display available to a trainer, wherein the trainer uses the modular anatomical system to perform instructional actions visible to the trainee.

64-69. (canceled)
